(19) United States
(12) Patent Application Publication
(10) Pub. No.: US 2004/0088392 A1
(43) Pub. Date: May 6, 2004

(54) Population mobility generator and simulator

(75) Inventors: Christopher L. Barrett, Santa Fe, NM (US); Richard J. Beckman, Santa Fe, NM (US); Stephen G. Eubank, Santa Fe, NM (US); Madhav V. Marathe, Los Alamos, NM (US); Keith A. Baggerly, Houston, TX (US); Michael D. McKay, Los Alamos, NM (US); Paul L. Speckman, Columbia, MO (US); Rudiger R. Jacob, Veitschoecheim (DE); Goran Konjevod, Tempe, AZ (US); Kai Nagel, Dormagen (DE); Kathryn P. Berkbigler, Los Alamos, NM (US); Brian W. Bush, Santa Fe, NM (US); Joerg Esser, Dusseldorf (DE); Paula E. Stretz, Los Alamos, NM (US); James P. Smith, Los Alamos, NM (US); Katherine Campbell, Los Alamos, NM (US)

Correspondence Address: MADSON & METCALF, GATEWAY TOWER WEST, SUITE 900, 15 WEST SOUTH TEMPLE, SALT LAKE CITY, UT, 84101

(73) Assignee: The Regents of the University of California

(21) Appl. No.: 10/100,501

(22) Filed: Mar. 18, 2002

(51) Int. Cl. G06F 15/173

(52) U.S. Cl. 709/223

(57) ABSTRACT

A system and method provides a simulation of a complex network and movement and interdependencies between entities in the network. The system receives aggregated population data and a population synthesizer generates disaggregated population data representative of two different types of entities. The different entity types are then coupled to one another to form interdependent relationships. An activity generator generates typical activities for the entities. A route planner generates travel plans, including departure times and travel modes, for each entity to achieve daily activities. A micro-simulation module simulates movement of the individual entities in compliance with their travel plans. The system may include parallel processors to simulate thousands of roadway and transit segments, intersection signals and signs, transfer facilities between various transportation modes, traveler origins and destinations, and entities and vehicles. The system includes a framework and selector module that gathers the travel times from the simulation and uses them to re-plan activities and trips and re-run the simulation. The methods of the present invention produce appropriate dynamic behavior of the transportation network as a whole.

### GOVERNMENT RIGHTS

This invention was made with Government support under Contract Number W7405-ENG-36 awarded by the United States Department of Energy to The Regents of the University of California. The Government has certain rights in the invention.

### BACKGROUND OF THE INVENTION

1. Technical Field

The present invention is directed to computer simulations of populations and, more specifically, to a system and method for simulating movement of entities and interdependencies between the entities in a network through space and time.

2. Technical Background

Modern day society heavily depends on its transportation infrastructure for day-to-day operation and survival. Given the critical functions of a transportation infrastructure, the infrastructure must be well designed. Planners dedicate extensive resources to short and long term planning of the infrastructure. Growth and improvements require changes to the infrastructure which may have unknown consequences. Furthermore, planners are required to plan the growth of cities according to the stringent transportation system planning requirements of the Transportation Equity Act for the 21^{st} Century and the Clean Air Act Amendments of 1990. These Acts require each state and its metropolitan areas to work together to develop 3-year and 20-year transportation improvement plans.

Improvement plans are used to estimate the future transportation needs for travelers and movement of goods. The plans must also evaluate ways to manage and reduce congestion and examine the effectiveness of building new roads and transit systems. Furthermore, the plans should also consider the environmental impact of the various strategies.

Putting together consistent, accurate transportation improvement plans requires models and tools that incorporate an analytical capability that properly accounts for travel demand, human behavior, traffic and transit operations, major investments, and environmental effects. Modeling further benefits from simulated interactions between travelers. When accurate modeling occurs, the planners are able to improve the transportation infrastructure and provide enormous benefit to the community. Inaccurate models generate poor plans much to the detriment of the community. Improved simulations are needed to provide greater accuracy and to recognize the impact of future developments.

Existing planning tools use aggregated information and representative behavior to predict average response and average usage of transportation facilities. Previous transportation planning surveyed people about elements of their trips such as origins, destinations, routes, timing, and forms of transportation used, or modes. These tools do not account for individual traveler response to the transportation environment. Computer models have been used to generate simulations relating to population movement. However, these simulations use aggregated data and fail to consider the behavior and interactions of individual travelers.

An accurate simulation benefits from the behavior of individual travelers. Furthermore, existing computer models do not track the locations of the travelers at any given time interval. Existing models are not able to accurately determine how changes in transportation policy or infrastructure might affect traveler's activities and trips. An accurate simulation should be able to simulate a situation where a lengthy trip will cause travelers to find other routes, change from a personal vehicle to a transit vehicle, leave at different times, or decide not to do a given activity at a given location.

Thus, it would be an advancement in the art to provide a system that models individual entities who are statistically representative of a population. It would be a further advancement in the art to provide a system that simulates interaction between entities in a transportation infrastructure. It would be an advancement in the art to provide a system that simulates interaction between travel subsystems, such as a traveler's activity plans and congestion on the transportation system. Such a system is disclosed herein.

### SUMMARY OF THE INVENTION

The present invention relates to a system that simulates and analyzes movement and interdependencies between entities in a network. The system is an integrated set of analytical and simulation models and supporting databases. The system architecture is designed to create a virtual network, such as a metropolitan region, with representation of each of the region's individual entities and their activities in the network.

The system provides disaggregated information that more explicitly represents the complex nature of human and non-human entities interacting within a transportation network. The system includes a population synthesizer that generates a synthetic, statistically valid, population representative of individuals and their households within the transportation network. In various simulations the network may be a metropolitan region. The demographic makeup and spatial distribution of the synthetic population may be derived from census data so that it matches that of the region's real population.

The system further includes an activity generator for generating typical activities for the synthetic population. From survey data, the activity generator creates an activity model of household and individual activities that may occur at home, the workplace, school, or shopping centers.

The system further includes a route planner that receives the activity model and generates travel plans, including departure times and travel modes. For each entity's activities, the route planner searches the transportation network to find optimal travel modes and routes to arrive at those activities. The travel plans are created for each individual entity to achieve its daily activities.

The system uses a micro-simulation module that simulates the movement of the individual entities and follows their travel plans throughout the transportation network on a second-by-second basis. The simulation may further include the use of vehicles such as cars or buses. The system mimics the traveling and driving behavior of entities in the transportation network. The interactions of individual vehicles produce realistic traffic dynamics from which analysts can judge the overall performance of the transportation network.

The system includes models, simulations and databases that require considerable computer processing, time, memory and storage. The system may be utilized by a parallel computational system to represent thousands of roadway and transit segments, intersection signals and signs, transfer facilities between various transportation modes, traveler origins and destinations, and possibly millions of entities and vehicles. Computing operations are enabled for parallel execution on multiple processor computers that are affordable for transportation planners.

Simulation-executed routes and mode travel times may differ from the information that was used initially to plan each trip. The system includes a framework module and selector module that gather the travel times from the simulation and uses them to re-plan the entities' activities and trips. The system then runs the simulation again using the updated plans. For each case in a study, this iteration between the planning model and the travel simulation may be performed repeatedly until the travel plans and simulated travel do not differ significantly between runs. A complete study may require multiple executions of the activity-demand model, trip-planning model, and the travel simulation.

To reduce the computational burden, the modules of the system apply methods that simplify the modeling of the individual entity's interactions within the transportation network. The methods of the present invention produce appropriate dynamic behavior of the transportation network as a whole. The methods use quick-running, simple models in which entities and vehicles traveling along the network generate realistic traffic flow and congestion. The modules use methods that rapidly select the nearest location for an entity's activity and find the travel modes and routes that are the shortest or quickest between locations. The methods further incorporate strategies that minimize the iterations required to attain consistent travel times between the route planner and the micro-simulation.

The present invention provides new ways of measuring the effectiveness of transportation system changes. The second-by-second simulation of each entity's travel allows various groupings of output data. For example, individual travel times can be grouped in five-minute intervals according to the trip starting time. These time-dependent distributions yield statistical properties of each group, such as median, percentile rankings, average, and standard deviation. So, in addition to comparing the traditional average travel time during the peak period of traffic congestion, the time dependence and the range of travel times could be compared between cases Because the system tracks individual entities, users may observe the transportation system's effect on an individual traveler or a sub-population of travelers. This is important when equity issues, such as who benefits and who is adversely affected, may be involved in decision-maker considerations. Sub-populations can be selected in other ways, such as the five-percent of the population with the worst travel times. Demographics of the sub-population may be examined for common features.

The present invention may be adapted and used for representation and analysis of urban traffic in various metropolitan areas as well as networks on a smaller and grander scale. These and other features and advantages of the present invention will become more fully apparent from the following description and appended claims, or may be learned by the practice of the invention as set forth hereinafter.

### BRIEF DESCRIPTION OF THE DRAWINGS

A more particular description of the invention briefly described above will be rendered by reference to the appended drawings. Understanding that these drawings only provide information concerning typical embodiments of the invention and are not therefore to be considered limiting of its scope, the invention will be described and explained with additional specificity and detail through the use of the accompanying drawings, in which:

FIG. 1 is a block diagram of one embodiment of a system of the present invention;

FIG. 2 is a block diagram of one embodiment of a system architecture of the present invention;

FIG. 3 is a block diagram of various inputs and outputs of a population synthesizer of the present invention;

FIG. 4 is a block diagram illustrating data used in generating a synthetic population;

FIG. 5 is a block diagram illustrating the creation of households within a network;

FIG. 6 is a block diagram of one embodiment of a population synthesizer of the present invention;

FIG. 7 is a block diagram illustrating various inputs and outputs of an activity generator of the present invention;

FIG. 8 is a block diagram illustrating one embodiment of an activity generator of the present invention;

FIG. 9 is a tree diagram for matching entities and activities;

FIG. 10 is a block diagram illustrating various inputs and outputs for a route planner of the present invention;

FIG. 11 is a block diagram illustrating one embodiment of a route planner of the present invention;

FIG. 12 is a perspective view illustrating layers representative of travel modes used by a route planner;

FIG. 13 is a block diagram representing a portion of a network;

FIG. 14 is a block diagram of an internal network representation of FIG. 13;

FIG. 15 is a block diagram representing a portion of a network;

FIG. 16 is a block diagram of an internal network representation of FIG. 15;

FIG. 17 is a block diagram illustrating various input and output data for a micro-simulation module of the present invention;

FIG. 18 is a plan view of a portion of a transportation network;

FIG. 19 is a flow diagram illustrating steps executed in a single timestep;

FIG. 20 is a block diagram illustrating one method for loading entities and vehicles into a micro-simulation module;

FIG. 21 is a plan view of vehicles in lanes to illustrate vehicle behavior;

FIG. 22 is a plan view of an intersection within a transportation network;

FIG. 23 is a block diagram representing a network and subnetworks;

FIG. 24 is a block diagram illustrating a link distributed between two processors;

FIG. 25 is a flow diagram illustrating steps executed in a single timestep for distributed processing;

FIG. 26 is a block diagram illustrating one embodiment for data flows between modules of the present invention;

FIG. 27 is a block diagram illustrating interaction between a selector and iteration database of the present invention;

FIG. 28 is a block diagram illustrating one embodiment of the interaction of a selector and an iteration database with modules of the present invention;

FIGS. 29a and 29b, are graphs illustrating examples of progressions that may be determined by a selector of the present invention;

FIG. 30 is a block diagram illustrating interaction between an iteration database and selector module of the present invention;

FIG. 31 is a block diagram of an alternative embodiment of a population synthesizer of the present invention;

FIG. 32 is a block diagram illustrating the interior components of an alternative embodiment of a population synthesizer of the present invention; and

FIG. 33 is a block diagram of an alternative embodiment of a system of the present invention.

### DETAILED DESCRIPTION OF THE INVENTION

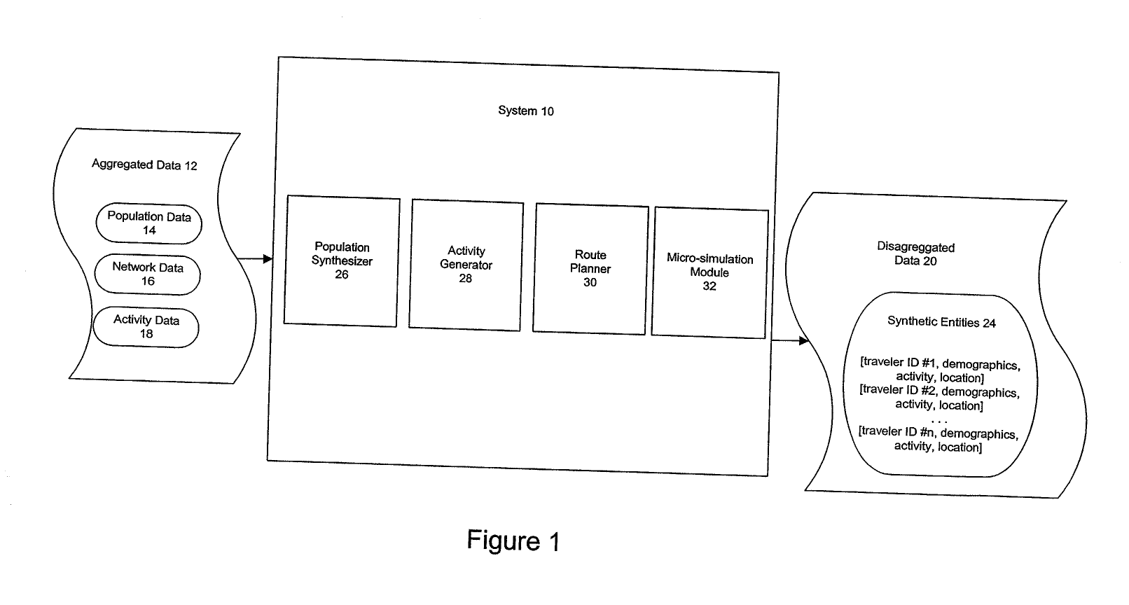

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 33, is not intended to limit the scope of the invention, as claimed, but is merely representative of presently preferred embodiments of the invention.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment.

The present invention provides a simulation-based system and method for representing and analyzing movement of entities in a given network. The system includes an integrated set of analytical and simulation models and supporting databases. The system architecture is designed to create a virtual environment with representation of each of the region's entities and their activities within the transportation infrastructure. Individual entity behavior and interactions, as constrained by the transportation infrastructure test the systems performance.

Referring to FIG. 1, a system 10 of the present invention receives aggregated, static data 12 that is referenced herein as input data 12. The input data 12 includes aggregated population data 14 that represents an entity population. For human entities, the population data 14 may include survey and census data. The input data 12 further includes network data 16. For an urban environment, the network data 16 is used to create a virtual metropolitan region. As such, the network data 16 includes nodes and links of a network representing a region. The network data 16 may include roadway and transport networks and transit schedules. The input data 12 may further include additional data such as activity data 18. The activity data 18 may include population activity surveys and marketing surveys.

The system 10 converts the input data 12 into disaggregated, dynamic data 20 that is herein referenced as output data 20. The output data 20 represents entity population mobility in terms of individual entity's movements and activities. The output data 20 may represent individual synthetic entities as demographic vectors 24. Each demographic vector is associated with an entity and includes location and activity. Location may be represented by the variables x, y, z, and t to represent a three dimensional position as function of time. Individual entities may further relate to each other to represent mobility interactions.

The system 10 includes modules for generating an entity population with behavior characteristics to simulate travel within a feedback-framework. A population synthesizer 26 generates a synthetic population of entities. The population synthesizer may generate individual entities and their households within a given metropolitan region in a statistically valid manner. The demographic makeup and spatial distribution of a generated synthetic population is derived from the population data 14 so that it matches that of a region's actual population.

The system 10 further includes an activity generator 28 for generating an activity model from the activity data 18. The activity model may include, for example, household and individual activities that may occur at home, the workplace, school, or shopping centers. The activity model includes representation of the region's individuals, activities, and transportation infrastructure.

The system 10 further includes a route planner 30 for creating individual routes from the activity model. The routes may include departure times and arrival times as well as travel modes. The routes are specific for each individual entity to perform activities.

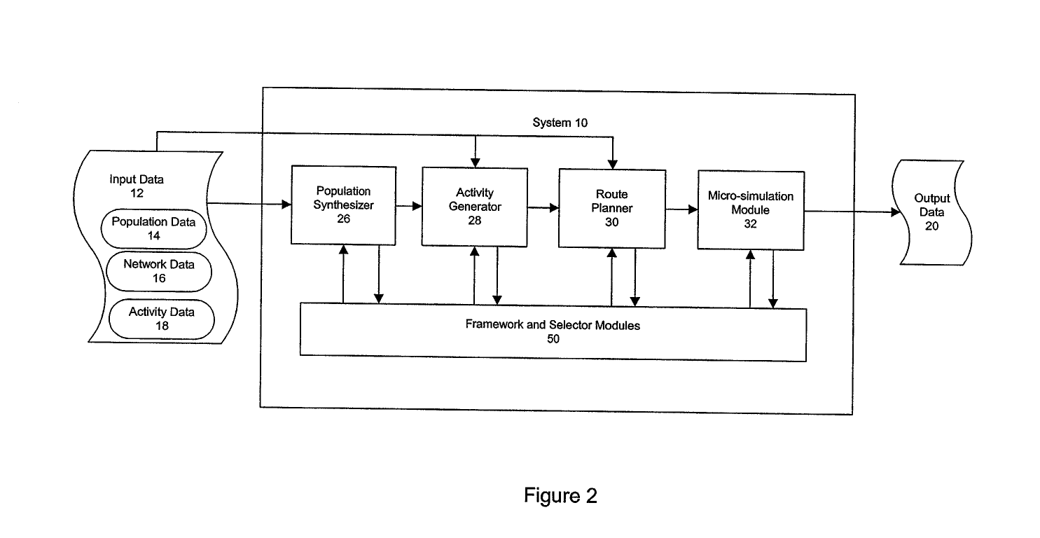

The system 10 also includes a micro-simulation module 32. The micro-simulation module 32 simulates individual entity movement and follows each entity as it moves throughout the transportation network. In an urban simulation, this may include the use of vehicles such as cars or buses. The module 32 may track entity movement based on discrete time intervals such as on a second-by-second basis. Referring to FIG. 2, one embodiment of a system architecture diagram is shown to illustrate how the modules may be interconnected. The population synthesizer 26, activity generator 28, and the route planner 30 receive population data 14, network data 16, and activity data 18 respectively. The system 10 further includes a framework module and a selector module that are collectively referred to as 50. The framework and selector modules 50 better approximate individual entity reaction and performance. Due to interactions among individual entities the simulation-executed route and mode travel times may differ from the input data 12 used to create the plan for each trip. The framework and the selector modules 50 gather the travel times as a simulation runs. The modules 50 then feed back the travel times to re-plan the individual entities' activities and trips and the simulation is run again.

For each case in a study, this iteration between the planning model and the travel simulation is done repeatedly until the trip plans and simulated travel do not change significantly between runs. A complete study of a network requires multiple executions of the activity generator 28, route planner 30, and micro-simulation 32. Execution of these components is iterated to stabilize the simulation and allow entities to react to information about the satisfaction of their preferences.

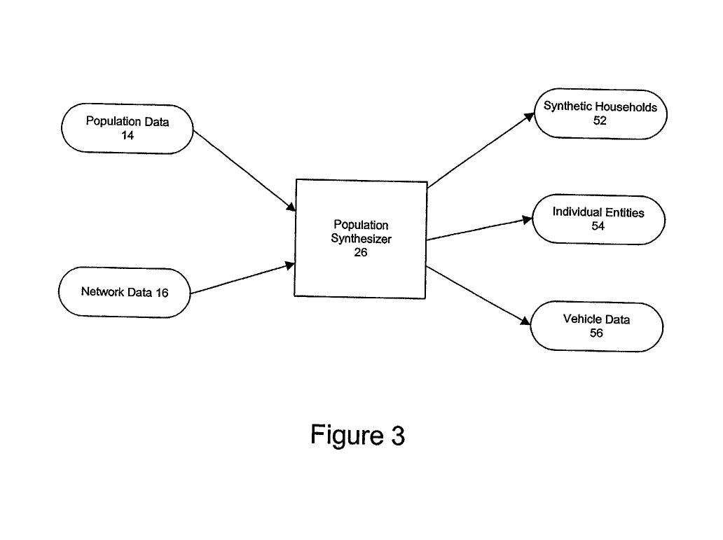

Referring to FIG. 3, a block diagram illustrates the types of data the population synthesizer 26 uses to generate a synthetic population of entities. For human entities, the population may include households including individual demographics and household location within the transportation infrastructure. The system 10 is based on the movement of individual entities between activities at different locations. Thus, the system 10 creates a synthetic population that represents every individual entity in a transportation network under study.

For a human population, population demographics are needed to create reality- based simulations. Such demographics determine the level of activity for each household. Demographic examples include the individual's age, income, gender, and employment status. Such demographics determine how each individual travels across the transportation infrastructure. For example, a six-year-old girl may take the bus to school, whereas 30-year-old executives may carpool to work.

For creating a human virtual population, the population synthesizer 26 may receive population data 14 such as:

U.S. Census Bureau Summary Tape File 3A (STF-3A) data;

U.S. Census Bureau Public Use Microdata Samples (PUMS); and forecast marginal demographic data.

The STF-3A data contains demographic summary tables from a census for small geographic areas, census tracts, or census block groups. Mostly one-dimensional, these summary tables contain information such as the distribution of the age of the householder or the number of workers in the family. Table 1 and Table 2 show typical STF-3A data.

TABLE 1
Number of workers in family households
for census tract 1, block group 2
of Los Alamos County, NM.
Number of Family Households, n,
with Number of Workers in Household

| | | | | |
|---|---|---|---|---|
| Workers | 0 | 1 | 2 | >2 |
| N | 0 | 121 | 214 | 25 |

TABLE 2
Age distribution of householders for census
tract 1, block group 2 of Los Alamos County, NM.
Number of Family Households, n, with
Householder Age in the Given Ranges

| Age | 15-24 | 25-34 | 35-44 | 45-54 | 55-64 | 65-74 | >74 |
|---|---|---|---|---|---|---|---|
| N | 4 | 134 | 94 | 46 | 46 | 36 | 0 |

PUMS contain files having the complete structure of each household, including the number of people in a given household, the household income, number of workers, and number of vehicles owned. These files may be edited to protect the confidentiality of all individuals, but they have the information necessary to conduct effective research and analysis. The forecast marginal demographic data contains the forecast marginal distributions, like those given above in Table 1, for household size, householder age, and household income as a function of census tract and block group. The forecast marginal demographic data must be created outside the system 10. Forecast marginal demographic data may typically be obtained by transportation planning agencies.

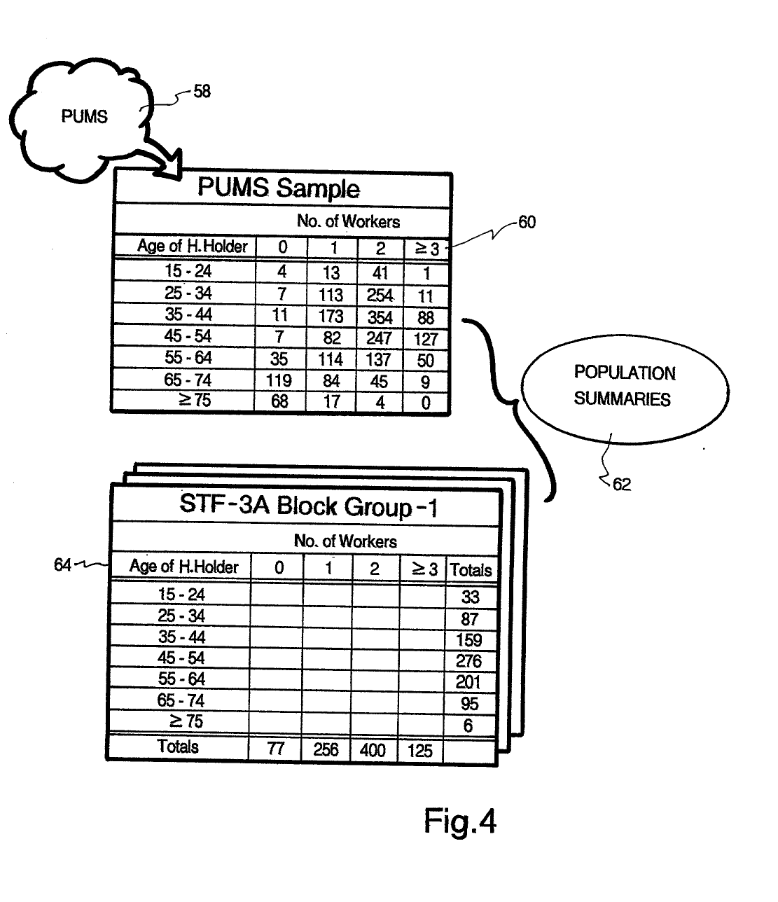

Referring to FIG. 4, a block diagram illustrates data used in generating a synthetic population. The population synthesizer 26 identifies a PUMS 58 and uses MABLE/Geocorr to obtain block groups 60 for the identified PUMS 58. The synthesizer 26 then obtains population summaries 62 from STF-3A 64 for the block groups 60 corresponding to the PUMS 58. The population summaries 62 may include age, family income, type of family (single parent, divorced, etc.), and number of workers in a household. The synthesizer 26 then constructs a multidimensional table from population summaries 62 from the PUMS 58 and ensures that the dimensions correspond with STF-3A64.

In one example, a multidimensional table would have four dimensions that correspond to four classifications: householder's age, the family's income, type of family, and number of workers in the household. Each household in the PUMS 58 has a household weight. The multidimensional table is composed of the sum of these weights for each of the households in the PUMS 58.

At this point, the proportion of households for each block group's classification is unknown. To determine this, the population synthesizer 26 may use a two-stage iterative proportional fitting procedure. Next, the block group 60 is updated for a forecast. Iterative proportional fitting uses the correlation structure of the generated block group demographic tables and the STF-3A type forecast demographics for the update. This procedure satisfies the distributions of the STF-3A data for each block group 60 while maintaining the correlation structure of the table constructed from the PUMS 58.

The population synthesizer 26 then selects households from the PUMS 58 to match the number of households in the census over a given geographic area, such as a block group or a census tract. The population synthesizer 26 uses land-use information to place each household within a block group at an activity location.

Land-use data may be stored in the network data 16 in the network activity location files. The network activity location files identify the activity locations, the corresponding block group and census tract, and provide an indication of the activities that may be performed at that location.

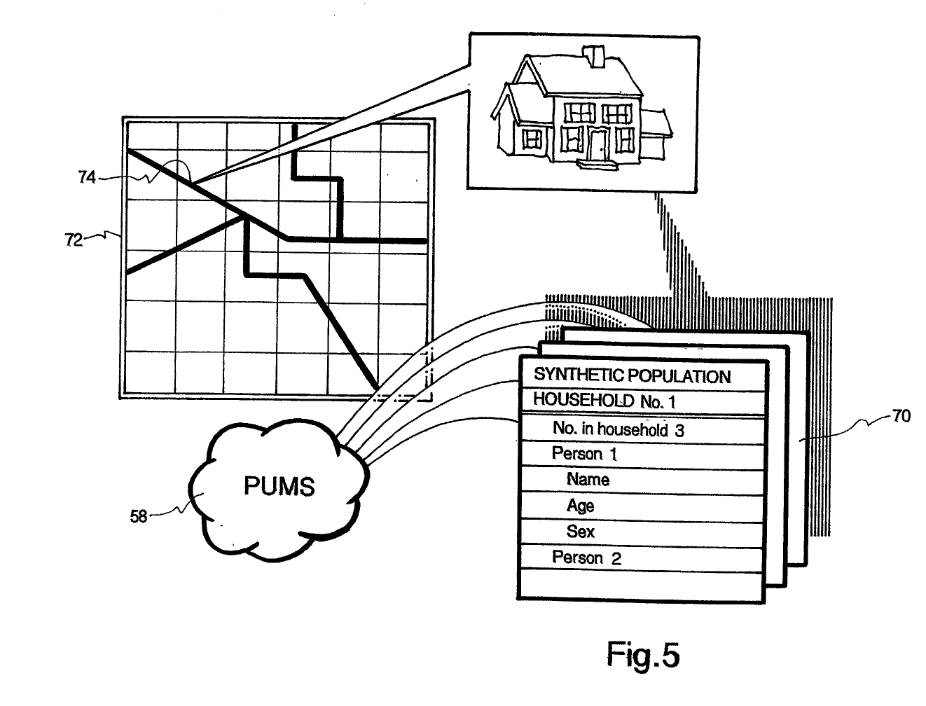

Referring to FIG. 5, a block diagram illustrates the creation of households 70 and placement within a network 72. The population synthesizer 26 identifies the activity locations within a block group before placing households 70 from the synthetic population at an activity location. Using land-use data, the synthesizer 26 determines a weight for each activity location. The weights are proportional to the probability that a household 70 will be placed at the activity location. In one embodiment, the weights may be determined by adding single family residential square footage to the multiple of the multifamily square footage for each activity location. In another embodiment, the number of households 70 on a block may be determined from phone books or tax data and used as the weights.

The population synthesizer 26 then divides each individual weight for an activity by the total weight of all the activity locations in a block group. The resultant ratios are used as the probability of a household 70 being located at an activity location. For each synthetic household 70, a random activity location, based on the probabilities, is selected. The household 70 is then placed at that activity location 74. Households 70 need not be placed at unique activity locations. Many households 70 can share the same activity location. The household location method may be applied to any metropolitan region that is being simulated. However, the weights given to the activity locations in a block group depend on the quality and availability of land-use data.

One of skill in the art will appreciate that household locations may be derived by using alternative methods. For example, a census block may be used to determine the number of households in a block. The number of households in a block could then be associated with an activity location and used as the weight. Alternatively, electronic phone books or aerial photography could be used to determine the number of households in a block.

The population synthesizer 26 outputs synthetic households 52 with a location in the network 72. Each household 52 in a synthetic population may be classified as either family, non-family, or individuals living in group quarters such as dorms. Each household 52 may contain at least one person. Family households contain one or more adults and possibly children. Household demographics vary in accordance with source data and study needs.

The system 10 assigns synthetic households 52 to activity locations 74 on an activity location of the network 72. Each activity location 74 is associated with the land-use characteristics that surround it.

The population synthesizer 26 further outputs individual entities 54 such as persons having characteristics. The characteristics may include gender, age, education, occupation, transportation, income and so forth.

The population synthesizer 26 may further output vehicle data 56 containing vehicles having characteristics such as identification, household or entity association, initial location in the transportation infrastructure, and type. Assignment of vehicle ownership may be performed in various ways. In one embodiment, the population synthesizer 26 uses the number generated from the synthetic population procedure using the PUMS 58. Alternatively, the synthesizer 26 assigns every possible driver a vehicle. In yet another embodiment, vehicle ownership is based on population demographics and network characteristics after generation of the synthetic population. Household vehicle ownership has been a factor in the choice of transportation modes.

The system 10 may use iterative methods to determine an entity's transportation mode so a refined vehicle ownership model may not be necessary. In either case, each vehicle represents an entry in a vehicle file within the vehicle data 56. Each file contains a vehicle identification number and the household 70 to which it is assigned.

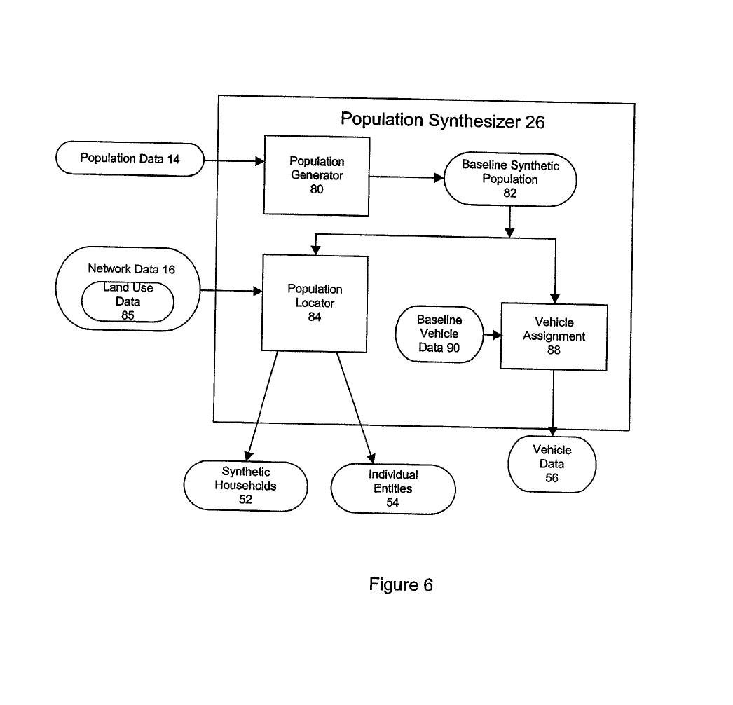

Referring to FIG. 6, a block diagram is shown that illustrates data output generated by the population synthesizer 26 based on data input. The population synthesizer 26 includes a population generator 80 that receives the population data 14. The population generator 80 generates a disaggregated baseline synthetic population 82 of entities based on the aggregated population data 14. Thus, the population generator 80 creates a synthetic population over a geographic area of census groups that maintain the statistical characteristics of the census. However, as shown in Table 3, the summary data for block groups from STF-3A 64 do not give the entries for any cross-classified demographics.

TABLE 3
The cross-classification of the number
of workers and the age of the householder for census
tract 1, block group 2 of Los Alamos County, NM, is unknown.
Householder Age

| Workers | 15-24 | 25-34 | 35-44 | 45-54 | 55-64 | 65-74 | >74 | Total |
|---|---|---|---|---|---|---|---|---|
| 0 | ? | ? | ? | ? | ? | ? | ? | 0 |
| 1 | ? | ? | ? | ? | ? | ? | ? | 121 |
| 2 | ? | ? | ? | ? | ? | ? | ? | 214 |
| >2 | ? | ? | ? | ? | ? | ? | ? | 25 |
| Total | 44 | 134 | 94 | 46 | 46 | 36 | 0 | |

A synthetic population may be easily generated if cross-classified tables exist for small areas such as block groups. Because PUMS 58 contains complete household records, the household records could be drawn at random, satisfying the marginals of the cross-classified tables for the block groups. In one embodiment, the cross-classified tables for the block groups are estimated. This estimation process satisfies the totals as given by STF-3A 64.

A method for generating a synthetic population is now summarized. First, the population generator 80 selects a reasonable set of demographics from STF-3A 64 that characterize the population. Next, the population generator 80 estimates the proportions in cross-classified tables made up of the selected demographics for the block groups in the PUMS 58. Finally, the population generator 80 draw households 70 at random from the PUMS 58 corresponding to the block group so that the estimated proportions in the cross-classified table are satisfied.

Although cross-classified tables cannot be derived from STF-3A 64 for small areas, multi-way summary tables can be created for an entire area represented by a PUMS 58. Table 4 provides the multi-way table for this area. It shows the number of workers in a family and the age of the householder.

TABLE 4
The cross-classification of the number of workers
and the age of the householder for a PUMS, which
contains census tract 1, block group 2 of Los Alamos County, NM.
Householder Age

| Workers | 15-24 | 25-34 | 35-44 | 45-54 | 55-64 | 65-74 | >74 | Total |
|---|---|---|---|---|---|---|---|---|
| 0 | 2 | 11 | 9 | 3 | 26 | 64 | 42 | 157 |
| 1 | 11 | 108 | 122 | 48 | 80 | 61 | 18 | 448 |
| 2 | 28 | 135 | 274 | 156 | 85 | 22 | 6 | 706 |
| >2 | 0 | 3 | 65 | 76 | 40 | 10 | 3 | 197 |
| Total | 41 | 257 | 470 | 283 | 231 | 157 | 69 | |

To estimate the proportions in the cells of multi-way block group tables, the population generator 80 uses iterative proportional fitting (IPF) of the block group summaries to the cross-classified values in the PUMS 58. IPF ensures that the correlation structure of the demographics for every entity that contributes to the block groups is the same as the correlation structure in the multi-way tables constructed from the PUMS 58.

The IPF methodology assumes that there is a sample from a multi-way classification of characteristics, and the exact totals for the margins of the multi-way table. IPF estimates the entries in the multi-way tables with fixed marginals, in this case the STF-3A 64 summary data, while maintaining the correlation structure of the sample table, in this instance, the PUMS 58. The algorithm begins by converting all summaries and tables to proportions of the total. For example, Table 3 and Table 4 become Table 5 and Table 6, respectively. In terms of proportions, the PUMS 58 sample for these two demographics is shown in Table 7.

TABLE 5
Proportion of workers in family households for
census tract 1, block 2 of
Los Alamos County, NM.
Proportion of Family Households, n,
with Number of Workers in the Household

| | | | | |
|---|---|---|---|---|
| Workers | 0 | 1 | 2 | >2 |
| Prop. | 0.000 | 0.336 | 0.594 | 0.069 |

TABLE 6
Proportion of ages of householders for census tract 1,
block group 2, of Los Alamos County, NM.
Proportion of Family Households, n, with Householder
Age in the Given Ranges

| Age | 15-24 | 25-34 | 35-44 | 45-54 | 55-64 | 65-74 | >74 |
|---|---|---|---|---|---|---|---|
| Prop. | 0.011 | 0.372 | 0.261 | 0.128 | 0.128 | 0.100 | 0.000 |

TABLE 7
Cross-classification of the proportion of workers
and the age of the householder for a PUMS, which contains
census tract 1, block group 2 of Los Alamos County, NM.
Householder Age

| Workers | 15-24 | 25-34 | 35-44 | 45-54 | 55-64 | 65-74 | >74 | Total |
|---|---|---|---|---|---|---|---|---|
| 0 | 0.001 | 0.007 | 0.006 | 0.002 | 0.017 | 0.042 | 0.028 | 0.104 |
| 1 | 0.077 | 0.072 | 0.081 | 0.032 | 0.053 | 0.040 | 0.012 | 0.297 |
| 2 | 0.019 | 0.090 | 0.182 | 0.103 | 0.056 | 0.015 | 0.004 | 0.468 |
| >2 | 0.000 | 0.002 | 0.043 | 0.050 | 0.027 | 0.007 | 0.002 | 0.131 |
| Total | 0.027 | 0.170 | 0.312 | 0.188 | 0.153 | 0.104 | 0.046 | |

IPF converts the PUMS 58 proportions in Table 7 so that they have the same row and column proportions as the STF-3A 64 data given in Table 5 and Table 6. IPF accomplishes this by first changing the rows then the columns. This is done by updating the first row of Table 7 by multiplying each entry by the first marginal proportion for that row given in Table 5 and dividing by the total for that row on the last iteration. In this case, the first element of the first row of Table 7 becomes 0.001 *0.000/0.104=0.000.

This process continues with the remainder of the rows of Table 7, where (for example) the third entry of the second row becomes 0.081*0.336/0.297=0.092. After all the rows are updated, the same procedure is applied to each column. The procedure continues by alternating between rows and columns until the table entries no longer change. For tables with more than two dimensions, the same procedure is followed—updating one dimension at a time. Table 8 shows the final results of this procedure, based on the data in Table 7.

TABLE 8
Estimated cross-classification of the proportion of
workers and the age of the householder for families in
census tract 1, block group 2 of Los Alamos County, NM.
Householder Age

| Workers | 15-24 | 25 34 | 35-44 | 45-54 | 55-64 | 65-74 | >74 | Total |
|---|---|---|---|---|---|---|---|---|
| 0 | 0.000 | 0.000 | 0.000 | 0.000 | 0.000 | 0.000 | 0.000 | 0.000 |
| 1 | 0.003 | 0.141 | 0.061 | 0.020 | 0.047 | 0.063 | 0.000 | 0.336 |
| 2 | 0.009 | 0.228 | 0.178 | 0.086 | 0.065 | 0.030 | 0.000 | 0.594 |
| >2 | 0.000 | 0.003 | 0.022 | 0.022 | 0.016 | 0.007 | 0.000 | 0.069 |
| Total | 0.011 | 0.372 | 0.261 | 0.128 | 0.128 | 0.100 | 0.000 | |

If required, the forecast procedure updates these tables. In either case, the last step in household generation is to draw samples from the PUMS 58. There are 360 family households 70 in the block group 60 given below. For this block group 60, 360 households 70 are generated one at a time. This is done by selecting at random a category of age and the number of workers according to the probabilities in Table 8.

Given the category (e.g., a householder between 45 and 54 years of age in a household with two workers), one of the households 70 in the PUMS 58 matching these demographics is drawn at random. In this case, one household 70 may be drawn from the 156 households possible, as shown in Table 4. This process is repeated 360 times to form a population that matches the census. Note that the same household 70 from the PUMS 58 may be selected multiple times by this procedure.

TABLE 9
Estimated cross-classification of the
proportion of workers and the age of the householder
for families in census tract 1, block group 2 of Los Alamos County, NM.
Householder Age

| Workers | 15-24 | 25-34 | 35-44 | 45-54 | 55-64 | 65-74 | >74 | Total |
|---|---|---|---|---|---|---|---|---|
| 0 | 0.000 | 0.000 | 0.000 | 0.000 | 0.000 | 0.000 | 0.000 | 0.000 |
| 1 | 0.003 | 0.141 | 0.061 | 0.020 | 0.047 | 0.063 | 0.000 | 0.336 |
| 2 | 0.009 | 0.228 | 0.178 | 0.086 | 0.065 | 0.030 | 0.000 | 0.594 |
| >2 | 0.000 | 0.003 | 0.022 | 0.022 | 0.016 | 0.007 | 0.000 | 0.069 |
| Total | 0.011 | 0.372 | 0.261 | 0.128 | 0.128 | 0.100 | 0.000 | |

Tables 1, 3, and 4, show that fitting only one block group 60 at a time using IPF is not entirely correct. IPF is based on the assumption that the seed proportions, as given by the PUMS 58, Table 7, are a sample of the population that produces the exact marginal totals given by STF-3A 64 (shown here in Table 7). Table 1 shows there are no households with 0 workers in the block group, while Table 4 shows many 0-worker households. The PUMS 58 consists of a sample of households 70 that contain all or parts of multiple block groups 60. In this case, block group 2 of census tract 1 from Los Alamos County is just one of the many block groups 60 in PUMA 00400. PUMA 00400 contains all of the block groups in Los Alamos and Santa Fe counties of New Mexico. That PUMA 00400 is a sample of multiple block groups is evident from PUMS 58.

The population generator 80 may use a two-step procedure to modify the IPF routine so that the generator 80 can simultaneously consider all block groups 60 that make up an area. A final step may be added to take into account the forecast marginal inputs. The population generator 80 assembles each block group 60 in an area from the MABLE/Geocorr database. In a small percentage of cases, a block group 60 is split between multiple areas. In such cases, the summary totals are reduced by the proportion of the block group's 60 households 70 in the area. The population generator 80 then collects the marginal STF-3A 64 tables for the block groups 60 in the area. The population generator 80 then constructs from the PUMS 58 a multi-way demographic table that matches the demographics from the STF-3A 64 tables for the corresponding area. The entries of this table are the sums of the household weights from the PUMS 58.

The population generator 80 adds the marginal tables for all the block groups 60 in an area. Next, the generator 80 estimates a multi-way table for the entire area by using an IPF fit of this summed table to the PUMS 58. The generator 80 then uses the estimate table as an additional marginal table and creates an (m+1)-dimensional table. The first m dimensions are the m marginals from STF-3A 64, whereas the m+1^{st} marginal is created by stacking all of the marginal tables. This (m+1)-dimensional stacked table, along with the table estimated from the sums, are the marginal tables used in an IPF procedure to an (m+1)-dimensional table consisting entirely of ones. This results in an estimated multi-way table for each block group 60 in the area.

The population generator 80 draws random households 70 from the PUMS 58 that match the demographics of each of the cells of the estimated multi-way table for each block group 60. Multiple demographics from STF-3A 64 are used to create the baseline population 82. Synthetic households 58 may be divided into three categories: Family Households ( households with two or more related individuals), Non-family Households (individuals living alone or unrelated individuals living together), and Group Quarters (dwellings such as college dormitories). Because travel activity can depend on the household type, a baseline population 82 of households and group quarters is generated for each of the three types.

Minor adjustments must be made to the IPF routine to handle marginal summaries in table form. For example, two-way marginals are considered to be one marginal by the IPF routine. Such marginal tables are converted to a single demographic whose categories consist of all the combinations of the two demographics involved. The last step in the creation of the synthetic population is to assign a unique number to each household 70 and each person in the population.

The baseline population 82 is produced on a block-group basis and provides the individual entities 54 that are associated with each household 70. No information about the exact location of individual households 70 of the baseline population 82 in the block-group is known. The population synthesizer 26 includes a population locator 84 that receives the baseline population 82 and the network data 16. In order to place each household 70 in the baseline population 82 on the network 16, land use data 85 contained in the network data 16 is used.

Each household 70 in the population is located at an activity location 74 in the network 72. Each network 72 may include activity locations 74 which are those places in the network 72 in which activities may take place. Associated with these locations is a set of land-use characteristics that indicate the type of activities that may take place at that location.

Each network 72 has a unique set of land-use characteristics associated with its activity locations. Land use is used to form a weighting factor for each activity location 74 that represents the relative likelihood of a housing unit being placed there. The exact formulation of these weights depends on the network 72 under investigation and the availability of land-use information. For a network 72 representing a real metropolitan area, the land use could, for example, contain the square footage of single-family residential housing along with the square footage of multi-family housing that surrounds the activity location 74. The weights for the activity locations 74 could be formed by adding the square footage of single-family residential housing to a multiple of the square footage of multifamily housing.

Given the housing weights associated with each activity location 74 on the network 72, households 70 are placed on locations. The population locator 84 identifies all activity locations 74 within a block group 60. The locator 84 may denote the associated household weights for these activities by wᵢ and compute the probabilities as follows: pᵢ=wᵢ/Σw_{I}. Each individual household 70 in the block group 60 is assigned to one of the n activity locations according to the probabilities, pᵢ. The location of the households 70 is one of the required demographics for each synthetic household 52.

The households 52 and entities 54 may be assigned unique numbers. An entity identification number is a unique identifier carried through the route planner 30 to the micro-simulation module 32. All output that is entity-oriented references these numbers.

The population synthesizer 26 further includes a vehicle assignment module 88 that receives the baseline population 82 and baseline vehicle data 90 and assigns vehicle types to each vehicle in the population. The baseline vehicle data 90 may include aggregated data regarding vehicles used in the region. The vehicle assignment module 88 generates the output vehicle data 56 that is associated with the household data 52 and individual entities 54.

In this manner, each household 52 may be created with a number of vehicles assigned to it. These vehicles have a unique number and are identified as belonging to the household 52. Each vehicle is also assigned a starting location, which consists of one of the parking locations on the driving network. Traditionally, this location has been the parking location closest to the household location. This information is written to the vehicle data 56.

Each vehicle driver has an entry in the synthetic population. Therefore, fictitious individuals are added to the population to represent those who travel on the network 72 but do not live in the area undergoing study. Known as “itinerant travelers,” these are added to the synthetic population as single-person households, each with one vehicle. The same is true for transit drivers and freight haulers.

These households 52, along with the individual entity 54, are given their own unique household and person number. If demographics are added to the actual synthetic entities 54 or households 52, the same demographics must be added to the itinerant traveler population. In some cases, these may be meaningless numbers because the activity list for these travelers is generated from origin-destination tables independent of the individual entity's demographics.

In equity studies, itinerant travelers can be viewed as a separate population. Every itinerant traveler may own one vehicle. The vehicle is given a unique number and type and is placed in the vehicle file. The starting location of these vehicles is the parking location where the traveler's trip begins. These starting points are most likely on the boundary of the study area, as itinerant travelers are those that are passing through the area or entering the area from the outside.

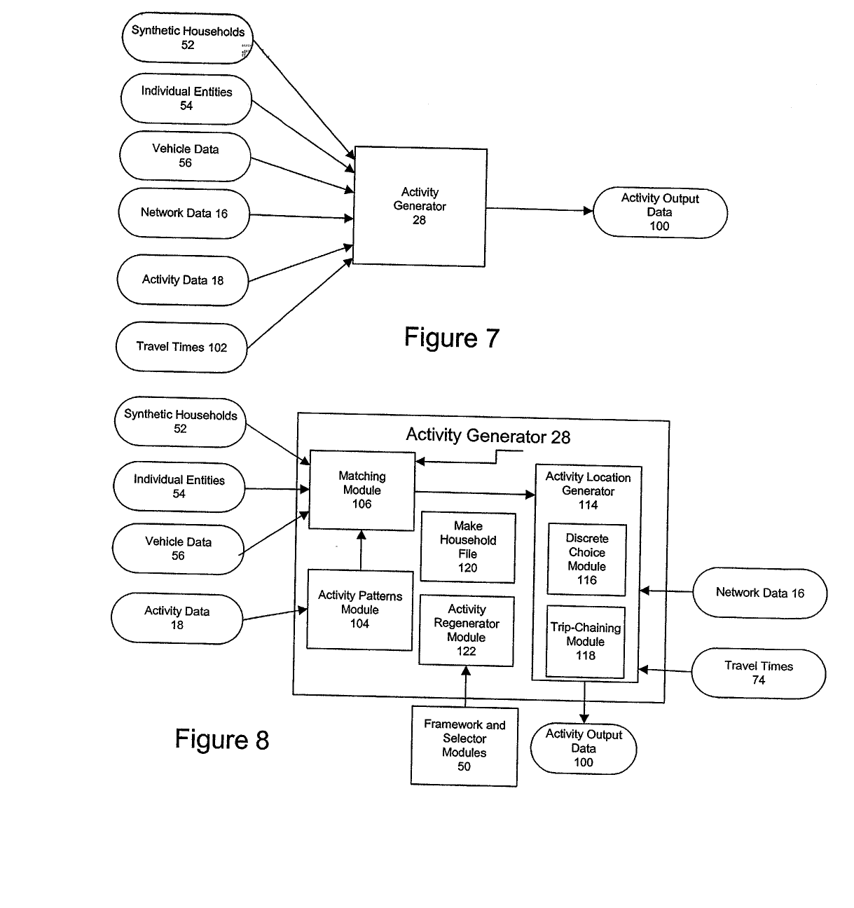

Referring to FIG. 7, a block diagram illustrates the data inputs that the activity generator 28 uses to generate activity output data 100. The activity generator 28 serves to capture individual entity 54 and household 52 behavior accurately. The activity generator 28 is responsive to inter-household behavior such that if an individual entity 54 of a household 52 escorts a child to school another entity need not do so.

The activity generator 28 operates under the assumption that any two activities, separated by time and location, require travel between them. The degree of detail in both the synthetic population and activities can vary, depending on the availability of data and the study being performed. For example, a more detailed study with more realistic traffic requires a more detailed and realistic representation of the metropolitan population and the activities in which the population engages.

The activity generator 28 receives the individual entity data 54 and vehicle data 56 that have been located in space within the network 72. The demographics in the entity population match the demographics that are used in the activity generator 28. The demographics are used to select a suitable household activity pattern.

The activity generator 28 further receives network data 16 that includes the locations of activities with the associated land use data 85, such as employment, recreation, and so forth for human entities. Each activity has a time for the activity to occur and a location that is included in the network data 16. The location is one of the activity locations 74 listed in an activity location file in the network data 16.

The activity generator 28 further receives activity data 18 to derive household activities. The activity data 18 may include surveys and other aggregated activity data that are representative of the population. The activity data 18 may include travel and activity participation of all individual entities 54 in a household 52. Simple activity patterns may be created by stripping locations from the activity data 18.

The activity generator 28 further receives travel times data 102 that represent travel time from various nodes in the infrastructure based on modes of transportation. The travel times data 102 may be estimated initially. After running the simulation, experienced travel times data 102 may be generated by the micro-simulation module 32 and provided through the framework and selector modules 50 as feedback data. The travel times data 102 may therefore include experienced travel times.

The activity generator 28 uses activity location tables form the network 16 that contain land use and employment information for determining the locations of activities from activity patterns. The activity generator 28 produces activity output data 100 that is disaggregated and associates the activities with individual entities 54. Each activity may have its own vector including activity type, activity priority, starting and ending times, vehicle preference, and location preference. During any given time in the simulation, an individual entity 54 is associated with an activity and with a household 52. Each individual entity 54 is associated with an activities list with attributes such as, type of activity, starting time range, ending time range, activity duration range, travel mode preference, and location. The type of activity may include travel, home, work, shopping, or other activity types contained with the aggregated activity data 18.

In addition to the time and location, the activity generator 28 assigns a travel mode to reach the activity. If two or more entities 54 are making the same trip, in particular, a driving trip, the entities 54 are identified as part of the activity list.

The activity generator 28 overlays each household 52 with a complete activity pattern. In so doing, the activity generator 28 processes activity data 18 to obtain a decision tree based on the total time spent in activities-by-activity type for each surveyed household 52. These times are weighted and summed to form a measure of total time spent in activities for each household 52. Demographic variables of the household 52 and the entities 54 in the household 52 are selected based on which ones make the best predictors of the activity duration time. A predictor takes the form of a decision tree. The tree's terminal nodes are selected to be as homogenous as possible with respect to household activities.

Once a decision tree is constructed, each household from the activity data 18 is classified as belonging to one of the tree's terminal nodes. More than one household is usually assigned to each of the terminal nodes.

To allocate base activity patterns to individual households 52 in the synthetic population, they are classified according to the decision tree, and given an activity pattern of one of the survey households that were similarly classified as belonging to that node. Drivers and passengers on shared trips within the household 52 are identified. The skeletal activity pattern provides all necessary information for household interactions, including shared rides.

Initial travel times 102 between activity locations 74 are estimated by using average times or calculated by using feedback from the route planner 30 or the micro-simulation module 32 for specific mode preferences. A modified discrete choice model based on land-use data and travel times 102 determines the locations of the activities, given the base activity pattern. Work locations are chosen first. Other activities may be added using a multi-nominal logistic choice model.

Referring to FIG. 8, a data flow diagram is shown that illustrates the activity output data 100 generated by the activity generator 28 based on data input. The activity data 18 is received by an activity patterns module 104 which derives household activities. The activity patterns module 104 further conforms the activity patterns in accordance with travel and organizes, by trips, an activity list for each person in the household. The activity patterns module 104 sends a library of skeletal activity/travel patterns to a matching module 106. The matching module 106 further receives household data 52, individual entities 54, and vehicle data 56. The matching module 106 matches the activity patterns to each household 52 based on the individual entities 54 within the household 52.

The matching module 106 may use a tree-structured classification based on household demographics to make the matches. Each synthetic household 52 is assigned to a unique node in the tree. After the synthesized household 52 is assigned to its tree node, the matching module 106 selects a survey household at random relative to the weights given to the survey households from the same node to obtain a matching household. The matching module 106 assigns the skeletal patterns for the survey household members to the matching members in the synthesized households 52.

The matching module 106 further groups household members to trips. The final activity set includes a list of participants for each activity. Because households 52 are matched on demographics, an activity list for an entity 54 in the matching survey household is appropriate for an entity 54 in the reconstructed household 52 except for activity location.

Cross-tabulation of households 52 by demographic variables can create many cells with few or no households in the survey. Instead of matching through some kind of table, household matching locates households 52 in the terminal nodes of a binary tree. Although the binary tree is sensitive to the characteristics of household behavior, it is also parsimonious with respect to household characteristics that do not affect behavior.

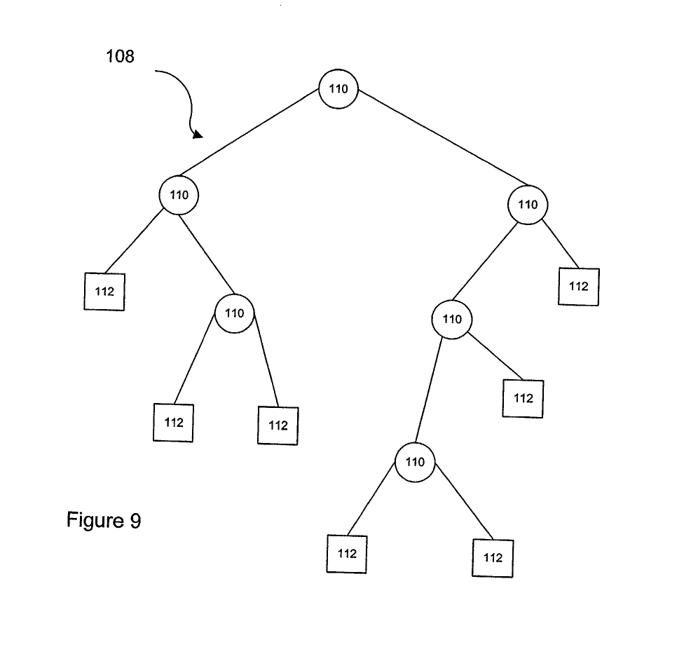

Referring to FIG. 9, a sample of a binary matching tree 108 is shown. Actual trees used in generating activities are much more complicated and will be specific to each particular transportation study. The tree 108 is constructed with an abbreviated list of three household demographic variables: hhsize (household size); agelt5 (number in household aged less than 5); and age5 to 17 (number in household aged 5 to 17). The tree 108 has 13 nodes, including six non-terminal nodes 110 and seven terminal nodes 112 identified as squares.

Table 9 defines these seven terminal nodes 112. At each non-terminal node 110, a household 52 is classified further into either a left or right “child” node according to a simple rule given by a demographic variable and split point. If the appropriate variable is less than the split point, the household 52 is classified into the left node; otherwise the right node is selected. The first choice (node 1) is on household size, hhsize. If hhsize is less than 2.5, the household 52 falls somewhere in the left nodes. Otherwise, further classification proceeds to the right. The procedure continues recursively until a terminal node 112 is reached.

TABLE 9
Terminal nodes.

| Node | Description |
|---|---|
| 3 | Household size = 1 |
| 5 | Household size = 2, no children less than 5 |
| 6 | Household size = 2, 1 child less than 5 |
| 10 | Household size = 3, no children less than 5, no children |
| | between 5 and 17 |
| 11 | Household size = 3, no children less than 5, at least 1 child |
| | between 5 and 17 |
| 12 | Household size = 3, at least 1 child less than 5 |
| 13 | Household size greater than 3 |

The first step in generating a set of activities is to locate the synthetic household 52 in its unique terminal node 112 of the tree 108. A household activity patterns is then selected at random from the node 112. For flexibility, weights are used in choosing the household activity pattern. Each pattern has weight wᵢ assigned to it. If N is the terminal node 112 for the synthetic household 52, household activity pattern i in node N is chosen with the following probability:

$$p ( i ) = \frac{{w}_{i}}{{\sum }_{j ∈ N}^{} {w}_{j}} .$$

Synthetic household members may be matched to members in the household activity pattern based on the four demographic variables. These variables may include relation to the head of the household, work status, gender, and age.

Although perfect matches are not always possible, the matching module 106 attempts to find the best matches possible. The pool of household activity patterns in the matching node may be divided into households with and without children if the demographics at the node permit households with children. This division enables matching synthetic adults and children without resampling.

The matching module 106 matches children to children and adults to adults. The children in the synthetic household 52 may be sorted by gender and descending age. Children in the household activity pattern are sorted in the same way, and a one-to-one match is made between the two sorted lists. If the household pattern has more children than the synthetic household 52, the extra children in the household pattern are ignored. If the synthetic household 52 calls for more children than the household pattern has, the activities of the last child in the household pattern are replicated as often as necessary to create activities for the remaining children in the synthetic household 52. If a synthetic household 52 contains more adults than the household activity pattern, the activities of the last adult in the household pattern are replicated as often as necessary.

A multivariate regression tree program can assist in constructing a binary tree 108 that matches synthetic households 52 to household activity patterns. A regression tree is a technique for modeling a regression relationship between a dependent variable Y and independent variables X₁, X₂, . . . , Xₚ. Regression trees are useful when there are a large number of explanatory variables and there is an expected complex relationship between the response variable and the explanatory variables.

In these cases, tree-based methods may more easily capture non-additive behavior and thus be easier to interpret than linear models. The basic idea is to partition the data set into nodes defined by the predictor variables X₁, X₂, . . . , Xₚ, and to model the response as a constant within each node. A binary tree 108 defines these nodes. Tree modeling may consist of two stages: a forward recursive algorithm for “growing” the tree, and a second stage where the tree is “pruned back.” Because the growing process is only in the forward direction once a node is defined, it cannot change, and the algorithm does not necessarily produce an optimal tree. The strategy is to begin by growing a very large tree, one that probably “overfits” the data, then to use a second algorithm, thus balancing faithfulness to the data with the complexity of the tree to select a good subtree.

Defining the recursive algorithm may be performed by observing a single “parent” node P_{I} as part of tree T. At the next stage, the parent node is split into two “children” nodes: a left node, Lᵣ, defined as all I′ observations in P_{I} with Xᵢⱼ≦t, and a right node, R_{I} where Xᵢⱼ>t for a suitable choice of variable Xᵢⱼ and cut point t. The optimal variable and cut point for the split are defined in terms of the “deviance” of the node, given as:

$$D ( N ) = {\sum }_{i ∈ N}^{} {( {Y}_{i} - \overline{Y} )}^{2} ,$$

which is the corrected total sum of squares for the observations in the node. For a potential partition split on variable Xⱼ at cut point t, define the reduction in deviance from the split as:

Δ_{j,t}=D(P)−(D(L)+D(R)).

A search is conducted over all j and t to find the pair j*, t* such that

$${Δ}_{{j}^{*} , {t}^{*}} = {max}_{j , t} ( {Δ}_{j , t} )$$

subject to, I′, I″>some minimum (say 10) and D(P) >0.01*D(total) where D(total) is the deviance in the dependent variable before any splits are made. If either condition fails, the parent node is a terminal node. The algorithm recursively splits nodes until they all become terminal nodes.

Prediction for a regression tree begins when the dependent variable Y is estimated by the mean value of Yin each node. However, the binary tree 108 from the growing algorithm generally overfits the data.

A common way to assess how well a tree fits is by using it to predict a new set of data. In this case, deviance is replaced by a sum-squared prediction error. It is from this that the best subtree in the sense of minimizing prediction error can be determined. The selected tree partially depends on the data set selected to be held out. Holding out such a subset for validation may prove wasteful. The data set may be randomly partitioned into ten approximately equal parts. Each part is held out in turn. A subtree T′ is then re-estimated on the remaining 90% of the data, and the re-estimated tree is used to forecast the 10% held out.

Let CVᵢ(T′) denote the sum squared prediction error for the ith partition. The process is repeated for all ten subsets of the data, and a total cross-validation score,

$$CV ( T ) = {\sum }_{i}^{} {CV}_{i} ( {T}^{′} )$$

is computed for the subtree. A subtree that minimizes (or nearly minimizes) CV(T′) is a good final choice for a tree that is appropriate for the data.

The following extended definition of deviance is used to implement a multivariate regression tree. Suppose we have dependent variables Y₁, . . . ,Y_{d} and node N with I′ observations. Let the deviance at node N with respect to variable Yⱼ be given as

$${D}_{j} ( N ) = {\sum }_{{i}^{′}}^{} {( {Y}_{{i}^{′} j} - {\overline{Y}}_{j} )}^{2}$$

with the total deviance at node N

$$D ( N ) = {\sum }_{j}^{} {s}_{j} {D}_{j} ( N ) = {\sum }_{j}^{} {\sum }_{{i}^{′}}^{} {{s}_{j} ( {Y}_{{i}^{′} j} - {\overline{Y}}_{j} )}^{2}$$

where sⱼ=1/var(Yⱼ) and is a scale factor. Then for a tree T,

$$D ( T ) = {\sum }_{j}^{} {s}_{j} {D}_{j} ( T ) = {\sum }_{j}^{} {\sum }_{i}^{} {{s}_{j} ( {Y}_{ij} - {\overline{Y}}_{j} )}^{2}$$

is the scaled total sum of squares for the I observations in the tree. Nodes can now be split by using total deviance instead of the single-variable deviance. With this new definition of total deviance, a regression tree can be grown and pruned as before. When coupled with cross-validation, this definition of deviance can be used to prune a tree to a proper size.

In the activity generator 28, the trees may be constructed using the total times households 52 spend in 15 broadly classified activity types as the values of Yᵢⱼ. An additional Y value is the number of trips the household 52 makes. The predictor variables may be all of the demographic variables collected in a survey. While these are reasonable variables to construct the tree, any variables could be used.

Referring again to FIG. 8, the matching module 106 provides the matched activity patterns for each household 52 to an activity location generator 114. The activity location generator 114 may use a discrete choice module 116 to select appropriate zones for all activities within the network. The activity location generator 114 then uses land-use variables to find specific activity locations 74 within zones for each activity. The activity location generator 114 may use the discrete choice module 116 to generate primary locations, such as work or school locations. A trip-chaining model 118 may then be used to generate locations for other activities.

The discrete choice module 116 may be a simplified multinomial logistic choice model, defined with the following terms. L is a destination zone for primary activity. a(L) is an attractor for primary activity in zone L. Often expressed as a(L) c′x(L), where x(L) is a vector of land-use variables for zone L, and c is a coefficient vector fit by maximum likelihood. It is also possible to use other specifications for a(L), including a nonparametric model for a continuous distribution fit from data. t(H,L) is the travel time from home location H to work location L. bₘ is a coefficient for mode choice m. The destination zone may be selected according to the probability distribution:

$$p ( L ) = \frac{exp ( a ( L ) + {b}_{m} t ( H , L ) )}{{\sum }_{{L}^{′}}^{} exp ( a ( {L}^{′} ) + {b}_{m} t ( H , {L}^{′} ) )} .$$

The initial mode choice is taken from the skeletal household activity pattern. After the zone is selected, a specific activity location 74 within the zone is selected at random according to weights determined by the discrete choice model 116.

The system 10 starts with an empty network 72, and the activity generator 28 may not have access to realistic travel times 102. Travel times 102 can be fed back from the route planner 30 or the micro-simulator module 32 to the activity generator 28 to refine the location choice probability model. With the travel time updates, the framework and selector 50 modules are used to develop models for mode and location choice.

To generate locations for other activities, the activity generator 28 may employ the trip-chaining model 118. In one example, a trip chain may consist of two stops on the way from work and home locations. In the example, the skeletal pattern calls for travel from primary location L to visit at L₁ by mode m₁, a second stop to shop at location L₂ by mode m₂, and finally returning home by mode m₃. The work and home locations are known. The other two destination zones, L₁ and L₂, are determined successively. For the first location, L1, the work location L and the home location H are used in the following equation as the anchor locations of the trip:

$$p ( {L}_{1} ) = \frac{exp ( {b}_{m1} t ( L , {L}_{1} ) + a ( {L}_{1} , v ) + {b}_{m2} ( {L}_{1} , H ) )}{\sum exp ( {b}_{m1} t ( L , {L}_{1}^{′} ) + a ( {L}_{1}^{′} , v ) + {b}_{m2} t ( {L}_{1}^{′} , H ) )} ,$$

where the sum is over all zones. After L₁ is chosen, L₁ replaces the work location L as the first anchor location for choosing the shop location L₂. In this example, separate attractors a(L, t) are defined for each location L and activity type, where the type is either v for “visit” or s for “shop.” After the zone is selected, specific activity locations 74 within the selected zone are chosen by the above formula with the activity locations 74 replacing the zone locations.

The activity generator 28 may calculate travel times between different zones in various ways. The activity generator 28 may use a travel times file that contains travel times 102 for zone pairs by mode and by time of day. Alternatively, the activity generator 28 may code and compile a travel time function. In yet another method, the activity generator 28 computes travel times 102 based on distance and default speeds for a given mode. Travel times 102 are used within computation loops that are called repeatedly in location choice algorithms. Therefore, methods to calculate the travel time 102 in a travel time function should be computationally efficient to avoid extended run times in the activity generator 28.

Activity times are taken from skeletal activity patterns and may be changed to allow for the estimated travel time between the activities since the location of the activity will be different from the location in the pattern. Entity intent is preserved in the activity list by maintaining the duration of the activities except for the initial at-home activity. Each activity has a preferred start time, end time, and duration. The range of each of these times is specified by a beta distribution, which requires four parameters: lower bound L, upper bound U, and “shape” parameters a and b.

When a=1 and b=1, no preference is indicated within the range L to U. If a=1 and b=−1, the range is assumed to be 0 around the preferred time. Preferred times are taken directly from the skeletal patterns. Table 10 gives possible values of the remaining parameters that may be implemented in the activity generator 28. The actual travel times 102 between two activities given by this method may be infeasible. Using output from the micro-simulation module 32 or the route planner 30, the framework and selector module 50 can request new times for these activities.

TABLE 10
Settings of time parameters for
activities. “Obs.” means observed time
taken from skeletal pattern. Times are in hours.

| Type of activity | | L | U | a | b |
|---|---|---|---|---|---|
| Work | Start | Obs. − .25 | Obs. + .25 | 1 | 1 |
| | End | Obs. − .25 | Obs. + .25 | 1 | 1 |
| | Duration | Obs. − .25 | Obs. + .25 | 1 | 1 |
| Other out-of-home | Start | Obs. − .50 | Obs. + .50 | 1 | 1 |
| | End | Obs. + .50 | Obs. + .50 | 1 | 1 |
| | Duration | Obs. − .3(obs.) | Obs. + .3(obs.) | 1 | 1 |
| AM beginning at-home | Start | 0 | 0 | −1 | −1 |
| | End | Obs. − .75 | Obs. + .75 | 1 | 1 |
| | Duration | Obs. − .75 | Obs. + .75 | 1 | 1 |
| Home during day | Start | Obs. − .75 | Obs. + .75 | 1 | 1 |
| | End | Obs. − .75 | Obs. + .75 | 1 | 1 |
| | Duration | Obs. − 1.00 | Obs. + 1.00 | 1 | 1 |
| PM end at-home | Start | Obs. − .75 | Obs. + .75 | 1 | 1 |
| | End | 24.00 | 24.00 | −1 | −1 |
| | Duration | Obs. − .75 | Obs. + .75 | 1 | 1 |

The activity generator 28 may use parallel computations to efficiently generate activities for a population. The activity generator 28 may include a make household file module 120 that creates a set of household files that collectively contain all of the households 52 in the population file. The activity generator 28 may operate in parallel using the set of household files and a parameter to identify the appropriate household file to use.

The framework and the selector modules 50 receive feedback from the route planner 30 and micro-simulation modules 32 to request changes in activity mode preferences, times, and locations. Using feedback, it is possible to begin with a “rough” activity output data 100. Once the feedback begins, a refined activity output data 100 emerges.

When the route planner 30 or micro-simulation module 32 detects a set of impossible activities, new locations, mode preferences, and activity times can be generated or the entire household's set of activities can be regenerated.

An activity regenerator module 122 is used to change the existing activity list by partial regeneration of the activities or to generate a new activity list for the entire household 52. Feedback can also provide an updated list of travel times 102 to be used in the activity regeneration. A file containing feedback commands is used by the activity regenerator module 122 to specify the activity to be updated and the type of update to be applied. Regeneration may be accomplished by rematching the synthetic household 52 to a survey household in the regression tree to select another activity pattern for the household 52.

The activity generator 28 may operate efficiently by relying upon simple models for activity location 74. Thus, instead of attempting to implement detailed models, the framework and the selector modules 50 deliver feedback data from the micro-simulation 32 and the route planner 30 to the activity regenerator module 122. The feedback data includes travel times experienced, activity locations 74, activity start and end times, and other data derived from the simulation that will influence activity decisions.

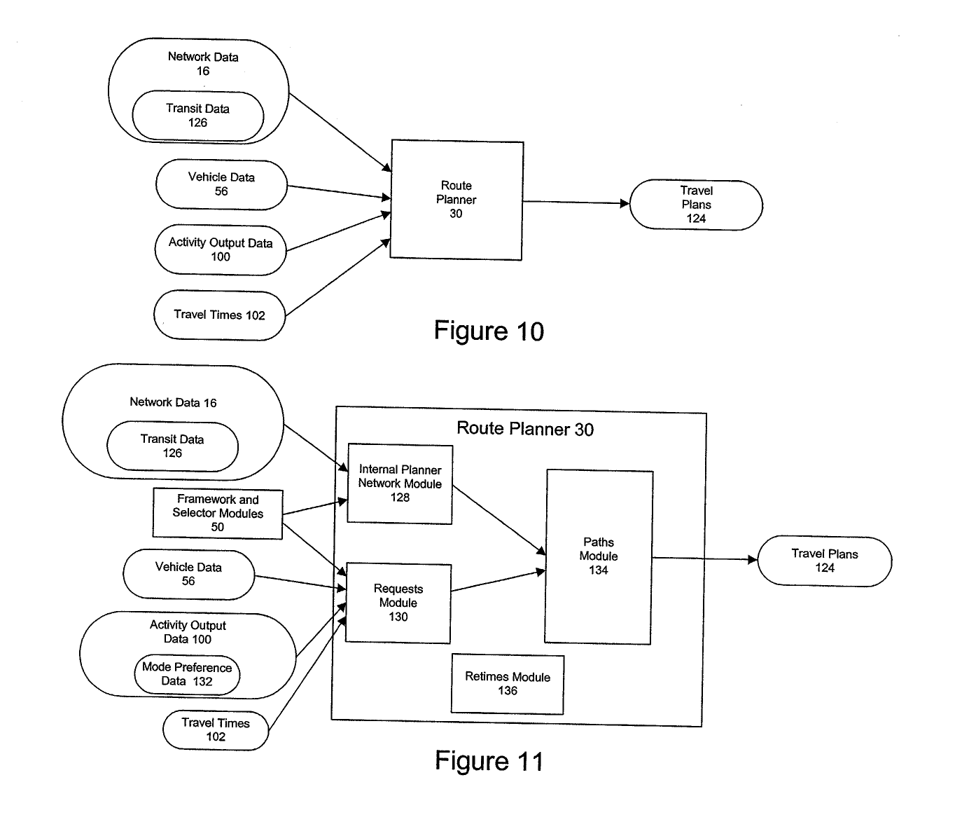

Referring to FIG. 10, a block diagram illustrates data inputs that the route planner 30 uses to generate routes or travel plans 124 for each individual entity 54. Each entity 54, including entities in transit, have an individual travel plan 124. Once the travel plans 124 are generated for all entities 54, the travel plans 124 are sent to the micro-simulation 32 and simultaneously executed.

The route planner 30 receives travel times 102, vehicle data 56, activity output data 100, and network data 16. The network data 16 includes nodes and links within a network 72 as well as activity locations 74. With respect to a metropolitan region, the network data 16 includes roadway and lane connectivity, parking places and transit stops. The network data 16 further includes transit data 126 having route paths and schedules within the network 72.

To increase execution speed, the route planner 30 may be distributed to run on multiple processors. These techniques may be combined, allowing the route planner 30 to take full advantage of a cluster of multiprocessor machines. Threads enable the parallel execution of several copies of the algorithms on a shared memory machine. Each planning thread uses the same copy of the network 72 to create plans and trip requests for different households 52. The plans created by the different threads are written to a plan file.

Activities may be assigned to threads using a round-robin approach. Thus, for the same activity output data 100, each thread is always given the same households 52 to plan. This is advantageous for repeatability, so that the same random numbers are used in different runs of the route planner 30. When running on several computers, several instances of the route planner 30 may run concurrently.

Referring to FIG. 11, a block diagram of the route planner 30 is shown including data inputs and outputs. The route planner 30 serves to compute the shortest path, subject to mode constraints, for each entity 54. Each link within the transportation network 72 has a cost associated with it. The shortest path can be interpreted as least cost for a generalized meaning of cost. Constraints are provided by criteria such as mode preferences for different legs of the trip.

Travel plans 124 are computed for each entity 54 in the population, based on that entity's 54 activity demands and preferences. Such computations enable each entity 54 to have an individualized view of the network 72. Accordingly, costs associated with links in the network 72 are computed separately for each entity 54.

Link costs may be computed in a time-dependent manner that can account for time delays resulting from actual travel conditions, such as peak-hour congestion. The delays may be fed back from the micro-simulation module 32 into the route planner 30, thereby enabling routes to be changed for individual entities 54.

The route planner 30 adheres to mode preferences contained in the activity output data 100. Thus, if the activity output data 100 specifies that an entity 54 will walk, then take a car, and then walk again between two desired activities, the route planner 30 produces a plan 124, if feasible, that ensures these modes are used in this sequence.

A travel plan 124 consists of a set of trips that carries the entity 54 through its desired activities. A trip consists of a set of contiguous legs. Activities of a given duration at a specific location may be separate trips. A leg consists of contiguous nodes and links that are traversed with a single travel mode. For example, a trip may consist of three legs: walking, transit, and walking. A travel plan 124 could consist of: a home activity, a trip from home to work, a work activity, a trip from work to shopping, a shopping activity, a trip from shopping to home, and a home activity.

A transit vehicle is any vehicle that makes scheduled stops along a predetermined route. Buses, trains, and streetcars are all considered to be transit vehicles whereas a taxi would not necessarily be considered a transit vehicle.

A request for travel to be planned by the route planner 30 consists of a starting location, a destination location, a start time, end time, duration constraints, and a mode string. A mode string contains a list of travel modes that may be used in the order given along the path from source to destination.

The system 10 provides different travel modes for the entities 54 including walk, bike, car, bus, light rail, regional rail, rapid rail, trolley, and transit. Bike mode is routed at a faster speed than the walk mode. The transit mode allows travel on any type of mass transit system, bus, rail, streetcar, or trolley and further allows walking in between transit routes. The transit mode allows transfers between different types of transit that may not use the same transit stop.

An additional mode herein referenced as a “magic” mode may also be provided. For magic mode, a walk plan is generated whose start and stop times are taken from the times given in the activities. The magic mode enables use of travel modes that are not supported by the route planner 30 or the micro-simulation module 32. One example of a non-supported travel mode is a school bus.

The route planner 30 includes an internal planner network module 128 that receives the network data 16 and travel times 102. The internal planner network module 94 determines the current status of the network 72. The internal planner network module 94 then constructs an internal network based on the network data 16. The internal network is time dependent in that travel on a link may incur different delays at different times.

The route planner 30 further includes a requests module 130 that receives vehicle data 56, activity output data 100, travel times 102, and may include lists of households to route as feedback from the framework and selector modules 50. The requests module 130 uses the activity output data 100 and vehicle data 56 to generate trip requests. The requests module 130 assimilates the data and determines the trips needed to achieve the activities. The activity output data 100 includes mode preference data 132 reflecting travel mode preferences. The travel mode preferences may be associated with entities 54 and the specific activities. Mode preference data 132 may be represented in the form of a string of characters and defines allowed modes of travel in a preference order.

The route planner 30 further includes a paths module 134 that receives data from the internal planner network module 128 and the requests module 130. The paths module 134 reviews the trip requests sent from the requests module 130 to generate travel plans 124 based on the transportation infrastructure. The travel plans 124 are generated for each individual entity 54 and include start and finish times for each travel segment, paths through a network, and expected arrival times along the path. The travel plans 124 include different travel modes, such as by foot or by vehicle type, and changes travel modes. The travel plans 124 may further represent different individual entities 54 that are traveling in the same vehicle.

Travel plans 124 are generated by the paths module 134 in response to trip requests for an entity 54. Trip requests come from the activity output data 100. For every entity 54, each pair of consecutive activities at different locations generates a trip request. A trip request consists of a source activity location, a destination activity location, constraints on the start time, end time, and duration, and the travel modes that are allowed. A trip request is satisfied by a plan, in the form of a trip made up of unimodal legs. Travel plans 124 are separated by activity plans.

The route planner 30 may further include a retime plans module 136 that has the ability to change the duration of existing plans due to updated link delay times or transit schedule files. The retime plans module 136 does not ensure the validity of re-timed plans, instead it changes the duration of the plans. Existing plans are read from the travel plans 124, and the duration of each selected path is recalculated. The new plans are written to a re-timed plan file. If the re-timed plan file exists, only plans for entities 54 whose identifications are in this file will be re-timed and written to the re-timed plan file. The activity output data 100 has activity itineraries for each entity 54.

The activity itineraries may be split into legs that define either activities and activity legs, or travel and transportation legs. Activity legs begin and end at the same activity location 74. Transportation legs begin and end at different activity locations 74. The activity legs are not planned and are stored in the travel plans 124 using the times from the activity output data 100. Travel plans 124 are created for each transportation leg. If a transportation leg is multi-modal, it is further split into unimodal sections. The unimodal sections are planned as separate legs of a trip.

If a planned trip uses a vehicle, the requests module 130 reviews the vehicle data 56 to determine the location of the vehicle and the trip is split. The first part of the trip is the location of the vehicle, such as in a parking location. The second part of the trip starts at the parking location and ends at the original trip's destination. The two parts are planned separately and then stored consecutively in the travel plans 124.

Each activity is assigned a time priority field that describes which start time, end time, and duration is important for that activity. The route planner 30 uses this information to fit transportation legs in between activity legs. Table 11 describes the various values of the time priority field.

TABLE 11
Description of time priorities.

Important Time

| Time Priority | Start | Stop | Duration |
|---|---|---|---|
| 0 | | | |
| 1 | X | | |
| 2 | | X | |
| 3 | X | X | |
| 4 | | | X |
| 5 | X | | X |
| 6 | | X | X |
| 7 | X | X | X |

The start time of an activity is mainly determined by the end time of the preceding transportation leg (PTL). If there is no PTL, because this is the first activity for the traveler or the PTL ends prior to the lower bound of the start time specified for this activity, the start time is taken from the distribution given in the activity output data 100.

If the activity time priority doesn't specify start time, the start time of the activity is the maximum of the end time of the PTL and the lower bound of the start time of this activity.

If the activity time priority does not include start time and the PTL end time is prior to the lower bound of the activity start time, then a start time is taken from the distribution. If the PTL end time is greater than the activity start time upper bound, then the PTL start time is decreased. If possible, this may be done so that the PTL end time is equal to the activity start time upper bound. This may be done if the constraints on the previous activity are not violated. Otherwise, the start time is the arrival time of the PTL. Next, the duration and stop time of the activity is determined. Of these two, if only duration is specified by the time priority, a duration is picked from the distribution given in the activity output data 100. The stop time is then the start time plus duration. For all other priorities, a stop time is picked from the distribution given in the activity output data 100. The duration is the difference between the stop time and start time. If the resulting duration is 0 or less, then the duration is changed to 1, and the stop time is changed to start time+1.

Finally, the times listed as important by the time priority are checked against the ranges specified by the activity output data 100. An entry in an anomalous problem file is created for any time indicated by the time priority that does not fall in the proper range. However, the entity travel is still planned.

Because the system 10 tracks the movements of each entity 54 throughout the simulation, the route planner 30 retains the location of each household's 52 vehicles. This enables an entity 54 from a household 52 to drive to a parking location, walk from the parking location to a destination, and then return to the parking location to retrieve the vehicle.

The route planner 30 may be configured to select a parking location adjacent the destination activity location for the trip as the destination parking location. If there is no adjacent parking location, the route planner 30 may return a warning and skip the remainder of the entity's 54 activities. In this case, adjacent may signify that there is a process link from the ending parking location to the ending activity location. If the ending activity location is adjacent to the starting parking location, then only a walk trip, from the starting activity location to the ending activity location is generated.

A shared ride is one in which an entity 54 travels in a vehicle driven by another entity 54. The trip request may be planned for the driver as usual. A trip request for a passenger may be fulfilled after all of a household's 52 non-passenger trips have been planned by using information from the driver plans. The trip requests for a passenger with a particular driver are listed in the order that they occur. The driver trip requests, that include the passenger, are also listed in an order. The driver and passenger trip requests may then be matched in order. This process may be repeated for every combination of driver and passenger that occurs in a household 52. If there are not enough driver trip requests to satisfy all of the passenger trip requests, then the passenger activity is listed in the anomalous problem file and identified as an anomaly. The condition where there are too many driver trip requests may not necessarily be detected.

Interdependencies may exist between entities. For example, an entity 54 who is a passenger in the morning may be a driver in the afternoon. Passenger activity may be planned before the corresponding driver activity. Room for the passenger trip is left in the plan sequence according to the desired activity times. If the driver trip is longer than expected, there may not be enough time between activities in the passenger plan. In this case, the activity leg following the passenger trip is shortened to accommodate the transportation leg and the activity is recorded in an anomalous problem file with an anomaly identification. If the passenger trip extends past the end of the upper bound of the following activity, the remaining activities for the passenger are not planned.

The route planner 30 may be configured to recognize various types of anomalous activities. Anomalous activities or “anomalies” may be used by the framework and selector module 50 to request new activity characteristics for an entity 54 within a household 52. An anomaly may create a warning or create an error that prevents planning of the rest of the activities for an entity 54. Table 12 lists various types of anomalies that may be recognized along with a corresponding severity.

TABLE 12
Types of anomalies.

| Anomaly Type | Number | Severity |
|---|---|---|
| No Path | 1 | Error |
| Invalid Time | 2 | Warning |
| Invalid Shared Ride | 3 | Error |
| Invalid Shared Ride Time | 4 | Subtype 1, 3: Warning |
| | | Subtype 2, 4: Error |
| Connectivity | 5 | Warning |
| Location | 6 | Error |
| Parking | 7 | Warning |

For each activity in which an anomaly is detected, an anomaly activity file may be created. The anomaly activity file may contain a number of fields that describe the activity for which an anomaly was detected, the trip generated for the activity, and the type of anomaly detected. Table 13 provides an example of fields that may be within an anomaly activity file.

TABLE 13
Anomalous activity file common fields.

| Field | Description |
|---|---|
| HouseholdId | ID of the anomalous household. |
| TravelerId | ID of the anomalous traveler. |
| ActivityId | ID of the anomalous activity. |
| TripId | ID of the trip generated by this activity. |
| LegId | ID of the first leg generated by this activity. |
| ProblemType | Type of anomaly (See Table 12) |
| Problem Subtype | Subtype of an anomaly, type dependent. |
| Number of data fields | Number of remain fields, varies by anomaly type. |

A No Path anomaly exists when a trip request cannot be satisfied because a path from the source location to the destination location cannot be found. Common reasons for this anomaly include no connectivity between the source location and the destination location and no transit vehicles running after the start time. The No Path anomaly includes information about the source and destination accessories, the travel mode, and the start time of the transportation leg. When a No Path anomaly is detected, no plan is generated, and the rest of the activities for this entity 54 are not planned. Table 14 lists types of subtypes of a No Path anomaly.

TABLE 14
No Path Subtypes

| Subtype | Value | Description |
|---|---|---|
| No path exists | 1 | No path exists with the requested mode, at the |
| | | requested time. |
| Trip Length | 2 | The activity starts past the end of the simulation. |
| Leg Length | 3 | The trip leg is too long. |
| Max Nodes | 4 | The maximum number of nodes has been |
| | | searched. |

An Invalid Time anomaly occurs when the actual time used by the route planner 30 does not fit within the bounds specified by the activity. The start time, end time, and duration are reviewed for consistency with the ranges given in the activity. A separate line in the anomalous activity file is output for each one of these times that is inconsistent. The line may contain the type of the inconsistency, the lower and upper bounds from the activity output data 100, and the actual value used by the route planner 30.

An Invalid Shared Ride anomaly occurs when the driver activities and passenger activities do not match. This may exist where there are too few driver activities for the number of passenger activities detected. When this anomaly is detected, no plan is generated for the passenger and the rest of the passenger activities are not planned. The driver activities are planned as usual.

An Invalid Shared Ride Time anomaly occurs when the transportation leg for a passenger-shared ride takes longer than the time between the two surrounding activity legs. If the trip extends past the upper bound of the following activity's start time, but not past the following activity's end time an Invalid Shared Ride Time anomaly is created. The Invalid Shared Ride Time anomaly is stored in the anomalous activity file and the rest of the passenger trip requests are planned. An Invalid Shared Ride Time is also created if the trip extends past the end time of the following activity and no further trips are planned for the entity 54. The Invalid Shared Ride Time anomaly includes the arrival time of the passenger-shared ride trip, the upper bound of the start time of the following activity, and the end time of the following activity. Table 15 lists possible subtypes of the Invalid Shared Ride Time anomaly.

TABLE 15
Invalid Shared Ride Time subtypes.

| Subtype | Value | Description |
|---|---|---|
| Driver Late | 1 | The driver was late, but the length of |
| | | the following activity was adjusted to |
| | | compensate. |
| Driver Very Late | 2 | The driver was too late to be accommodated. |
| Passenger Late | 3 | The passenger was late, but the length of |
| | | the following activity was adjusted |
| | | to compensate. |
| Passenger Very Late | 4 | The passenger was too late to be |
| | | accommodated. |

A Connectivity anomaly occurs when a process link from the destination parking location to the final activity location does not exist. When this happens, a plan is still produced as this process link is not included in the output plan.

A Location anomaly occurs when the source activity location or destination activity location specified in the activity output data 100 or the vehicle location specified in the vehicle data 56 cannot be located in the transportation network.

A Parking anomaly occurs when the origin parking location and destination parking location are identical. This occurs when a drive trip is specified between two activity locations that share a parking location. A walk trip between the two activity locations is generated.

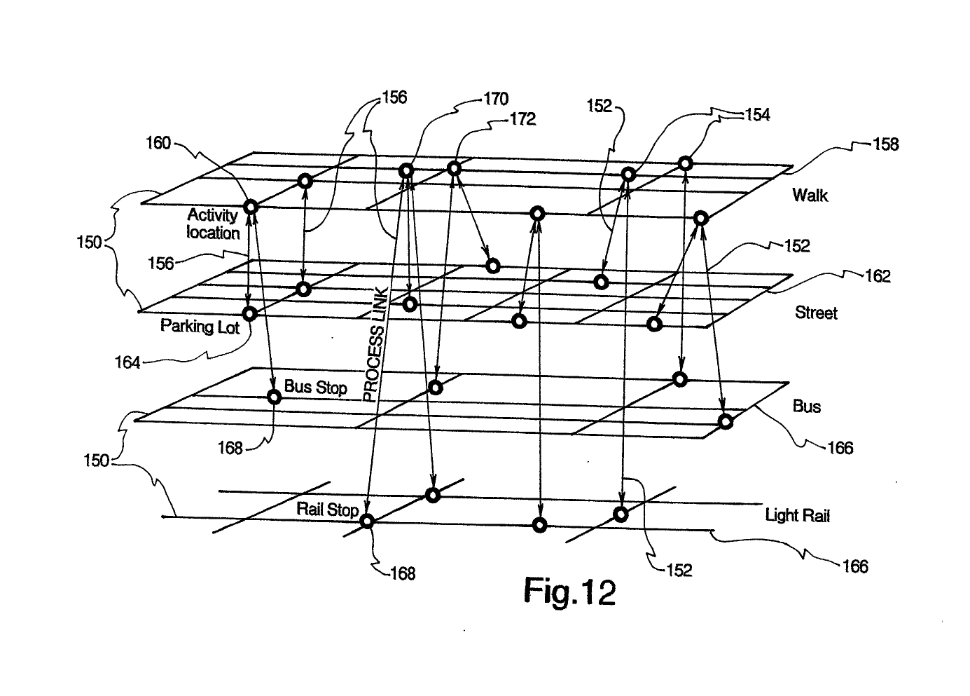

Referring to FIG. 12, a high-level depiction of various layers 150 used by the route planner 30 is shown. From individual entity preferences and constraints contained in the network data 16 and activity output data 100, the route planner 30 plans for trips that consist of multiple modal legs 152. The route planner 30 conceptually views the network as a set of interconnected, unimodal layers 150. A separate layer 150 exists for each mode and the designated locations are viewed by the route planner 30 as a node 154. Constructing multiple layers in which each layer 150 can be encoded as a different unimodal network allows for the efficient calculation of trips constrained by modal sequences. In each layer 150, a special link, referred to herein as a process link 156, connects one or more of the unimodal layers 150 to another. The process links 156 allow intermodal transitions to take place.

A unimodal layer 150 may be a walk layer 158 that includes all streets in the network that can be walked along and activity locations 160. A street layer 162 includes links between intersections and parking locations 164. The parking locations 164 and transit stops 168 that belong to the other layers are accessible only from activity locations 160 via process links 156. Transit layers 166 include transit stops 168 and are traversed in transit (e.g., bus or light rail) modes only. There is a separate transit layer 166 for each type of transit vehicle (e.g., bus, light rail, commuter train).

Nodes 154 may appear in two different layers 150 because even though an entity 54 may be in the same geographic location, whether in a street or walk layer, an entity 54 cannot change from the street layer 162 to the walk layer 158 without visiting an activity location 160 and using a process link 156.

The activity output data 100 generated by the activity generator 28 includes mode preferences for each trip. The mode preferences may be captured in simple alphabetical expressions. For example, “wcw” represents a trip that may signify a walking leg from an entity's house to a vehicle, a car leg to a parking lot at a place of work, and a walking leg from the parking lot to an activity location 160. For the first leg of the trip, the walking leg), the route planner 30 searches for possible paths within the walk layer 158 to obtain a walking route from the home to the parking lot of the vehicle. After the walking route is found, a series of least-cost driving links is found to obtain a route to a parking lot near the activity location 160. A walking route is then developed to move the entity 54 from the parking lot to the activity location 160.

Once the router planner 30 is searching in the street layer 162, the route planner 30 chooses additional links from the street layer 162 or parks the vehicle and chooses links from the walk layer 158. This determination is based on the lower cost. The route planner 30 ensures that the final link is a walking link in this example.

Trips that cannot be feasibly planned, or that contain questionable legs, may be marked and provided as output from the route planner 30 in an anomalous activity file. The anomalous activity file may be fed back to the activity generator 28. This instructs the activity generator 28 to choose a new activity time, location, or travel mode.

For computational efficiency, the internal planner network module 128 takes information from the network data 16 to create a route planner internal network representation, hereinafter referred to as an “internal network.” The internal network increases the efficiency of the paths module 134. The internal network represents a weighted, directed graph. The graph's nodes represent intersections and accessory locations, such as parking accessories, activity locations, and transit stops. Arcs represent travel possibilities between node pairs. Internally, all links are unidirectional. Bi-directional links are represented by two separate links.

The paths module 134 finds the shortest paths in a weighted, directed graph. The paths module 134 may perform a breadth-first search of the graph, starting at the origin node and visiting the other nodes in the order of their shortest-path distance from the origin.

One of the main differences between the transportation network and the internal network is that the edges in the internal network are all unidirectional. Any bi-directional links in the transportation network are converted to a pair of unidirectional links in the internal network, one in each direction. There is a node in the internal network for each node in the transportation network.

Each link in the transportation network may have accessories attached to it. These accessories represent activity locations 160, parking 164, and transit stops 168. The accessories become additional nodes in the internal network. Activity locations 160 may be placed on a layer 150, such as the walk layer 158. Parking locations 164 are always placed on the street layer 162. The following examples assume that all activity locations 160 are placed on the walk layer 158.

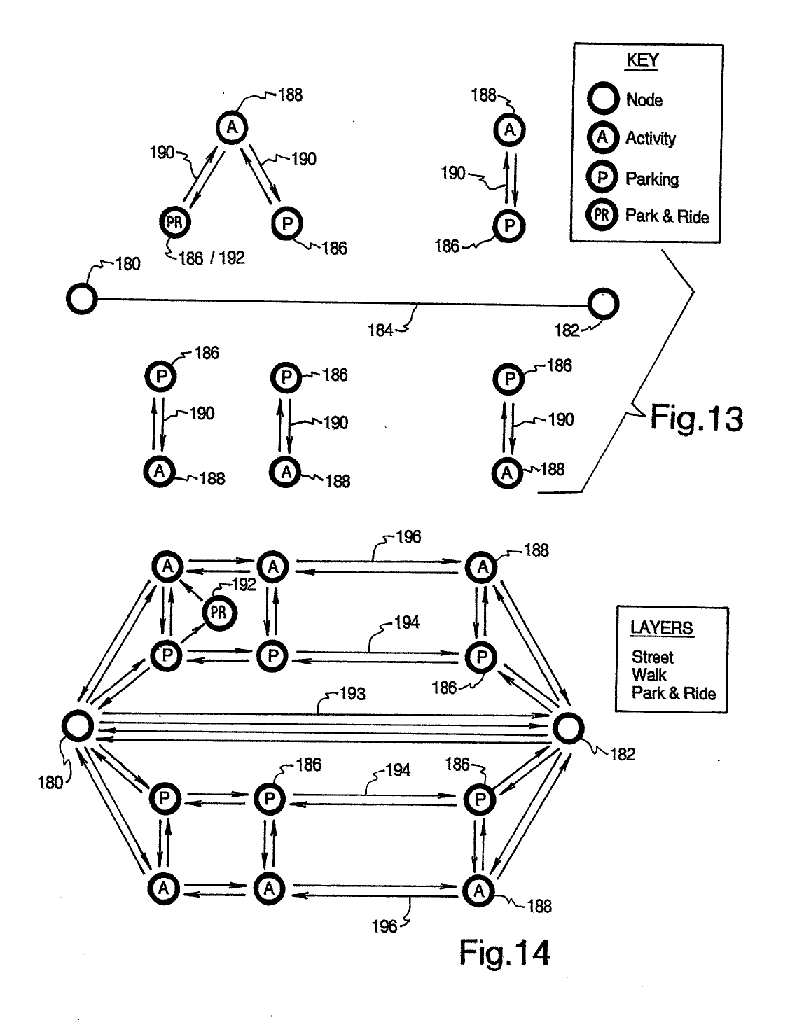

Referring to FIG. 13, a network representation of two nodes 180, 182 with a connecting bi-directional link 184 is shown. There are six parking locations 186 and five activity locations 188, connected by process links 190 as shown. One of the parking locations 186 is designated as a commuter park-and-ride lot 192.

Referring to FIG. 14, nodes and edges of the internal network representation are shown that correspond to those of FIG. 13. The single link 184 is transformed into four unidirectional links 193. There is one link in each direction for the street layer 162, as well as a link in each direction for the walk layer 158. The edges 193 connecting the two nodes 180, 182 have fraction 1.0. The edges 194 that connect the parking locations 186 are assigned fractions according to the length of the link and the offset of the parking location 186 from a node 180, 182. The edges 196 connecting the activity locations 188 are similar. If a link in the transportation network does not allow walking, such as a freeway link, any activity locations 188 along that link are still connected by edges 196 in the walk layer 158. However, no edges 196 are placed between the activity locations 188 and the intersection nodes.

Referring again to FIG. 12, information about the transit layers 166 may come from the network data 16 that includes a transit stop table, transit route file, and a transit schedule file. Each transit stop 168 in the transit stop table may be represented by a node 154 in a transit layer 166 for each type of transit that serves the stop. Each route in the transit route file may have its own layer containing a node 154 for each stop on the route called route nodes. Process links connect each transit stop 168 to the corresponding route nodes. The route nodes are connected by links in the order that the route nodes appear in the route file. The stops 168 in a particular route must be unique. Each transit stop 168 is connected to the walk layer 158 with process links 156 to appropriate activity locations 160. Delays for the route links are taken from the route schedule file. Delays for the route links are represented by constant delay functions.

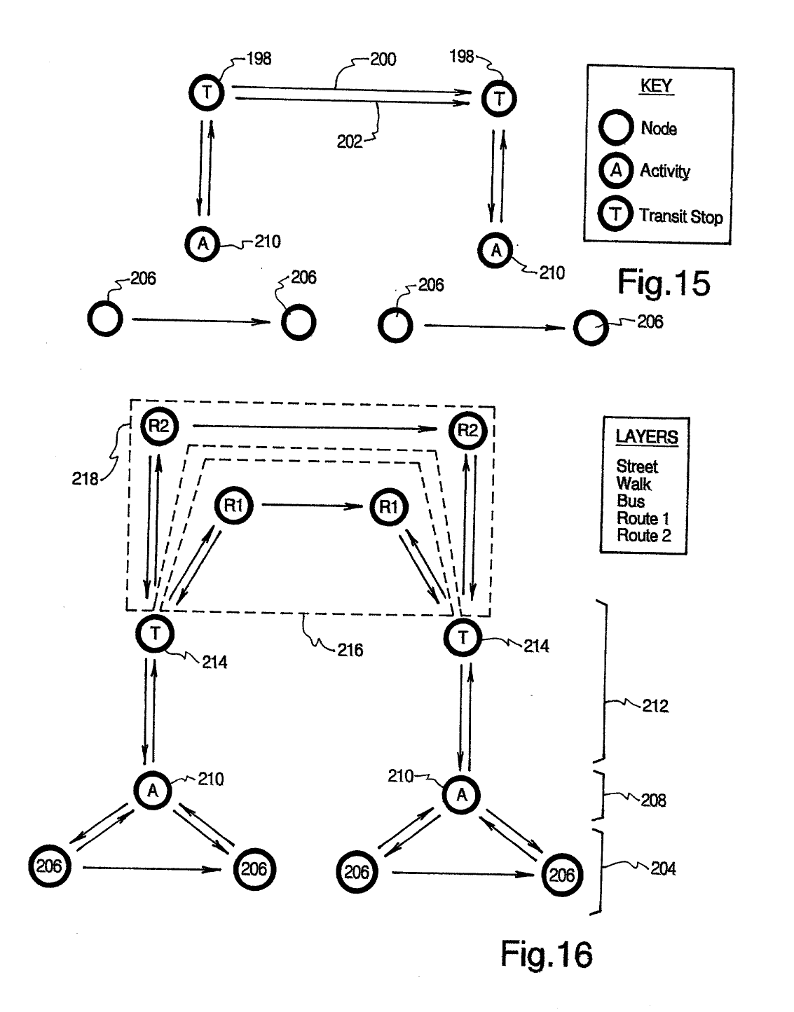

Referring to FIG. 15, a transportation network representation of two streets with bus stops 198 and two bus routes 200, 202 connecting them is shown. Referring to FIG. 16, a corresponding internal network representation is shown. There are five different layers in the internal network: a street layer 204 containing the intersection nodes 206; a walk layer 208 containing the activity locations 210; a bus layer 212 containing the bus stops 214; and two layers 216, 218 for each of the two bus routes.

There are several ways to determine the “cost” of a trip. The paths module 134 uses travel time 102 to determine the shortest path through the transportation network. It also computes monetary cost and distance. Each link has a delay associated with it. Links on a street layer have a delay for driving on that link. Links on the walk layer have a delay for walking on that link. Transit links have a delay for the time arriving at a transit stop and the time at which the transit vehicle may be exited at the following stop. The transit delay takes into account the time spent waiting for the transit vehicle to arrive, based on the transit vehicle's schedule. Delays can either be constant, such as walking delays, or dependant on the time of day.

A default delay for a street link may be the free speed delay. The free speed delay may be calculated from the free speed on that link and the length of the link. The actual delays calculated by the micro-simulation module 32 are used to provide more accurate information. Each delay represents the average delay experienced for the vehicles that traversed the link, averaged over a certain interval.

The delay for walking or biking on a link is determined from the length of the link and the walking speed or biking speed. There are also delays for entering transit vehicles and exiting transit vehicles. The transit delays are used to keep travelers from changing transit vehicles to save a few seconds of travel time.

Process links can also have a delay associated with them. For example, the delay involved in parking a vehicle in a lot can be represented by the delay on the process link from the parking location to any adjacent activity locations.

To increase the effectiveness of the route planner feedback, noise can be added to the link delays. The maximum amount of noise to add to the link as percentage of the link delay can be specified. If the delay for a link is d and the specified noise percentage value is n, the reported delay will be in the interval (d−nd, d+nd). Fractional links that are used to access parking accessories always have the maximum amount of noise added to them. This is to ensure that traveling on the partial links is always at least as expensive as traveling on the associated full link.

The route planner 30 may increase performance by artificially increasing the delay for links that lead in the wrong direction. For example, a source location for a trip may be in the southern part of a network and a destination location may be located directly north. Links that head north are preferred over links that lead east or west. The farther from north that the link leads, the less likely it is that it will be considered.

In another method, a parameter called overdo may be used to find the shortest paths between nodes in a Euclidean graph. The overdo parameter allows for a tradeoff between the running time and optimality of the paths found. The internal network may not be strictly Euclidean, since only certain nodes may be reached from each node. When overdo has a moderate value, such as overdo=0.25, the resulting path looks quite realistic and brings a considerable improvement to running time. However, if this method is used, the plans will be less sensitive to feedback. The larger the value of overdo, the longer congestion will be tolerated by the route planner 30 before alternative routes are taken.

In addition, with overdo turned on, certain geometric configurations in the network will cause the route planner 30 to prefer low-speed links that head in the correct direction over high-speed links that lead in an incorrect direction. For example, the route planner 30 may create a plan that causes an entity 54 to exit a freeway via a ramp, only to reenter several links later, rather than remaining on the freeway. If the value of overdo is 0, and the delay noise is 0, then the optimal (i.e., least cost) path will be found for the particular mode string used.

For each route, the distance traveled by traversing the route is calculated. The distance for a transit leg is the sum of the Euclidean distances between each pair of transit stops. For auto, walk, and bike legs, the distance is the sum of the length of the links traveled. For magic move legs, the distance is the Euclidean distance between the source and destination activity locations.

In addition to travel time delay, process links can also have an associated monetary cost. This can be used to account for parking fees, transit fares, and tolls. All costs are expressed as cents. The cost of parking is represented by the cost on the process links from the parking accessory to any connected activity locations.

There are two types of transit costs, referred to here as fixed fare and variable fare. Fixed fare means that the fare is calculated based on where the transit vehicle is entered, regardless of where it is exited. A variable fare depends on where the transit variable is entered and exited. A fixed fare is handled similarly to parking costs. The price of the fare is the process link cost from activity location to transit stop. A variable fare is handled by transit fare zones (TFZ). Each transit stop is assigned a TFZ. A transit fare table contains the cost of traveling between each pair of TFZs by transit type. Any individual links that have a cost associated with them (e.g., tolls) can be listed in a link cost file. The link cost file contains pairs of link identification and cost.

To more accurately model mode choice, the concept of a generalized cost function (GCF) may be used. The GCF allows other factors in addition to travel time and monetary cost, to be taken into account when determining a plan for an entity 54. These other factors are included in the “cost” of a trip. The importance of the monetary cost of a trip may be modified depending on a traveler's income. A greater penalty for traveling on congested links can be imposed by calculating the difference between actual delay and free speed delay. Transit transfers may impose a higher cost than the actual delay involved.

The GCF currently reported is simply the travel distance. Fixed transit costs and transit distances may be combined in the first transit leg if multiple routes are used in one trip. For example, the trip in Table 16 will be reported as in Table 1017.

TABLE 16
Actual trip.

| Leg Mode | Distance | Monetary Cost |
|---|---|---|
| W | 0.5 km | 0 |
| t - Bus Route 1 | 2.0 km | 100 |
| W | 0.1 km | 0 |
| t - Bus Route 2 | 1.5 km | 150 |
| W | 0.1 km | 0 |

TABLE 107
Reported trip.

| Leg Mode | Distance | Monetary Cost |
|---|---|---|
| W | 4.2 km | 250 |
| t - Bus Route 1 | 0 km | 0 |
| W | 0 km | 0 |
| t - Bus Route 2 | 0 km | 0 |
| W | 0 km | 0 |

Similarly, distance and parking costs for the walk leg from the parking location to the activity location are included in the auto leg of the trip.

The amount of information output by the route planner 30 can be controlled in several ways. Logging configuration file keys control the amount of logging information generated. Logging information is normally sent to standard output. The configuration file key ROUTER_LOG_FILE can be used to direct the logging output to a specific file. LOG_ROUTING generates information about the general progress of the route planner 30. LOG_ROUTING_DETAIL generates copious amounts of logging on information and is normally turned off for normal execution. LOG_ROUTING_PROBLEM duplicates the information in the route planner anomalous activity file.

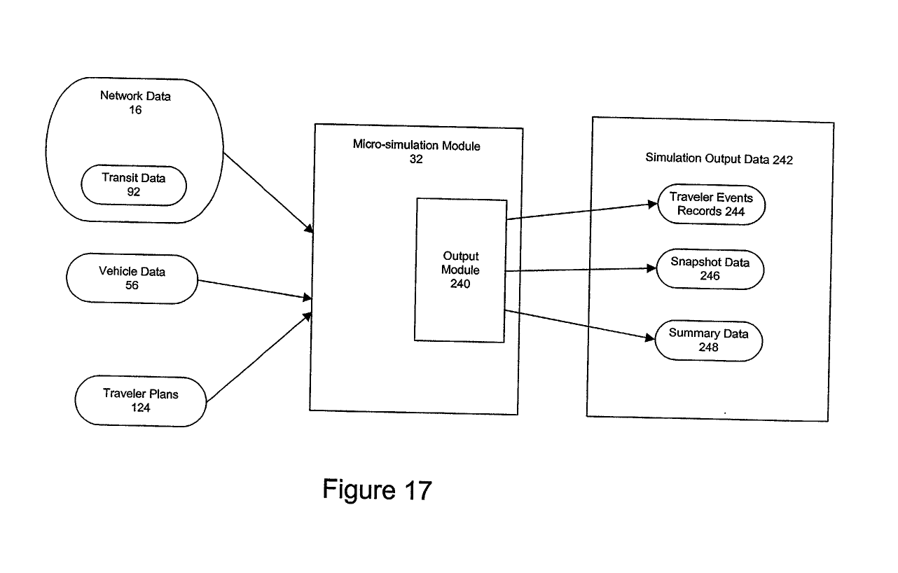

Referring to FIG. 17 a block diagram illustrating the input and output data from the micro-simulation module 32 is shown. The micro-simulation module 32 receives the network data 16, including the transit data 126. In a metropolitan simulation, the network data 16 may include the location of streets and intersections, the number of lanes on each street, the manner in which the lanes are connected, parking locations on the streets, and a collection of activity locations.

The micro-simulation module 32 further receives the travel plans 124 for each individual entity 54 and vehicle data 56. Each travel plan 124 for each individual entity 54 is broken down into a sequential set of trips, which must begin and end at an activity location (such as home, work, or shopping center). A trip is further decomposed into a set of unimodal legs. An individual entity 54 can use only a single mode of transportation on a leg. Accordingly, several legs are chained together to form a single trip.

As a simulated day progresses, each individual entity 54 follows a predefined plan to move from one activity to the next by using combinations of modes, such as walking, driving a vehicle, and riding in a private or public vehicle. The route planner 30 provides travel plans 124 formed link-by-link, including the mode of travel.

The micro-simulation module's 32 analytical power resides in its ability to aggregate the results of millions of interactions within the transportation network. The micro-simulation module 32 enforces physical constraints such as individual entities 54 cannot be in two places at once, and individual entities 54 cannot create vehicles. Travel plans 124 initiate and place individual entities 54 in initial start locations, whereas information in the vehicle data 56 places vehicles in their initial locations.

The micro-simulation module 32 simulates the movements and interactions of individual entities 54 in a region's transportation infrastructure. The micro-simulation module 32 attempts to execute travel plans 124 for each individual entity 54 within the network. The combined interactions for each individual entity 54 produce emergent behaviors such as traffic congestion. The micro-simulation module 32 simulates intermodal travel plans, multiple individual entities per vehicle, multiple trips per traveler, and vehicles with different operating characteristics.

The micro-simulation module 32 includes an output module 240 that collects data from a running simulation and stores it for subsequent examination by the analyst or use by other software components. The output module 240 provides a layer that insulates other modules from the details of the file structure and provides great flexibility in the specification of the data to be collected.

The output of the micro-simulation module 32 is collectively referred to herein as simulation output data 242. The micro-simulation module 32 may output traveler event records 244 each time an event of interest to an analyst takes place. The traveler event records 244 may include individual entity identification, trip identification, leg identification, and a time and location for each individual entity 54 specific to that time. The traveler event records 244 may further include other fields to describe anomalies and an individual entity's 54 state at the time an event took place.

The micro-simulation module 32 may further provide snapshot data 246 that illustrates locations at a specified time interval. The snapshot data 246 may include a listing of individual entities 54 and vehicles in links and intersections. Traffic animation may be produced from the snapshot data 246. The snapshot data 246 includes snapshot files containing time, position, and velocity information for each vehicle in the simulation.

Outputting the snapshot data 246 for a 24-hour simulation of a major metropolitan area creates extremely large files. Users may restrict output to smaller portions of the network and specific times during the simulation. Users may select only a few desired fields or only those records that meet certain criteria. For example, a user may choose only specific events, such as beginning a leg, particular travelers, or vehicles traveling above a given speed. The sampling rate and reporting frequency for each data type may be controlled by user-selected parameters.

The micro-simulation module 32 may further include summary data 248 that includes a variety of data such as aggregated travel times through specific links, link/lane densities, and turn counts. The snapshot files can be used to recover data that has not already been provided in the summary data 248. For example, if a new study requires an average gap between vehicles, it can be computed from the snapshot data 246.

The simulation output data 242 may be parsed or otherwise configured into the disaggregated dynamic data 20 as shown in FIG. 1. An analyst may use a filter to limit potentially voluminous output to only those items of interest in a particular simulation run. An unlimited number of output specifications may be included in a simulation configuration file, allowing for very fine-grained control of the output produced. In particular, time-based filtering may be used to restrict data collection to a subset of the total run time by specifying starting and ending times. An analyst may specify, in an input configuration file, the frequency of reporting for summary data 248 and the sampling frequency for summary data 248.

The system 10 is readily applicable to a metropolitan transportation infrastructure to simulate traffic complexity, congestion, and air quality. A roadway network includes freeways, highways, streets, ramps, turn pocket lanes, and intersections. A driver executing trip plans accelerates, decelerates, turns, changes lanes, passes and responds to other vehicles and signals. Although the system 10 is applicable to a metropolitan network for human travelers it has vast application to other entities and other transportation systems. Thus, the system 10 may also simulate routing of data packets through a network, spread of disease through a human population, movement of aircraft through various travel hubs, and so forth. One of skill in the art will appreciate that the present invention is applicable to many different human and non-human entities and methods of movement.

In operation, the micro-simulation module 32 reads in a representation of the transportation network from the network data 16. This representation is very similar to a detailed street map; it includes a number of lanes, turn pockets, merging lanes, turn signals, and so on. Vehicles traveling along streets in the road network are simulated in detail. In addition to the streets, there are several kinds of accessories that represent parking lots, activity locations, and transit stops, all of which act like buffers for travelers who are not in a vehicle traveling on a street.

Each vehicle's type and initial location are read in. Once this is complete, travel plans 124 for each entity 54 are read in as needed. Entities 54 are placed on the network and are allowed to travel from their point of origin to their final destination. For non-simulated modes, this movement is simple-an entity 54 is removed from the buffer in one accessory and placed in the buffer on another, with a new departure time reflecting the trip's estimated duration.

Vehicles move from one grid cell to another by using a cellular automata (CA) method that is described below. Modifications in this approach support lane changing and plan following for each vehicle until it reaches the end of a link. There the vehicles wait for an acceptable gap in traffic or for protection from a signal before they move through the intersection onto the next link. This continues until each vehicle reaches its destination, where it is removed from the network.

The micro-simulation module 32 is capable of using turn pockets and merge lanes, lane-use restrictions, such as high-occupancy-vehicle lanes, turn prohibitions, and speed limits. Each intersection has a controller such as a stop or yield sign, a traffic signal, or even a set of coordinated traffic signals.

Another type of beneficial network information consists of a list of transit stops serviced by each transit route. The actual transit schedule is encoded in the travel plans 124 of transit drivers. Transit drivers stop to pick up or drop off passengers at transit stops.

The micro-simulation module 32 breaks the travel plans 124 into sequential sets of trips, which must begin and end at an activity location, such as home, work, or shopping center. A trip is further decomposed into a set of unimodal legs. An entity 54 uses a single mode of transportation on a leg. Accordingly, several legs are chained together to form a single trip.

As a simulated day progresses, each entity 54 follows a predefined plan to move from one activity to the next by using combinations of modes, such as walking, driving a vehicle, and riding in a (private or public) vehicle. The route planner 30 provides a link-by-link travel plan 124 of each entity 54, including the mode of travel.

Vehicles are simulated in sufficient detail to include driving on roads, stopping for signals, accelerating, decelerating, changing lanes, stopping to pick up passengers, and so on. Mode changes (e.g., from walking to car or to transit) are explicitly simulated based on information contained in the travel plans 124.

Vehicles follow a simple set of rules that guarantee no collisions will take place. Phenomena such as reaction times and limited visibility may not be simulated explicitly. However, the effects of these phenomena are simulated by the values of parameters used in the driving rules so that the fundamental flow-density diagram matches real, observed traffic.

The micro-simulation module 32 can estimate the impact of hypothetical changes on quality of service. It provides answers to questions such as the effects on traffic patterns by a proposed highway, how changes in transit schedules affect riders, changing an intersection's traffic signals to alleviate congestion, and determining common demographic characteristics of a subpopulation most affected by a particular infrastructure change.

The micro-simulation module 32 has the ability to aggregate the results of millions of interactions within the transportation network. The following discussion focuses on the level of detail used to simulate a travel plan 124. The following example consists of a six-leg multi-modal work-to-home trip. It begins and ends at activity locations coded in the transportation network.

Leg 1: walk from activity location W to bus stop X, where W is the work activity location and X is a bus stop in the network description.

Leg 2: take route Y to bus stop Z.

Leg 3: walk to parking lot P.

Leg 4: drive to day care at activity location D.

Leg 5: drive (with one passenger) to parking location P2.

Leg 6: walk to activity location H (home).

For walking legs, the micro-simulation module 32 may not explicitly micro-simulate the second-to-second locations of pedestrians. An entity 54 arrives at a destination at a simulation time computed by adding the delay time, contained in a travel plan 124, to the start time for the walk-mode leg. No additional information is used or generated for walk-mode legs.

Bus leg plans require one additional piece of information than the walking legs, that being the acceptable route. The precise itinerary of the bus an entity 54 takes is determined by the driver's travel plan 124. The entity 54 simply boards the bus at a bus stop and rides it until the entity's 54 desired stop is reached, at which point the entity 54 exits the bus.

The micro-simulation module 32 simulates bus loading and unloading. The micro-simulation module 32 observes resource constraints such as vehicle capacity and transit stop capacity. If a bus is full when it reaches a bus stop, an entity 54 is not permitted to board and will wait for the next bus on the same route. With this level of detail, it is easy to determine how many passengers cannot find space on the bus or how many minutes a traveler must wait for a bus.

After getting off the bus, an entity 54 walks to a parking lot. In this instance, the parking lot may be where an entity 54 left its private vehicle. This walking leg is handled as previously described.

Upon arriving at the parking lot, an entity 54 is associated with a specific vehicle, which either must have been left in the parking lot earlier in the simulation or placed there during initialization.

The entity 54 and vehicle exit the parking lot and enter the transportation network. The entity's 54 travel plan 124 specifies exactly which turns the entity 54 takes until the entity 54 arrives at the daycare center. At this point, the entity 54 waits until the passenger enters the vehicle. The passenger's travel plan 124 specifies what vehicle to ride in, and the passenger waits for the vehicle to arrive. The driver's travel plan 124 specifies how many passengers to pick up. Once again, the driver re-enters the transportation network, completing the remainder of the planned trip.

Like other travelers, mass transit driver 54 can switch vehicles, switch routes, with or without switching vehicles, and take layovers of prescribed duration or ending time at specific control points. The micro-simulation module 32 enforces physical constraints such as entities 54 not being in two places at once and entities 54 cannot create vehicles. Information in the travel plan 124 initiates and places entities 54 in their initial start locations, whereas information in the vehicle file places vehicles in their initial locations.

The micro-simulation module 32 uses the CA process to provide the computational speed needed to simulate a region at the individual entity level and yield individual vehicle movement. The CA process is able to maintain a fast execution speed while simulating large numbers of entities 54 and vehicles.

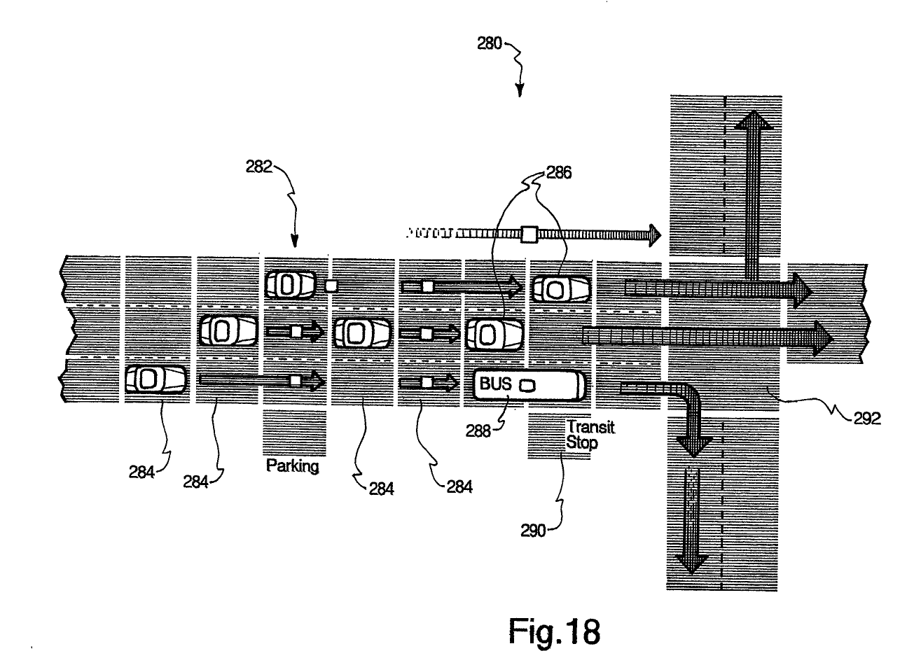

Referring to FIG. 18, a small portion 280 of a regional transportation network is shown. In the CA process, each link 282 in the transportation network is divided into a finite number of cells 284. As illustrated and by way of example, the link 282 is a roadway section and a cell 284 is an area one lane wide and 7.5 meters long. Each cell 284 may contain an entire vehicle 286, part of a vehicle 288, or be empty. At each time step of a simulation, each cell 284 is examined for a vehicle occupant. If a vehicle 286 is present in the cell 284, the vehicle 286 may be advanced to another cell 284 using a simple rule set. To increase fidelity, the cell size may be decreased which adds vehicle attributes. The rule set may further be expanded but this may result in slower computational speed.

The fidelity and performance limits of the micro-simulation module 32 may be evaluated to establish the computational detail that supports the fidelity necessary to meet analysis requirements. The sheer number of individual entities 54 and the level of detail in the micro-simulation module 32 may require the use of multiple processors where available. Alternatively, the information flows and scheduling of the micro-simulation module 32 may be performed on a single processor.

The micro-simulation module 32 performs the simulation in discrete time steps, such as one second of real time. On each time step, a determination is made as to whether a vehicle 286 accelerates, brakes, or change lanes in response to the occupancy of nearby grid cells 284. After decisions are made for each vehicle 286, each vehicle 286 moves to a new grid cell 284 in accordance with its current velocity.

As part of the lane-changing procedure, the micro-simulation module 32 scans nearby cells 284 for transit stops, which transit vehicles 288 obey. Transit vehicles 288 examine the queue at a transit stop 290 to see if anyone is waiting for the transit vehicle 288. Transit vehicles 288 also query their passengers to see if anyone wants to get out at the transit stop 290. A transit driver's travel plan 124 may specify a departure time from any stop 290. The driver enters the stop 290 if: 1) the scheduled departure time has not yet been reached; 2) anyone is waiting; or 3) anyone wants to get out.

The micro-simulation module 32 ensures that decisions for each vehicle 286 are made based on the state of every other vehicle 286 in its local vicinity (i.e., five cells) at the same time. In other words, every vehicle 286 on the network accelerates based only on information available at time t, which does not include the time t+1 positions of vehicles 286 that already have made their acceleration decision. This parallel update scheme ensures that the simulation results do not depend on the order in which links (i.e., streets) in the network are updated.

Each intersection 292 has traffic-control logic that directs the entry of vehicles 286 into the intersection 292. The micro-simulation module 32 examines the traffic in each lane at the intersection 292. If the intersection 292 is clear, vehicles 286 pass through it in a fixed amount of time and are placed on the next roadway's link.

Vehicles 286 entering the roadway from parking locations or off-street transit stops 290 can enter any lane with a large enough gap between it and oncoming traffic. The gap must be wide enough to ensure that, on the next timestep, no vehicles 286 collide with vehicles 286 entering the roadway. A single timestep may be executed in several different steps.

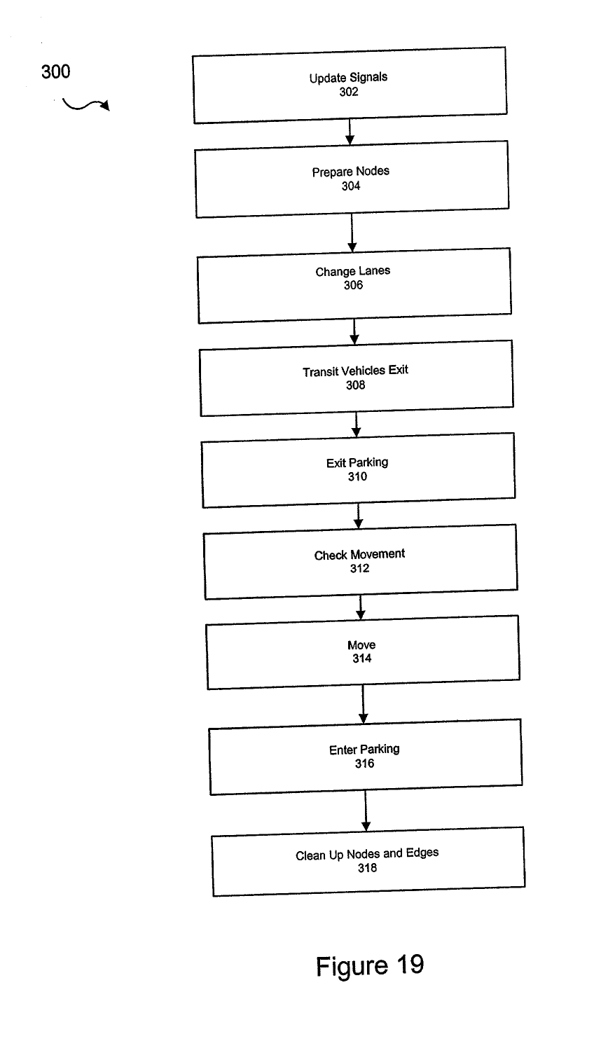

Referring to FIG. 19, a flow diagram 300 illustrating steps executed in a single timestep is shown. In a timestep, the micro-simulation module 32 updates 302 traffic signals. The micro-simulation module 32 then prepares 304 nodes. Vehicles 286 in an intersection 292 reserve space in a destination link, if possible. All vehicles 286 are allowed to change lanes 306. In this step, transit vehicles 288 are also allowed to enter transit stops 290. When vehicles 286 in two lanes at time t both try to change into the same lane, the module 32 alternates the direction of lane changing to avoid potential collisions.

The module 32 then allows transit vehicles 288 to exit 308 transit stops. Vehicles 288 stopped at transit stops 290 collect and disembark passengers. Next, vehicles 286 exit 310 parking locations. Vehicles 286 at the head of a queue waiting to leave a parking location 310 are allowed to enter the road. The module 32 then checks 312 movement. Vehicles 286 entering intersections 292 are marked and given instructions from an intersection controller about the availability of their destination link. In the next step, all of the vehicles 286 move 314 and every vehicle 286 makes an acceleration decision. Vehicles 286 are then allowed to enter 316 into parking locations. The module 32 then cleans 318 up nodes and edges. Vehicles 286 leave intersections 292 and appear in the space reserved for them in the prepare nodes step 304. Various temporary markers are removed from the grid cells 284.

The procedures invoked during each simulation timestep can be placed into one of five broad categories: 1) placing travelers and vehicles; 2) updating the location of each traveler and vehicle; 3) preparing for a timestep; 4) cleaning up after a timestep; and 5) supporting parallel computation.

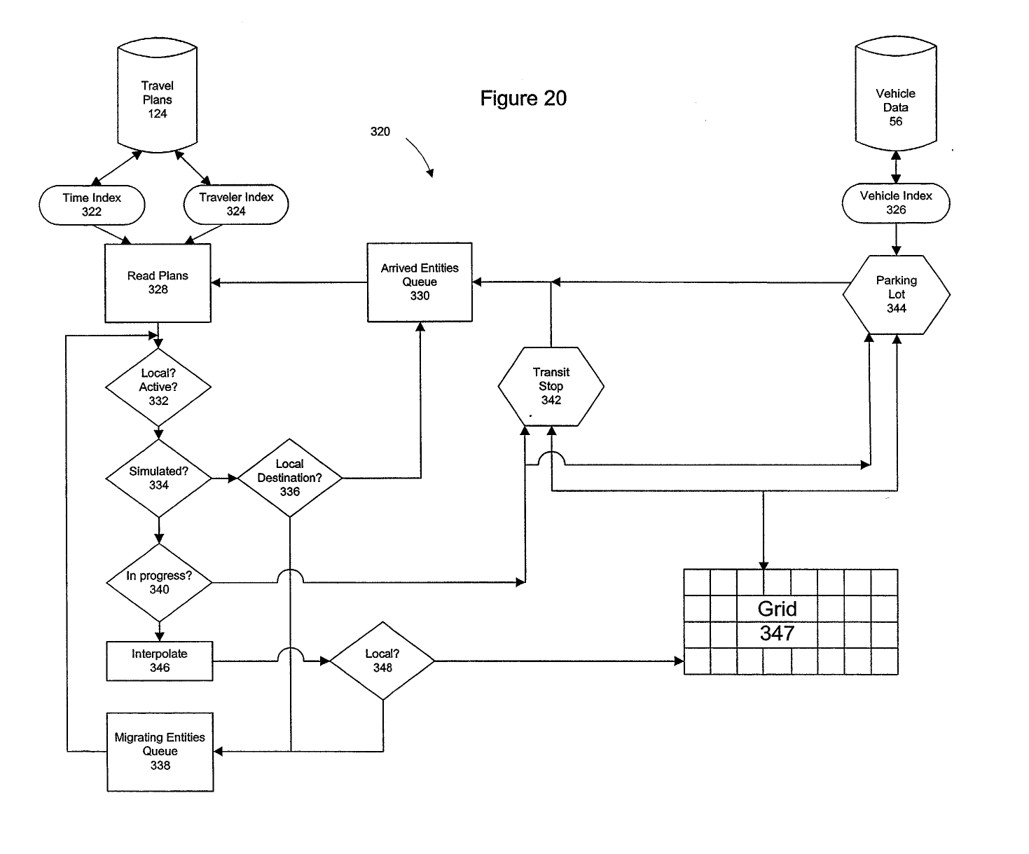

Referring to FIG. 20, a block diagram illustrating a process 320 and data structures involved in loading entities 54 and vehicles 286 into the micro-simulation module 32 is shown. The micro-simulation module 32 accesses the travel plans 124 through time and traveler indexes 322, 324. Likewise, the module 32 accesses the vehicle data 56 through a vehicle index 326. Indexes 322, 324, 326 may be generated from the appropriate file if it does not already exist. An index can refer to more than one data file.

Travel plans 124 are read 328 using indexes 322, 324 and sorted by expected departure time until all plans 124 departing before or on the current simulation step have been read. In addition, the identifications of “hibernating” entities 54, those who have already executed one leg of their plan and are waiting to depart on another, are removed off an arrived entities 54 queue 330. Each hibernating entity 54 carries along a minimal required information set that consists of: entity identification, current trip and leg ID, and a set of state flags used in maintaining states required by the output module 240.

To minimize memory requirements, other non-essential information is deleted from memory while an entity 54 hibernates. To find the next leg for each of the arrived entities 54, a read plans 328 application accesses the indexes 322, 324 and sorts travel plans 124 by entity identification. Each travel plan 124 must pass entity evaluation tests 332 before the entity 54 is placed onto the transportation network. First, the entity 54 must be local, meaning that its origin must be an accessory that is a part of the transportation network under control of the processor. Second, the entity 54 must be active, meaning that its expected arrival time must be after the simulation start time, and its departure time must be before simulation end time.

After placing an entity 54 in the transportation network, the process 320 determines 334 as to whether the travel plan 124 calls for a simulated or non-simulated mode of travel (activity, walk, or bicycle). If the travel plan 124 is non-simulated, the process 320 then determines 336 as to whether the destination is local. If the destination is local, then the process 320 places the entity 54 in the arrived entities queue 330 with a departure time specified by the travel plan 124. For example, the travel plan 124 may list using the later of a 10-minute duration or a specific time (e.g., 8:10 a.m.). The process 320 may add ten minutes to the current simulation time, compare it to 8:10 a.m., and place the entity 54 into the arrived entities queue 330 with a departure time equal to the later of the two.

If the destination is not local, the entity 54 is placed in a migrating entities queue 338 and the entity 54 migrates to another processor. The migrating entity 54 is then placed into an arrived traveler queue for the new processor.

If the entity 54 is using a simulated mode of transportation, either as a passenger or a driver, the process 320 then determines 340 as to whether the travel plan 124 is in progress, i.e., its departure and arrival times do straddle simulation start time. If not, the entity 54 is placed in the transportation network in an origin accessory. This could be either a transit stop 342 or a parking location 344. Entities 54 are not placed in activity locations because the simulated transportation modes do not have paths to or from such locations.

It is desirable for the simulation to reach normal traffic flow conditions as rapidly as possible. To facilitate this, vehicles whose driver's travel plans 124 are in progress are placed in the transportation network when the micro-simulation module 32 is initialized. This is based on where the driver's travel plans 124 predict the driver will be at the simulation starting time.

Once a plan's 124 geometric length is estimated, a link is selected by interpolating 346 along the path according to the duration of the leg, as estimated by the route planner 30. The length is difficult to determine if the plan 124 is not wholly contained within the part of the network local to the processor. Thus, this process is not guaranteed to produce the same initial condition when the number of processors varies.

The process 320 then determines 348 as to whether the entity 54 should be placed on a non-local section of the transportation network. If so, then the entity 54 is placed in the migrating entities queue 338. Otherwise, the entity 54 is placed in the grid 347 of the transportation network in a cell position and lane.

If the selected cell 284 is already occupied, the grid 347 is searched upstream for an available cell 284. If all cells 284 upstream are occupied, the grid 347 is searched downstream for an unoccupied cell 284. If all cells 284 on the link are occupied, a warning message is printed and the vehicle 286 is deleted.

No attempt is made to find an available cell 284 on an adjacent link. Because interactions between vehicles 286 are not taken into account, this process does not produce the same distribution of traffic that would be found by starting earlier and letting the simulation evolve to the same time. Furthermore, transit passengers may not be placed in transit vehicles 288, but rather placed at their destinations. If this interpolation scheme does not work satisfactorily, the user may start the simulation at an earlier time.

When travelers leaving the vehicle have completed a leg of their plan 124, they are placed in the arrived entities queue 330 and trigger the read plans 328 process to find the next leg of their plans. If all of the mass transit entities 54 exiting at this stop have been taken care of and either the bus is full or no more passengers are waiting to board, the vehicle is placed back on the grid 347.

After reading in and placing entities 54, the micro-simulation module 32 executes the travel plans 124 one step at a time. Each step involves several substeps in the order given in FIG. 19. Interactions of individual vehicles 286 on the transportation network produce traffic dynamics in the micro-simulation module 32. To determine the position of vehicles 286 on a roadway, a rule set is applied that governs movement and lane changes. This rule set may be simplified to maintain the computational speed necessary for updating positions of the large number of vehicles 286 that could be present in a regional traffic simulation.

The rule set may use a no-collision strategy on the vehicles 286. Vehicle interactions based on the rule set combine to produce emergent driver behavior. Traffic dynamics require that, for any vehicle v at time t, all position change calculations must be based on other vehicle positions at time t, not at time t+1.

During the timestep, each vehicle 286 is examined to determine if it will change lanes. To produce realistic traffic dynamics, lane change and movement must take place on the same timestep. Left and right lane changes are made on alternating timesteps to prevent collisions and to ensure that gap calculations are based on vehicle positions at time t, not t+l. Multilane roadways may be processed from left to right when making left lane changes and from right to left when making right lane changes. Vehicles 286 are not allowed to change into a lane if it would violate lane use or high occupancy vehicle (HOV) restrictions.

A vehicle 286 changes lanes for two reasons: 1) to pass a slower vehicle 286 in the current lane; and 2) to make turns at intersections to follow its travel plan 124. A vehicle 286 that needs to make a turn at the next intersection 292, as part of its plan 124, may change lanes when it is within a set distance from the intersection 292. The urgency to change into a lane increases linearly as the vehicle 286 approaches the intersection 292. Any vehicles 286 that fail to make the required lane changes are marked as off-plan.

Passing lane changes are based on three gap calculations: 1) gap in the current lane (G_{c}); 2) gap forward in the new lane (G_{f}); and 3) gap backward in the new lane (G_{b}). If these gaps satisfy the following constraints, a lane change will be attempted as follows: 1) V+1>G_{c} (i.e., a vehicle ahead in the current lane is preventing acceleration); 2) G_{f}>G_{c}(i.e., the gap in the neighboring lane is larger than in the current lane); 3) V≦G_{f} (i.e., the gap in the neighboring lane is large enough to maintain the vehicle's current speed); and 4) G_{b} ≧V_{GlobalMax} (i.e., if the lane change were made, there would not be a collision). V_{GlobalMax} may be used in constraint 3) rather than the actual speed of the other vehicle 286 for efficiency. Nothing in the lane-changing or CA rules depends on the velocity of any vehicle 286 besides the one under consideration.

Acceptable approach lanes that allow a vehicle 286 to transition to the next link in its plan 124 are determined when a vehicle 286 enters a link. A preferred lane is also selected. The preferred lane may change as the vehicle 286 changes lanes. Plan-following considerations are introduced into lane-change calculations when a vehicle 286 is within a set distance from an intersection (D_{PF}). The bias to make a lane change increases as the vehicle 286 nears the intersection 292. The bias also increases linearly with the number of lanes away from an acceptable lane.

If the vehicle 286 is already in an acceptable approach lane, the vehicle 286 is biased to stay in the correct lane and ignore lane changes to pass slower vehicles, i.e., lane changes based on gaps. Lane changes are controlled by introducing an additional parameter to the lane-change calculations. This parameter, W, is initially set to zero. If a vehicle 286 is within the D_{PF} but is not in an acceptable approach lane, W is set based on the distance between the vehicle and the intersection (D_{I}). W is also based on the minimum number of lane changes n it will take to reach an acceptable lane. W may be given by:

$$W = {V}_{Max} - \frac{( {V}_{Max} - 1 )}{n \cdot {D}_{PF}} \cdot {D}_{I} .$$

Note that as D_{I} goes from n·D_{PF} to 0, W goes from 1 to V_{Max}, the parameter W is used to gradually relax constraints 3) and 4) given above. When W reaches V, constraint 3) is completely removed and when W reaches V_{Max}, constraint 4) is removed. Because only one type of lane change is made during a timestep, the type of lane change needed (left/right) is the same as the type of lane change (left/right) calculated during this timestep.

It is possible for a vehicle 286 to have more than one approach lane that is acceptable for plan-following. If the vehicle 286 is in an acceptable lane and the new lane (left/right) must be also an acceptable approach lane, W=0, which allows lane changes based on gaps. If the new lane is not acceptable, no lane change is allowed, unless the vehicle 286 must cross the new lane to reach an acceptable one.

The micro-simulation module 32 handles mass transit vehicles 288 separately because they are not to become off-plan. Furthermore, mass transit vehicles 288 must have priority in making lane changes. In addition, mass transit vehicles 288 are allowed to enter transit stops 290 during lane changes. Each mass transit vehicle 288 enters a transit stop 290 if: it is not full and there is a queue of passengers waiting at the stop; any passenger wishes to get off at the stop; or the driver's travel plan 124 includes a scheduled departure time for this step and that time has not yet passed.

The transit vehicle 288 may either be left occupying the grid cells 284 or taken off the grid entirely, depending on the style of transit stop 290. If it is left on the grid, it will attempt to get into the rightmost lane. The vehicle's speed 288 constraint is set to 0 while it is in the STOP style of transit stop.

Merging by vehicles 286 is handled by using the lane-change logic. Vehicles 286 in merge lanes are forced to make lane changes in the same direction as the merge direction. In some cases, a lane can have a merge pocket and a turn pocket further down the lane toward the intersection 292. In these cases, vehicles that need to use the turn pocket are prohibited from entering the lane until they are past the end point of the merge pocket.

The micro-simulation module 32 imposes speed restrictions on vehicles 286 attempting to enter a turn pocket lane from an adjacent lane. These restrictions prevent movement of the vehicle 286 past the start of the turn pocket, thus causing the vehicles 286 to queue on the adjacent lane until it is a possible to execute a lane change into the turn pocket lane.

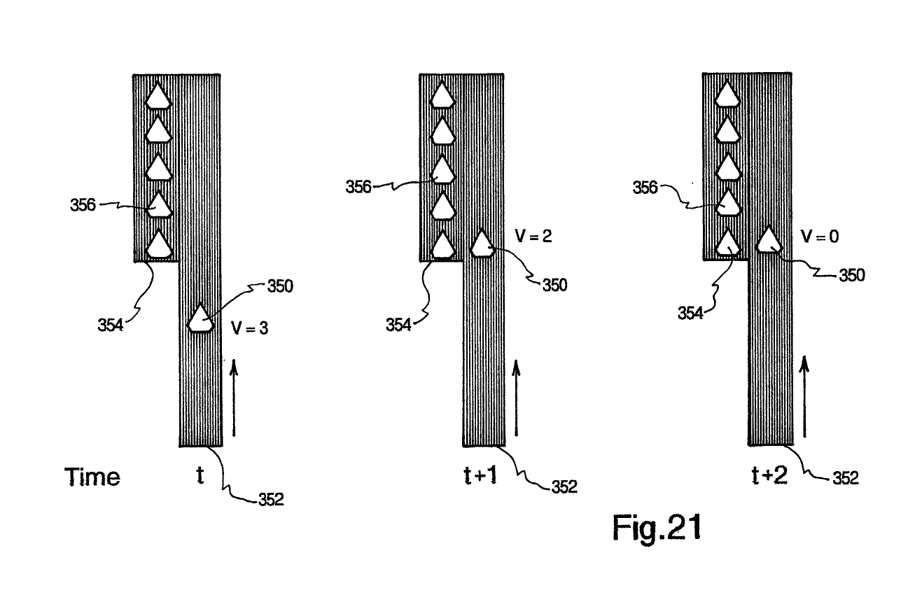

Referring to FIG. 21, a plan view of vehicles 286 in two lanes illustrates vehicle behavior at turn pocket lanes. The vehicle 350 in lane two 352 needs to make a left turn at the next intersection. The left turn pocket of lane one 354 has no vacant cells. At time t, the vehicle's 350 speed is 3, which will move the vehicle 350 past the start of the turn pocket. The vehicle's 350 speed is constrained to 2, the distance from the vehicle's 350 current position at time t and the start of the turn pocket.

At time t+1, the vehicle 350 has moved down lane two 352 to the starting cell of the turn pocket. A lane change into the turn pocket is not possible because other vehicles 356 occupy all of the cells. By constraining the speed to 0, the vehicle 350 is prevented from traveling further down lane two 352. At time t+2, the vehicle 350 remains in lane two 352 with speed 0. The vehicle's 350 speed will remain constrained to 0 until a lane change into the turn pocket is possible.

Approach lanes can be determined by considering only the connectivity to the next link. However, some vehicles 286 cannot make the required lane changes into acceptable approach lanes on short multilane links with multiple lane connectivity at the intersections. Looking ahead across links increases the time that a vehicle 286 has to make a plan-following lane change.

The micro-simulation module 32 uses plan look-ahead distance to determine acceptable approach lanes. The distance is used to determine how many links in the travel plan 124 are considered when determining the approach lanes on the current link. A default value of 0.0 means that approach lanes are determined by considering the next link only.

While a vehicle 286 is in a transit stop 290, the transit-stop object contains a pointer to the vehicle 286 that implies that the capacity of stops is 1. The object also contains queues of travelers waiting to board transit vehicles 288. There is a separate queue for each route identification.

If there is a transit vehicle 288 currently servicing a stop 290 and the transit vehicle 288 has been there for at least the number of timesteps specified by the configuration file key, then entities 54 are allowed to enter and exit the transit vehicle 288. Entry and exit can take place simultaneously, but the mean rate at which travelers enter and exit is set by configuration file keys.

Entities 54 may be removed from an entity queue until the maximum number of entities 54 who can board in a single timestep is reached or an entity 54 is found whose next departure time is later than the current simulation time. If an entity's travel plan 124 calls for the entity 54 to take the route that this vehicle 286 is servicing, and the number of passengers already aboard does not exceed the capacity for this type of vehicle 286, then the entity 54 will enter the vehicle 286.

A parking place accessory has a list of identifications for the vehicles 286 present (either because they began the simulation there or they have arrived during the course of the simulation). It also has a queue of travelers and their associated plans 124. This procedure handles each traveler in the traveler queue whose departure time has arrived.

An entity 54 cannot leave unless a vehicle 286 is present. If the vehicle 286 is not there, the entity's 54 departure time is incremented and the entity 54 is replaced in the arrived entities queue 330 as shown in FIG. 20. Depending on the travel plan 124, the entity 54 is added to the vehicle 286 as either a driver or a passenger. If the driver has not yet been added to the vehicle 286, the next traveler is removed off the arrived entities queue 330. Otherwise, the driver determines how many passengers are anticipated. This information may be contained in the driver's plan 124, along with the identifications of the expected passengers.

If any passengers are missing, the driver is placed back in the arrived entities queue 330 so that the vehicle 286 will try to leave again on the next timestep. If the driver and all passengers are present, the vehicle 286 attempts to find room on the grid 347 in any lane and traveling at the speed limit.

Once the appropriate grid 347 for the planned direction of travel is determined, the grid 347 is searched upstream for a distance of V_{Max} cells. If a vehicle 286 is found in a lane, that lane and the adjacent lanes are eliminated from consideration. Thus, the maximum number of vehicles 286 that can leave a lot in one timestep is the number of lanes on the grid 347. All lanes are searched and if a lane is available, the vehicle 286 is placed on the lane at the cell 284 corresponding to the parking lot 344. If there is no room on the grid 347, the driver is returned to the arrived entity queue 330.

This procedure handles vehicles 286 that leave a link and pass through an intersection 292. Upon arriving at an intersection 292, a vehicle's 286 destination lane on the next link is determined. The current lane is selected if it is allowed on the next link; otherwise, a lane is picked at random from the set of allowed lanes.

Intersections 292 without signals and with stop/yield traffic controls require vehicles 286 to consider oncoming traffic before they can move onto the next link. The vehicles 286 use the gap between the oncoming vehicles 286 and the intersection 292 to determine if they can enter the intersection 292. If the gap is acceptable, the vehicle 286 traverses the intersection 292 and arrives on the destination link during a single update step in the simulation.

Vehicles 286 at intersections 292 with signals have different behaviors from those at intersections 292 without signals. When a vehicle 286 enters an intersection 292 with signals, it is placed in a queued buffer, where it resides for a specified time before exiting to the destination link. The time that the vehicle 286 spends in the queued buffer models the time necessary to traverse the intersection 292. Vehicles 286 with permitted but not protected movements from the intersection traffic control must consider the oncoming traffic before entering the intersection 292.

To enter an intersection 292, a vehicle 286 may be required to satisfy six conditions. First, the vehicle 286 must be on the link in the current lane going toward the intersection 292. Only one vehicle 286 per lane is allowed to enter the intersection 292 in a single timestep. Second, the vehicle 286 must have a current speed greater than or equal to the number of empty cells 284 between the vehicle 286 and the end of the link. Third, the vehicle 286 must satisfy the conditions of the traffic control at the intersection 292. The state of the traffic control indicates if a vehicle 286 must consider oncoming traffic gaps. Fourth, there must be an acceptable gap between the vehicle 286 and oncoming traffic. Fifth, the intersection buffer for the current lane must not be full.

Finally, the destination cell 284 in the destination lane on the destination link must be unoccupied.

A vehicle 286 will attempt to enter an intersection 292 if its current speed is greater than or equal to the number of empty cells 284 between the vehicle 286 and the end of the link. The state of the traffic control at the intersection is an important factor in determining if a vehicle 286 can enter the intersection 292.

To enter an intersection 292 with a signal, the traffic controller must indicate a permitted, protected, or caution movement for the current lane and the desired movement. At an intersection 292 without a signal, stop and yield signs impose conditions on intersection entry.

A traffic controller state may require that the distance between the intersection 292 and oncoming traffic, interfering lane gap, meet certain criteria before the vehicle can 286 enter the intersection 292. Table 118 shows the traffic controller states and their corresponding actions.

TABLE 118
Traffic controller states and corresponding actions.

| Traffic Controller State | Action | Conditions |
|---|---|---|
| S* - Protected | Proceed | None |
| S - Wait | Stop | None |
| S - Permitted | Evaluate | G_{I} on IL (Interfering Lanes) |
| S - Caution | Proceed | None |
| U** - None | Proceed | None |
| U - Stop | Wait | Stopped < 1 Timestep |
| | Evaluate | G_{I} on IL, Stopped ≧ 1 Timestep |
| U - Yield | Evaluate | G_{I} on IL |

*S = Signalized intersection
**U = Unsignalized intersection

The interfering lane gap (G_{I}) consists of the distance between the oncoming vehicle 286 and the intersection 292. The oncoming vehicle 286 must be on a link connected to the intersection 292, which limits the look-back distance for oncoming traffic to the length of a single link. The oncoming vehicle's 286 speed (V₀ᵥ) and the gap velocity factor (GVF) are used to calculate the desired gap (G_{d}), such that G_{d}=V₀ᵥ*GVF.

On links in which the desired gap is greater than the number of cells 284 on the link, the number of cells 284 on the link is used as the desired gap. Where G_{I}≧G_{d}, the interfering gap is acceptable. Where G_{I}<G_{d}, the interfering gap is not acceptable. For an oncoming vehicle 286 with speed of 0, G_{d} will be 0, which allows movement through intersections 292 in congested conditions in which both G_{d} and G_{I}=0. If the interfering gap is not acceptable, the vehicle 286 is at a stop or a yield sign, and the interfering lane is also controlled by a stop/yield sign, then there will be a deadlock resolution in which the vehicle 286 will proceed with probability determined by the value of a configuration file key.

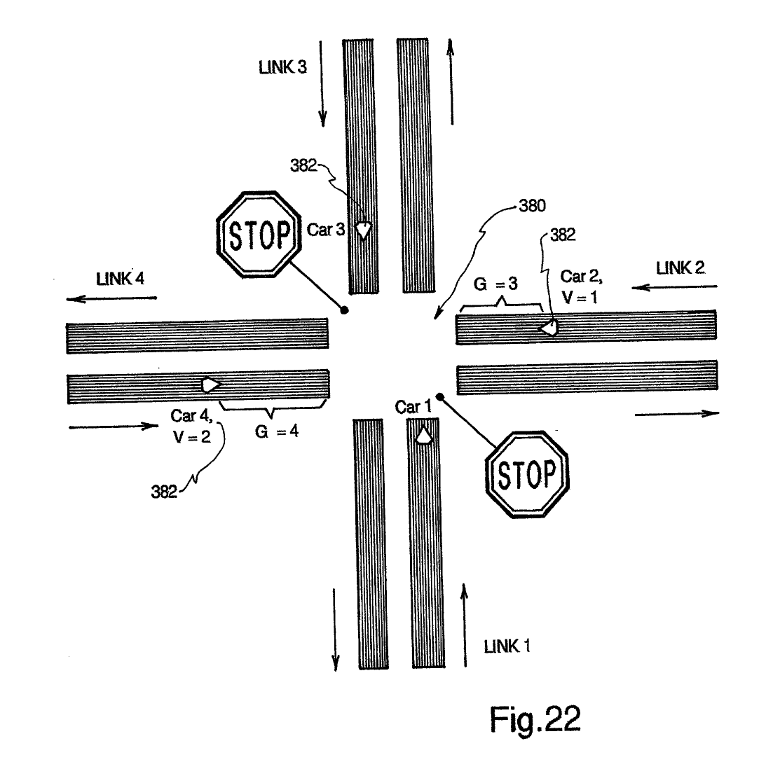

Referring to FIG. 22, a plan view of an intersection 380 is shown to illustrate the intersection entry interfering lane gap. A vehicle 382 can enter the intersection 380 only when the interfering gaps are acceptable (G_{I}≧G_{d}). If the traffic control for the intersection 380 is signalized, the vehicle 382 does not traverse the intersection in the current timestep. Signalized intersections maintain internal queued buffers in which vehicles 382 are placed to traverse the intersection 380. Each intersection 380 has one queued buffer for each incoming lane.

If the conditions of the signalized traffic controller have been satisfied, a vehicle 382 must check whether the appropriate buffer has space to receive the vehicle 382. If this is the case, the vehicle 382 is removed from the incoming link and is placed in the intersection buffer for a wait period. After the wait period has expired, the vehicle 382 exits from the buffer to the first cell on the destination link if the cell is vacant. If it is not, the vehicle 382 waits in the intersection buffer until the cell becomes vacant. The buffers may have a fixed size, so that if the buffer is full the vehicle 382 cannot enter the intersection 380 and must wait on the link.

At intersections 380 without signals, vehicles 382 can enter and exit the intersection 380 in a single timestep. Therefore, if the conditions of the unsignalized traffic controller have been satisfied for intersection entry, a vacant cell on the destination link in the destination lane must be available for the vehicle 382 to enter the intersection 380. The vehicle's 382 current speed is used to determine which cell to reserve on the destination link.

If the primary destination cell is unavailable, the next cell closer to the intersection is tried. This process continues until an available cell is found or until all the cells between the intersection 380 and the primary destination cell are tried. A marker is placed in the destination cell to reserve the cell.

If a vehicle 382 successfully reserves a place in the queue or on the next link, an internal state variable will be set to indicate that it can proceed. The internal state variable is used during the movement procedure to determine whether to remove a vehicle 382 from a link or decrease its speed. Vehicles 382 traversing intersections 380 without signals are placed on their destination link during the cleanup procedure 318 at the end of a timestep.

An off-plan vehicle 382 is one that is not in an acceptable approach lane when it is ready to enter an intersection 380 and thus cannot follow its assigned plan. Vehicles 382 that have not moved for the number of timesteps, as defined by a configuration file key, also become off-plan. The timestep when the vehicle 382 tries to exit from the simulation is calculated using an off-plan exit time. Once this is calculated, a new destination link is selected from links connected to the vehicle's 382 current lane. New destination links may be randomly selected for off-plan vehicles 382 until the current timestep is equal to the calculated exit timestep. Once time is reached, the vehicles 382 are removed from the simulation at the nearest parking place.

Vehicles 382 attempting to enter an intersection 380 and that have not moved for a specified period of time abandon their travel plans 124 and, if possible, select a different destination link. These vehicles 382 are marked as off-plan and are removed at the nearest parking place. Allowing vehicles 382 to become off-plan after a specified waiting period is necessary to prevent traffic gridlock.

The micro-simulation module 32 incorporates a simple movement rule that an entity or vehicle accelerates when it can, slows down if it must, and sometimes slows down for no reason. This movement rule is executed to update the speed and position of each vehicle in the transportation network. Each vehicle attempts to accelerate up to a desired speed if the gap is greater than the current speed. The desired speed is limited to the speed limit posted on each link and the maximum speed for each vehicle type and subtype.

If the gap is smaller than the current speed, the vehicle will slow down until its current speed is equal to the gap, thus imposing the no-collision condition. Each vehicle also has a random probability of slowing down. This is called the deceleration probability (P_{D}). Use of the deceleration probability is essential to produce realistic traffic dynamics, such as jam waves, from individual vehicle interactions. To compute a vehicle's speed and the next position on a link (Vₜ+1), the speed based on the gap and the vehicle's speed in the current timestep (Vₜ) is first computed. This is done by computing the gap. Then if (Vₜ<gap and Vₜ<V_{Max}), Vₜ+1=V+Aₜ. The acceleration Aₜ is determined separately for each vehicle subtype. For autos, Aₜ is the maximum acceleration as specified in the vehicle data 56. For other vehicles, acceleration is grade and velocity dependent.

Under the assumption of constant power acceleration, A_{Max} is interpreted as the maximum acceleration at V=7.5 m/sec=1 cell/timestep. Then, the velocity dependence is A=A_{Max}/V. The grade dependence is managed by taking into account the acceleration caused by gravity, A=A_{Max}/V-gsinθ, where θ is the grade. Negative accelerations are possible, until a vehicle reaches its “crawl speed” of 1 cell/timestep. Fractional accelerations are managed by using the greatest integer part and adding 1 randomly. That is, an acceleration of 1.6 cells/timestep/timestep is implemented as an acceleration of 2 (60% of the time) and 1 (40% of the time).

Each moving automobile (speed>0), but not heavy vehicles, has a random probability of decelerating in each timestep. The probability is computed and the vehicle decelerates if the computed probability is less than the deceleration probability. The vehicle moves to its new grid position based on the new speed. The new cell is equal to the current cell plus Vₜ₊₁.

To remove vehicles from the roadway at destination parking places, the micro-simulation module 32 checks all of the cells in all lanes downstream from the parking place for a distance of V_{GlobalMax} cells. If a vehicle is found on the last step of the current leg of its plan and with this parking place as its destination, the vehicle is removed from the roadway. The removed vehicle identification is placed onto the list of vehicles present at that parking place.

Timing tables provided for each signal are used to update them at each timestep. Signalized traffic controls are initialized at the beginning of the simulation to the first interval of the signal cycle's first phase when the signal offset is 0.0. When the offset is not zero, the signal is initialized to the phase and interval that corresponds to simulation time 0 in the offset cycle.

Vehicles 382 in each intersection 380 that are ready to be ejected during the present timestep are located. Vehicles 382 exit from the intersection queued buffers when their residence time in the buffer is greater than the intersection residence time specified by a configuration file key. Vehicles 382 exit from the queued buffer onto the first cell in the destination lane on the destination link. Exiting vehicles 382 reserve their destination cell before vehicles 382 on links calculate movement, thus giving the vehicles 382 exiting from intersection buffers precedence over vehicles 382 on the links. This procedure places a temporary vehicle marker on the next grid for each vehicle 382 that will leave the intersection 380 on this timestep.

After a timestep, the micro-simulation module 32 performs a clean up of nodes and edges 318 shown in FIG. 19. Any vehicle that has passed from a region of a link controlled by a processor into a region controlled by its neighbor may be encoded in a message and sent to that neighbor. In this manner, migrating vehicles may be moved on a link-by-link basis. Some entities not in vehicles may have been placed in the migrating entities queue 338 shown in FIG. 20 during the timestep. These entities are encoded into messages and passed on to the desired processors thereby clearing out the queue as it goes.

Cleaning up the nodes causes each intersection 380 to eject the first vehicle 382 in each of its buffers into previously reserved locations on the destination link. Vehicles 382 are transferred from the buffers to their reserved destination cells during the cleanup phase 318, which takes place after movement changes of all vehicles 382 have been executed. Vehicle speed does not change during intersection entry/exit at a signalized intersection. Vehicles 382 are placed in the first cell on the destination link with the same velocity that they entered the intersection buffer.

Cleaning up edges 318 clears all temporary vehicle markers from the grids. In addition, if the cleanup action state variable for a vehicle is eject, it places the vehicle in the intersection buffer. If the cleanup action is migrate, it deletes the vehicle which has already been sent to its destination processor in the migration step.

The micro-simulation module 32 may run on multiple processors to maximize computational speed. Updating vehicle positions then can be done in parallel on individual processors. This method is faster than a single, sequential update algorithm on transportation networks with a large number of vehicles.

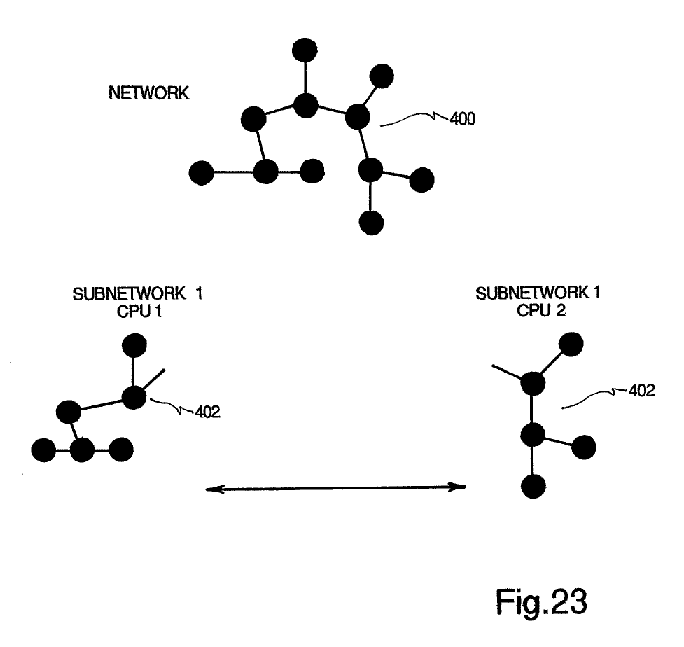

Referring to FIG. 23, a transportation network 400 is shown to illustrate its partition among multiple processors. The transportation network 400 is partitioned between two processors with each processor receiving a set of nodes and links to create two subnetworks 402. Partitioning may be performed through use of an orthogonal bisection (OB) algorithm or the METIS graph-partitioning library. METIS is a public domain package which is widely available and well known in the art. The algorithm used may be determined at run time by a combination of the configuration file keys.

Both OB and METIS algorithms use a cost function for each node. METIS also uses a cost function for each link. These costs can be based on the number of cells on the links attached to the node if no other information is available. As the simulation runs, it collects information on the amount of processor time devoted to processing each link and node. This information can be saved in a run time measurements file, which can be used to assign costs to the links and nodes in subsequent partitioning calculations.

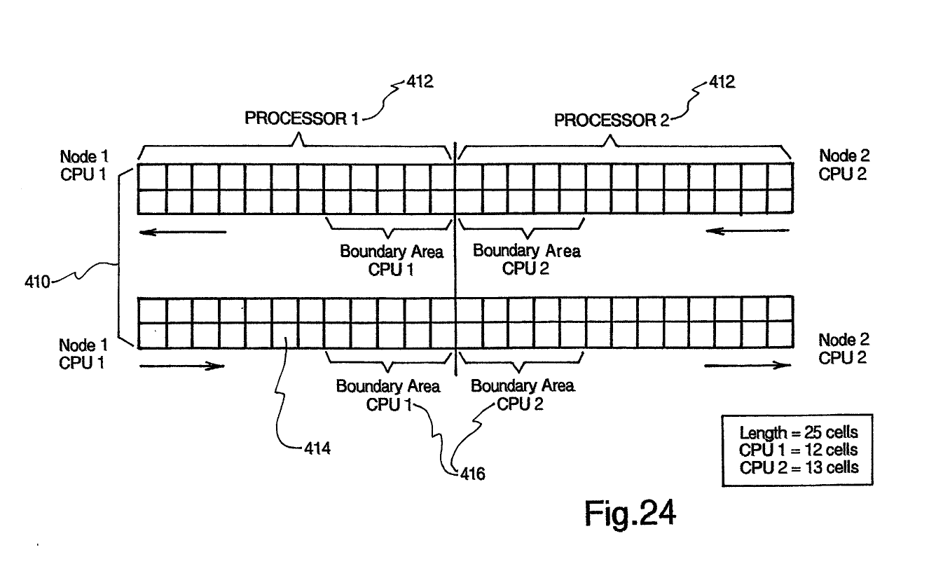

Referring to FIG. 24, a block diagram illustrates a link 410 that is distributed between two processors 412. Links that connect nodes residing on different processors are split or distributed. These links are referred to herein as distributed links. Each processor 412 is responsible for approximately one-half of the link 410. Each distributed link 410 is assigned a number of active grid cells 414 belonging to a given processor 412. Such an assignment is necessary to consistently divide links 410 with an odd number of cells. The area in the middle of the distributed links 410 is called a boundary area 416. The boundary area's 416 width may be V_{GlobalMax} (5) cells. The maximum distance, forward or backward on a link, that can be used for gap calculations is limited to the boundary width on distributed links 410.

Vehicles are transferred between processors 412 as they traverse these distributed links 410. Each distributed link 410 introduces a message-passing delay during the update sequence because messages must be passed between the processors 412 for vehicles that are crossing distributed links 410. Two types of messages are exchanged between processors 412 with distributed links 410: 1) vehicle migration messages, which are messages for vehicles transferred to the other part of the link 410 on a different processor 412; and 2) boundary exchange messages, which are messages containing information about vehicle positions in the boundary area 416 of a link 410.

Vehicle migration messages occur for all vehicles that have traversed half the cells 414 of a distributed link 410. These vehicles must be transferred to the processor 412 that owns the other half of the distributed link 410. All information about the vehicle, its occupants, and the travel plans 124 is put into a message and sent to the destination processor 412 after which the vehicle is removed from the originating processor 412.

Upon receipt of the message, the destination processor 412 recreates the vehicle and entities using the information in the message. The destination processor 412 then places the vehicle and entities at the appropriate position on its half of the distributed link 410.

Exchange of boundary information between processors 412 is referred to as a boundary exchange. Boundary exchange messages are used to correctly calculate position changes, movement and lane changes, for vehicles in a processor's 412 boundary area 416. Information about vehicles in the next V_{GlobalMax} cells 414, or preceding V_{GlobalMax} cells 414, depending on the direction of traffic flow, is necessary to execute the appropriate gap calculations for lane changes and movement.

Each processor 412 maintains a list of its distributed links 410 and of the processor owners of the other half of the links 410. Boundary exchanges are conducted before lane changes and again before vehicle movement. Each processor 412 initiates the exchanges at the appropriate time. Each processor 412 waits until it receives all of the boundary exchange messages from neighboring processors.

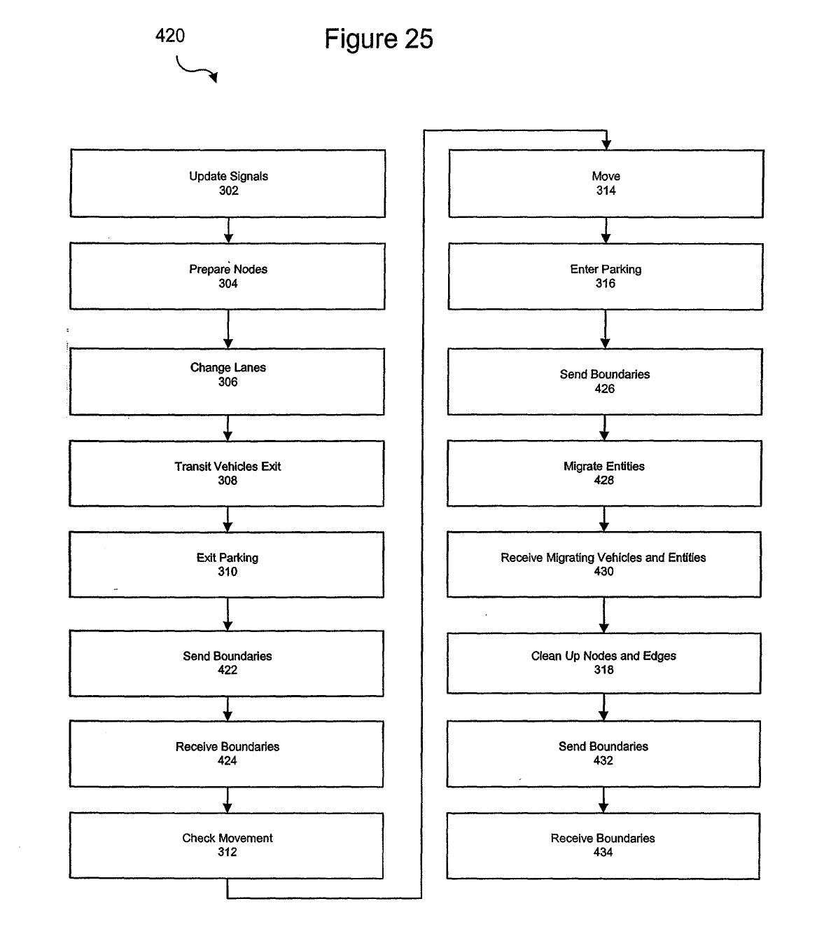

Referring to FIG. 25 a flow diagram 420 illustrating steps executed in a single timestep for distributed processing is shown. The flow diagram includes steps additional to those of FIG. 19 to illustrate message passing in a distributed version of the micro-simulation module 32. A processor sends and receives 422, 424 boundary exchange messages after vehicles exit 310 parking locations. After entering 316 parking locations, a processor sends 426 boundary exchange messages, migrates 428 entities, and receives 430 migrating vehicles and entities. After the cleaning phase 318, the processor once again sends and receives 432, 434 boundary exchange messages.

In a distributed version of the micro-simulation module 32, the module 32 may use a master/slave paradigm. A master process starts the slave processes, handles the initialization sequence, and serves as a synchronization point for the slave processes. The slave processes do the work in the simulation. After initialization, each slave process completes successive update cycles until the end of the specified simulation run. The slave processes synchronize with the master process at the beginning of each timestep or at the beginning of a sequence of timesteps, depending on the value of a configuration file key.

The master process begins by reading the network data 16, constructing a copy of the transportation network, and constructing or reading a partition. The master then is ready to create and initialize a five-step slave process. First, the slave processes start. Then the master process sends each slave lists of its local nodes and links and lists of those slaves connected to it by distributed links.

Each slave receives a mapping from node identifications to processor identifications, and optionally a mapping from accessory identifications to processor identifications. The master then tells each slave to construct its transportation subnetwork from database information. Finally, the master tells slaves to read in the initial plans, queue initial vehicles on parking places, and initially place vehicles on the links at the given simulation start time.

After the initialization sequence is complete, the master starts the simulation by telling the slaves to execute the first timestep sequence. The master process waits until all of the slaves complete execution of a fixed number of timesteps. The master then sends a message to the slaves to execute the next timestep sequence.

Upon termination, the master sends messages to the slaves to shut down the parallel input/output system. The slaves are then instructed to exit when the requested number of timesteps has been executed.

For efficiency, a parallel code may overlap communication and computation whenever possible. This enables a processor to continue executing useful work while waiting for responses from other processors. The micro-simulation module 32 may accomplish this by noting which links are under a single processor's control and which are shared. After sending boundary information, each processor can update all of its non-shared links before it makes use of boundary information received from other processors.

Slaves generate in parallel all output information from the micro-simulation module 32. Each slave sends a message to the master indicating what sort of information it would like to write and how many bytes the information will require on a memory. The master collates the requests from all the slaves and responds to each, indicating an offset into a file for writing the information. Each slave then writes its information to a memory at the indicated location.

Referring again to FIG. 17, the output module 240 collects data from the running micro-simulation module 32 and stores it for subsequent examination by a user or use by other components. The output module 240 provides a software layer that insulates applications from the details of the file structure and provides great flexibility in the specification of the data to be collected. A parallel communication library may be used to collect data in ASCII format into a single file written by the master simulation process. No post-processing is required by the output module 240.

The output module 240 may generate simulation output data 242 in various file formats. The micro-simulation module 32 outputs traveler event records 244 each time an event of interest to the user takes place. Filtering capabilities may be provided so that the user can select which of the many potentially interesting events should be recorded. Table 19 provides a list of events that may be of interest. The other fields describe an entity's state at the time the event took place.

TABLE 19
Traveler event record fields.

| Field | Description | |
|---|---|---|
| TIME | The current time (seconds from midnight). | |
| TRAVELER | The traveler ID. | |
| TRIP | The traveler's trip ID. | |
| LEG | The traveler's plan leg ID. | |
| VEHICLE | The vehicle ID; value = 0 if not in a vehicle. | |
| VEHTYPE | The vehicle type: | |
| | 0 = walk | |
| | 1 = auto | |
| | 2 = truck | |
| | 3 = bicycle | |
| | 4 = taxi | |
| | 5 = bus | |
| | 6 = trolley | |
| | 7 = streetcar | |
| | 8 = light rail | |
| | 9 = rapid rail | |
| | 10 = regional rail | |
| VSUBTYPE | The vehicle subtype may be unused; value = 0 if | |
| | not applicable. | |
| ROUTE | The transit route ID; value = −1 if not in a transit | |
| | vehicle. | |
| STOPS | The count of number of stop signs encountered on | |
| | current plan leg. | |
| YIELDS | The count of number of yield signs encountered on | |
| | current plan leg. | |
| SIGNALS | The number of traffic signals encountered on current | |
| | plan leg. | |
| TURN | The type of last turn made: | |
| | 0 = straight direction (no turn) | |
| | 1 = right turn | |
| | −1 = left turn | |
| | 2 = hard right turn | |
| | −2 = hard left turn | |
| | values 3 to 6 represent increasingly more extreme | |
| | right turns | |
| | values −3 to −6 represent increasingly more extreme | |
| | left turns | |
| | −7 = reverse direction (U-turn) | |
| STOPPED | The time (seconds) spent stopped on current plan leg. | |
| ACCELS | The time (seconds) spent accelerating from 0 on | |
| | current plan leg. | |
| TIMESUM | The total time (seconds) spent on current plan leg. | |
| DISTANCESUM | The total distance (meters) traveled on current plan leg | |
| | (see accompanying text for more information). | |
| USER | The analyst-defined field: any integer value is | |
| | acceptable;definition may vary with each | |
| | case study. | |
| LINK | The link ID when traveler is on a link or previous link | |
| | when traveler is in an intersection. | |
| NODE | The node ID traveler is traveling away from on a | |
| | link or node traveler is in an intersection. | |
| ANOMALY | The type of anomaly: | |
| | 0 = no anomaly occurred | |
| | 1 = traveler is off plan | |
| | 2 = traveler cannot find next link in plan | |
| | 3 = traveler cannot find next parking place in | |
| | plan | |
| | 4 = traveler cannot find next vehicle in plan | |
| | 5 = traveler cannot find next transit stop in plan | |
| | 6 = traveler cannot board full transit vehicle | |
| | 7 = driver of transit vehicle skipped stop that | |
| | had passengers waiting to board | |
| | 8 = driver of vehicle cannot change lanes because | |
| | of congestion | |
| STATUS | The traveler's current status bits: (see accompanying | |
| | text for a detailed explanation of status bit | |
| | interpretation). | |
| | 0x1 = traveler is on a link (persistent) | |
| | 0x2 = change in traveler's on-link status | |
| | 0x4 = traveler is on a leg (persistent) | |
| | 0x8 = change in traveler's on-leg status | |
| | 0x10 = change in traveler's on-trip status | |
| | 0x20 = traveler is non-motorized, i.e., walking, | |
| | bicycling (persistent) | |
| | 0x40 = traveler is not in the study area (persistent) | |
| | 0x80 = change in traveler's in-study area status | |
| | 0x100 = traveler is in a vehicle (persistent) | |
| | 0x200 = change in traveler's vehicle occupancy status | |
| | 0x400 = traveler is the driver (persistent) | |
| | 0x800 = change in traveler's driver status | |
| | 0x1000 = traveler is waiting at some location | |
| | (persistent) | |
| | 0x2000 = change in traveler's waiting status | |
| | 0x4000 = location is a parking place (persistent) | |
| | 0x8000 = location is a transit stop (persistent) | |
| | 0x10000 = driver of transit vehicle is at a transit stop | |
| | (persistent) | |
| | 0x20000 = change in driver's transit vehicle at stop | |
| | status | |
| | 0x40000 = driver of transit vehicle is on a layover | |
| | (persistent) | |
| | 0x80000 = change in driver's transit vehicle on | |
| | layover status | |
| | 0x100000 = driver's transit vehicle is full | |
| | (persistent) | |
| | 0x200000 = change in driver's transit vehicle full | |
| | status | |
| | 0x400000 = traveler is off plan | |
| | (persistent) | |
| | 0x800000 = change in traveler's off-plan status | |
| | 0x1000000 = beginning of simulation | |
| | 0x2000000 = end of simulation | |
| | 0x4000000 = location is an activity location | |
| | (persistent) | |
| | 0x8000000 = undefined | |
| | 0x10000000 = undefined | |
| | 0x20000000 = undefined | |
| | 0x40000000 = undefined | |
| | 0x80000000 = undefined | |
| LOCATION | The traveler's location: parking place ID, transit stop | |
| | ID, or activity location ID, depending on the event as | |
| | defined as follows: | |
| | EVENT | LOCATION value |
| | Begin/End | parking place ID or transit stop ID |
| | plan leg | |
| | Begin/End | parking place ID or transit stop ID |
| | trip | |
| | Enter/Exit | parking place ID or transit stop ID |
| | vehicle | |
| | Begin/End | parking place ID or transit stop ID |
| | driving | |
| | Waiting | transit stop ID |
| | for transit | |
| | Waiting | parking place ID |
| | at parking | |
| | Begin/End | activity location ID |
| | activity | |
| | Transit vehicle | transit stop ID |
| | at stop | |
| | Transit vehicle | transit stop ID |
| | on layover | |
| | Transit vehicle | transit stop ID |
| | full | |
| | Can't find | parking place ID |
| | parking | |
| | Can't find | parking place ID |
| | vehicle | |
| | Can't find | transit stop ID |
| | transit stop | |
| | Can't board | transit stop ID |
| | transit | |
| | Skipped | transit stop ID |
| | transit stop | |

When the traveler is on a link or in an intersection, the
LOCATION field is zero.

The STATUS field may be bit-oriented. Each bit represents a characteristic about the entity that is true whenever the bit is set. Multiple bits set signifies that multiple characteristics are true at this time. Interpretation of the STATUS field involves determining which combination of characteristics is currently true according to the table that describes the individual bits. It is convenient to view the STATUS field in hexadecimal notation because this more clearly illuminates the patterns in the field. Status values are generally represented in bit pairs. The lower bit of a pair is termed the “persistent bit,” whereas the upper bit is termed the “change bit.” The persistent bit is set during the entire time that the condition is true. The change bit is set only for the timestep when a change in the persistent bit occurs.

This scheme enables the user to identify the beginning and the end of a persistent condition without comparing multiple events. For example, when an entity begins a leg, the persistent bit representing on leg (0×4) is set, and the change bit representing change in on leg (0×8) is set. While the entity is on the leg, the persistent bit (0×4) remains set, and the change bit (0×8) is cleared. When the entity ends the leg, the persistent bit (0×4) is cleared, and the change bit (0×8) is again set for one timestep. While the entity is not on a leg, e.g., while waiting somewhere, both the persistent bit and the change bit are cleared.

A few of the status bits take place singly rather than in pairs because both bits are not required. For example, a persistent bit for on trip is not needed because entities are only simulated while they are on a trip. A persistent bit that is always set provides no additional information and clutters the output, and therefore it is not used. The non-motorized bit (0×20) is used in conjunction with the on leg bits to indicate that the leg does not involve vehicular travel.

The location type identification bits (0×4000, 0×8000, and 0×4000000) are used in two ways: 1) the bits are used in conjunction with bits 0×10000 and 0×2000 to identify the type of location at which the traveler is waiting; and 2) the bits are also used to specify the type of location when the LOCATION field represents a parking place or transit stop identification. For example, when an entity begins a leg at a parking place, bit 0×4000 will be set in addition to bits 0×4 and 0×8 to signify that the beginning location of the leg is a parking place.

The DISTANCESUM field accumulates the distance traveled along links and within intersections. Upon entering the intersection, DISTANCESUM is incremented by the setback on the link just left; and when exiting the intersection, DISTANCESUM is incremented by the setback on the new link.

Snapshot data 246 provides detailed information about the state of the simulation at a point in time. Multiple snapshots allow a user to follow the evolution of the simulation state through time. Snapshot data 246 includes vehicle snapshot data that provides information about vehicles traveling on a link. When collected for every link on every timestep, such data give a complete trajectory for each vehicle in the simulation. Vehicle snapshot data is collected as frequently as the user may indicate in an input configuration file for the specified links. Table 20 provides a sample list of vehicle snapshot record fields.

TABLE 20
Vehicle snapshot data record fields.

| Field | Interpretation | |
|---|---|---|
| VEHICLE | The vehicle ID. | |
| TIME | The current time (seconds from midnight). | |
| LINK | The link ID on which the vehicle was traveling. | |
| NODE | The node ID from which the vehicle was traveling | |
| | away from. | |
| LANE | The number of the lane on which the vehicle is traveling. | |
| DISTANCE | The distance (in meters) the vehicle is away from the | |
| | setback of the node from which it is traveling away. | |
| VELOCITY | The velocity (in meters per second) of the vehicle. | |
| VEHTYPE | The vehicle type: | |
| | 0 = walk | 6 = trolley |
| | 1 = auto | 7 = streetcar |
| | 2 = truck | 8 = light rail |
| | 3 = bicycle | 9 = rapid rail |
| | 4 = taxi | 10 = regional rail |
| | 5 = bus | |

| | |
|---|---|
| ACCELER | The acceleration (in meters per second) the |
| | vehicle had in the current timestep. |
| DRIVER | The driver ID. |
| PASSENGERS | The count of passengers in vehicle. |
| EASTING | The vehicle's x-coordinate (in meters). |
| NORTHING | The vehicle's y-coordinate (in meters). |
| ELEVATION | The vehicle's z-coordinate (in meters). |
| AZIMUTH | The vehicle's orientation angle (degrees from |
| | east in the counterclockwise direction). |
| USER | The user-defined field that can be set on a per-vehicle |
| | basis. |

Snapshot data 246 may further include intersection snapshot data that provides information about a vehicle as it traverses an intersection. Intersection snapshot data is collected as frequently as the user indicates in an input configuration file for the specified nodes. Table 21 provides a sample list of intersection snapshot record fields. Table 21. Intersection snapshot data record fields.

TABLE 21
Intersection snapshot data record fields.

| Field | Interpretation |
|---|---|
| VEHICLE | The vehicle ID. |
| TIME | The current time (seconds from the midnight). |
| NODE | The node ID where the vehicle is located. |
| LINK | The link ID from which the vehicle entered. |
| LANE | The number of the lane from which the vehicle entered. |
| QINDEX | The vehicle position in the intersection buffer. |

Snapshot data 246 may further include traffic control snapshot data that reports the current state of the traffic signal at a node. Traffic control snapshot data is collected as frequently as the user indicates in an input configuration file for the specified nodes. Table 22 provides a sample list of traffic control snapshot record fields. Table 22. Traffic control snapshot data record fields.

TABLE 22
Traffic control snapshot data record fields.

| Field | Interpretation |
|---|---|
| NODE | The node ID, where the signal is located. |
| TIME | The current time (seconds from midnight). |
| LINK | The link ID entering the signal. |
| LANE | Number of the lane entering the signal. |
| SIGNAL | The type of control present: |
| | 0 = None |
| | 1 = Stop |
| | 2 = Yield |
| | 3 = Wait |
| | 4 = Caution |
| | 5 = Permitted |
| | 6 = Protected |
| | 7 = Permitted after stop |

Summary data 248 is an aggregation of data about the simulation. Summary data 248 is sampled, accumulated, and reported periodically throughout the simulation. The first record in each summary data file contains metadata information about the parameters used in data collection. The metadata record may begin with the keyword METADATA, followed by the date on which the file was created. Other items in the metadata record follow in the form of keyword-value pairs.

Summary data 248 includes link travel times summary data which reports vehicle counts and travel times on links accumulated as vehicles exit the links. This data is collected as frequently as the user indicates in an input configuration file for the specified links. There may be separate data records for each turning movement leaving each lane on the link. Table 23 lists link travel times summary field records.

TABLE 23
Link travel times summary data field records.

| Field | Interpretation |
|---|---|
| LINK | The link ID being reported. |
| NODE | The node ID from which the vehicles were traveling |
| | away. |
| TIME | The current time (seconds from midnight). |
| COUNT | The number of vehicles leaving the link. |
| SUM | The sum of the vehicle travel times (in seconds) for |
| | vehicles leaving the link. (The time spent in the |
| | previous intersection is included in this value.) |
| SUMSQUARES | The sum of the vehicle travel time squared |
| | (in seconds squared) for vehicles leaving the link. |
| | (The time spent in the previous intersection is |
| | included in this value.) |
| TURN | The type of turn the vehicle made when leaving the |
| | link: |
| | 0 = straight direction (no turn) |
| | 1 = right turn |
| | −1 = left turn |
| | 2 = hard right turn |
| | −2 = hard left turn |
| | values 3 to 6 represent increasingly more extreme |
| | right turns |
| | values −3 to −6 represent increasingly more |
| | extreme left turns |
| | −7 = reverse direction (U-turn) |
| LANE | The lane number. |
| VCOUNT | The number of vehicles on the link. |
| VSUM | The sum of vehicle velocities (in meters per second) |
| | on the link. |
| VSUMSQUARES | The sum of the squares of the vehicle |
| | velocities (in meters squared per |
| | second squared). |

The summary data 248 further includes link density summary data that reports vehicle counts and velocities within “boxes” that partition the link. The link density summary data is collected as frequently as the user indicates in an input configuration file for the specified links. There are separate data records for each lane on the link. The box length is specified in an input configuration file. Table 24 lists link densities summary record fields.

TABLE 24
Link densities summary data record fields.

| Field | Interpretation |
|---|---|
| LINK | The link ID being reported. |
| NODE | The node ID from which the vehicles were traveling |
| | away. |
| DISTANCE | The ending distance of the box (in meters) |
| | from the setback of the node from |
| | which the vehicles were traveling away. |
| TIME | The current time (seconds from midnight). |
| COUNT | The number of vehicles in the box. |
| SUM | The sum of the vehicle velocities (in meters per |
| | second) in the box. |
| SUMSQUARES | The sum of the squares of the vehicle |
| | velocities (in meters squared per second squared). |
| LANE | The lane number. |

The summary data 248 may further include link velocity summary data that reports histograms of vehicle velocities within “boxes” that partition the link. The link velocity summary data is collected as frequently as the user indicates in an input configuration file for the specified links. The input configuration file specifies the box length, number of histogram bins, and maximum velocity. The maximum velocity is typically 37.5 m/s and the velocity range is divided into five bins, in addition to an overflow bin that extends to infinity. Histogram intervals are defined to be closed at the lower end of the bin and open at the upper end. Table 25 lists link velocities summary data record fields.

TABLE 25
Link velocities summary data record fields.

| Field | Interpretation |
|---|---|
| LINK | The link ID being reported. |
| NODE | The node ID from which the vehicles were traveling away. |
| DISTANCE | The ending distance of the box (in meters) from the |
| | setback of the node from which the vehicles were |
| | traveling away. |
| TIME | The current time (seconds from midnight). |
| COUNT0 | The number of vehicles with velocities in the range [0, 7.5). |
| COUNT1 | The number of vehicles with velocities in the range [7.5, |
| | 15). |
| COUNT2 | The number of vehicles with velocities in the range [15, |
| | 22.5). |
| COUNT3 | The number of vehicles with velocities in the range [22.5, |
| | 30). |
| COUNT4 | The number of vehicles with velocities in the range [30, |
| | 37.5). |
| COUNT5 | The number of vehicles with velocities in the range [37.5, |
| | infinity). |

The summary data 248 may include link energy summary data that report histograms of vehicle energies, integrated power, accumulated as vehicles enter the links. Energy is defined as the sum of the vehicle's power over each timestep, where power is defined as the velocity times the acceleration when the acceleration is greater than zero. Vehicles are assumed to have zero power while they are at intersections. The units for energy are cells-squared per second-squared. The link energy summary data is collected as frequently as the analyst indicates in an input configuration file for the specified links. Histogram intervals are defined to be closed at the lower end of the bin and open at the upper end. Table 26 lists link energy summary record fields.

TABLE 26
Link energy summary data record fields.

| Field | Interpretation |
|---|---|
| LINK | The link ID being reported. |
| NODE | The node ID from which the vehicles were traveling away. |
| TIME | The current time (seconds from midnight). |
| ENERGY0 | The number of vehicles with integrated power in the range |
| | [0, energy_maximum/number_bins). |
| ENERGY1 | The number of vehicles with integrated power in the second |
| | bin. |
| ENERGY2 | The number of vehicles with integrated power in the third |
| | bin. |
| ENERGYn | The number of vehicles with integrated power in the range |
| | [energy_maximum, infinity). |

A variety of output filtering capabilities have been designed to limit potentially voluminous output to only those items of interest in a particular simulation run. An unlimited number of output specifications may be included in an simulation configuration file, allowing for very fine-grained control of the output produced. Time-based filtering may be used to restrict data collection to a subset of the total run time by specifying starting and ending times. The user specifies in an input configuration file the frequency of reporting for evolution and summary data 248 and the sampling frequency for summary data 248. Collected data may be restricted to a subset of nodes and links in the road network. Regional filtering allows the specification of the corners of a rectangular region in which data should be collected.

Simulation output data 242 may be filtered by value, with only those items that pass all filters appearing in the output. The supported operators for value filtering are indicated in Table 27. Data fields in a record may be suppressed, resulting in shorter records.

TABLE 27
Value filtering operators.

| Operators | Interpretation |
|---|---|
| == | equal to |
| != | not equal to |
| < | less than |
| <= | less than or equal to |
| > | greater than |
| >= | greater than or equal to |
| % | an integer multiple of |
| !% | not an integer multiple of |
| @ | included in the list (a list is a string of values starting with the |
| | left-bracket character ([), ending with the right-bracket |
| | character (]), and where each value is separated by the pipe |
| | character (\|)) |
| !@ | not included in the list |
| & | has set bits |
| !& | has cleared bits |

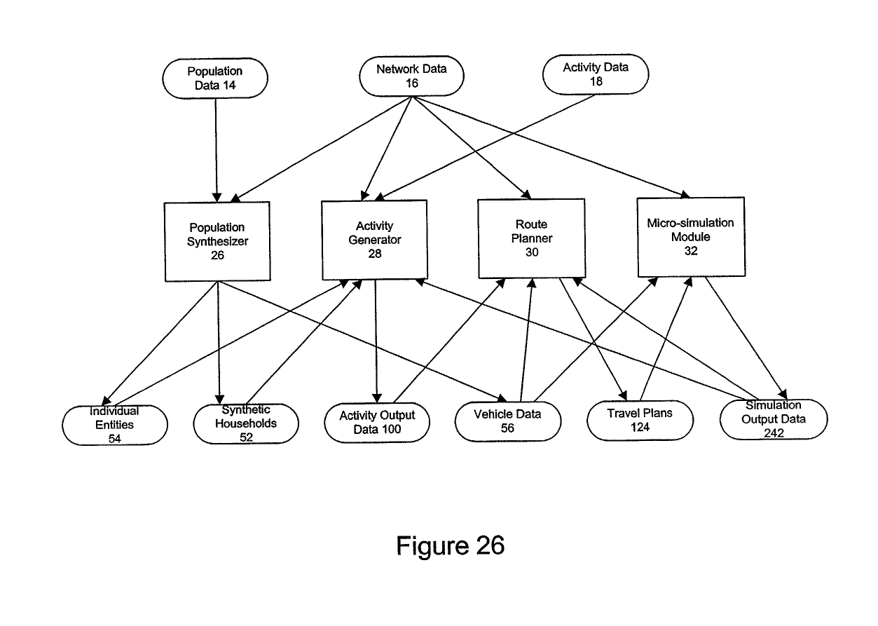

Referring to FIG. 26, a block diagram is shown illustrating data flows relative to the population synthesizer 26, activity generator 28, route planner 30, and micro-simulation module 32. The data flow from one module to another is enabled by the framework and selector module 50 (not shown). Each module depends on external data, which is shown along the top row. Data produced by the modules, shown along the bottom row of the diagram, are used as input to other modules. To develop transportation-specific models the framework and the selector modules 50 use the control and flow of information from one module to another.

The data produced by the modules may be used as feedback. Feedback enables the overall computational system to reflect “learned” behavior within the simulated population represented. Feedback involves biased selection, wherein a subpopulation may be defined based on any static or dynamic information about travelers. Feedback further involves updating entities to revise the selected subpopulation's use of the transportation system by controlling the quality of information about the system available to them.

The information about entities consists of the entity-specific data contained in individual entities 54, synthetic households 52, vehicle data 56, activity output data 100, travel plans 124, and simulation output data 242. This data is generated under specific hypotheses about the transportation network. By carefully controlling the hypotheses, the system 10 can be used to bias entities toward certain choices.

A typical simulation study involves repeated iteration between modules. Thus, there is no standard iteration script because different study designs involve different iteration schemes. One important example of feedback is in solving the traffic assignment problem. The simplest version of this uses a loop between the route planner 30 and the micro-simulation module 32.

On the first pass of the route planner 30, routes are chosen under the hypothesis that travel time is well represented by free speeds on the network, i.e., that entities do not interact. Correction for entity interactions can be applied simply by making available to the route planner 30 information about actual travel times produced by the micro-simulation module 32. With this information, the route planner 30 chooses different routes for most entities, resulting in different travel times. In this case, updating entities is accomplished by re-running the route planner 30 with an updated travel time table.

There are a wide range of different feedback schemes for this problem which depend on a selection process which determines exactly which entities are to be run through the route planner 30 with updated travel time information. One selection process is to choose a certain fraction of entities uniformly at random. The framework and selector module 50 supports much more sophisticated processes. For example, a user may select only entities with automobile drives of an hour or more who cross a geographic feature.

There are many more information flows in the system 10 than just a travel time table. Every module can be used to update only a selected subpopulation using information provided by the framework and selector module 50. In effect, this is similar to providing a separate model for every conceivable subdivision of the population without the need for fitting each model separately.

For example, work location is chosen using a single simple model for the entire population. In this example, entities who commute by bus across a river are poorly assigned work locations. Selecting that subpopulation and running the work location assignment model with slightly different input information can change the poorly selected locations for that subpopulation with no change in the model itself.

A single entity may be included in two subpopulations. For example, the entity may be included in a previous subpopulation and the subpopulation assigned to households larger than five people who also have longer than average commutes. However, no sophisticated correlation structure needs to be built into the model to handle such cases correctly.

Selection is based on both absolute criteria such as an entity's mode, and on relative criteria such as the duration of a trip compared to the duration of all other trips in the subpopulation picked out by the absolute criteria. The relative criteria act as user-specified cost functions. Thus, a user may select the ten percent of entities meeting some absolute criteria who have the longest actual travel time compared with their expected travel time.

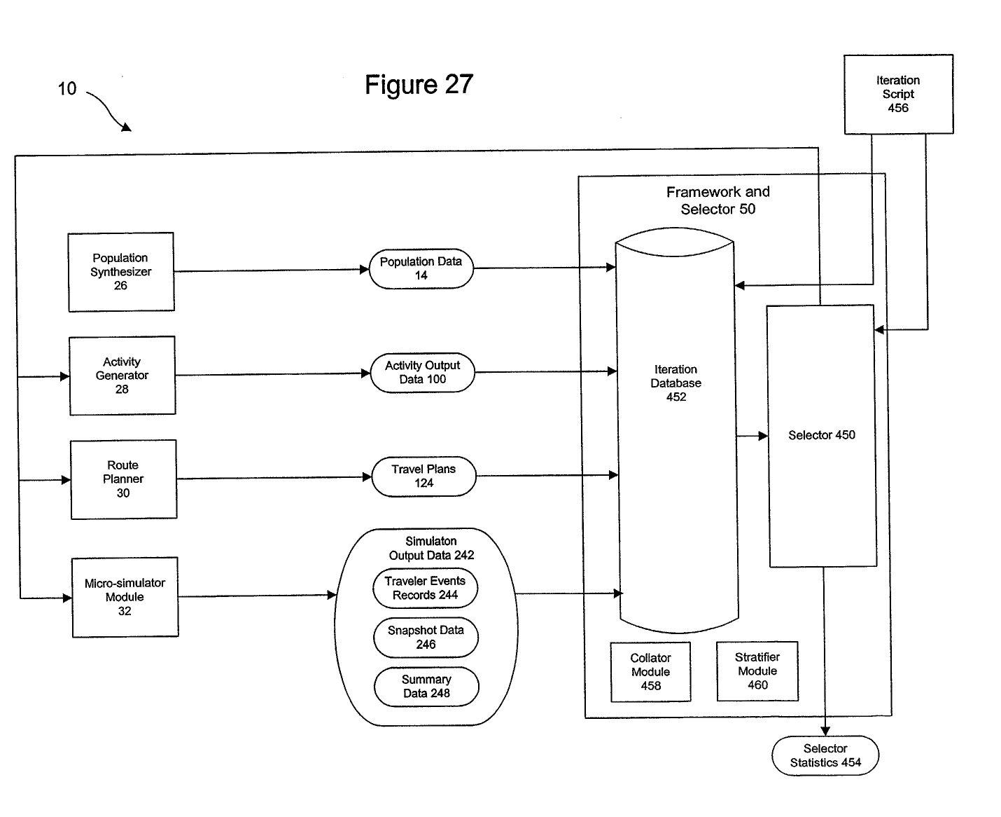

Referring to FIG. 27, a block diagram illustrates interaction of a selector 450 and an iteration database 452 which are subcomponents of the framework and selector module 50. The iteration database 452 is an archive of information about individual entities across iterations. The selector 450 uses this information to make selection decisions. The data contained in the iteration database 452 may be chosen by the user from the fields of the population data 14, activity output data 100, travel plans 124, and simulation output data 242.

For example, the data may include income, travel mode preference, or an expected duration of a trip. The iteration database 452 may also include data extracted from the simulation output data 242 such as the actual duration of a trip. The iteration database 452 may also contain data that is deduced from the travel plans 124 and the simulation output data 242. For example, the data may include the duration of a trip relative to the trip's expected duration.

The selector and iteration database 450, 452 maintain internal consistency among the various modules and serve as the primary modeling tool. The selector and iteration database 450, 452 achieve an agreement among the travel demands expressed in the activity output data 100, the travel plans 124, and execution of the travel plans 124 by the micro-simulation module 32.

The architecture of the system 10 employs an iterative feedback process that is a natural way to tailor models of activity locations, mode selections, route planning, etc. to specific, possibly overlapping, sub-populations. Feedback enables the overall computational system to reflect “learned” behavior within the simulated population represented. The iterative feedback process of the present invention employs a biased selection process that defines a sub-population based on any static or dynamic information about individual entities. The iterative feedback process further updates individual entities thereby revising the selected sub-population's use of the transportation network and controlling the quality of information about the network available to the subpopulation.

The information available to the system 10 consists of the individual entity 54 specific data contained in network data 16, population data 14, activity output data 100, travel plans 124, vehicle data 56, and simulation output data 242. These data are all generated by the system 10 under specific hypotheses about the transportation network. By carefully controlling the hypotheses, the system 10 can be used to steer travelers toward certain choices.

To overcome the computational difficulties of iteration, the modeling of the of individual entities' interactions may be simplified within the transportation network. Nevertheless, the system 10 produces appropriate dynamic behavior of the transportation network as a whole. For example, the micro-simulation module 32 may rely upon quick-running, simple models in which vehicles move along a roadway to generate realistic traffic flow and congestion.

The activity generator 28 may select the nearest location for an individual entity's activity. The route planner 30 may determine the travel modes and routes that are the shortest or quickest between locations. Simplified models minimize the iterations required to attain consistent travel times between the planning models and the simulation.

Users can prepare an iteration script 456 to control the entire iteration process. The iteration script 456 uses special control commands specifically developed for the iteration of the modules. The script 456 enables a user to filter results, run repeated iterations, establish stopping criteria, and perform a host of other operations that make the analyst's job less labor intensive.

During each iteration, the iteration script 456 controlling the current study invokes the selector and iteration database 450, 452. The iteration database 452 accumulates output data from each of the modules. When the selector 450 runs, it reads information about the individual entities 54 from the iteration database 452. The selector 450 then examines each entity and decides whether to regenerate the entity's activities using the activity generator 28.

Regeneration of activities requires generation of routes by the route planner 30. The selector 450 further determines whether regeneration of new routes between existing activities by the route planner 30 is needed. The selector 450 may decide to retain the existing activities and the planned routes between the activities. Based on the selections, the selector 450 decides whether a new simulation must be run for the entities. If so, then the selector 450 so instructs the micro-simulation module 32.

The selector 450 then writes selections made for each entity into data files that are sent to the activity regenerator 122 and the route planner 30. The activity regenerator 122 and the route planner 30 execute the selections.

The population data 14, activity output data 100, travel plans 124, and simulation output data 242 may be used to fill in fields of the iteration database 452. For example, after running the population synthesizer 26, demographic information can be collected and after running the route planner 30, expected travel times can be collected. The framework and selector module 50 may include a collator module 458 that is run after each module. The collator module 458 fills in fields in the iteration database 452 that depend on that module with the most recent data available.

The collator module 458 gathers data from disparate sources, such as activity output data 100, travel plans 124, and traveler events records, into a single table keyed by traveler identification and trip number. The user may specify which data is to be collected using configuration file keys. The collator module 458 may also accumulate data over an entire trip and provide some commonly used processing algorithms described below.

In one embodiment, each record of the iteration database 452 may include identifying information such as household identification, entity identification, an integer identifying which home tour a trip belongs to, an integer identifying which round trip from a non-home anchor location a trip belongs to, a trip identification integer, an identification of the starting activity location for a trip, and an identification of the ending location for a trip. This arrangement facilitates use of familiar statistical analysis tools on the data. For example, a simple text processing tool might be used to create a single record for each tour an entity makes. Similarly, a user may wish to extract the total travel time for each entity on each iteration and build a cross-iteration database.

The framework and selector module 50 may further include a stratifier module 460 that uses a combination of built-in algorithms on the data contained in the iteration database 452 to stratify or classify trips. Classification of trips is stored in the iteration database 452 as indexes into a set of n-way user-specified tables.

The stratifier module 460 specifies a stratification by defining a binning, for each variable. Each binning is given a user-defined name using a configuration file key. Raw or processed data fields in the iteration database 452 can be binned. The boundaries of the bins may be determined automatically if the user specifies or the boundaries may be specified explicitly by the user.

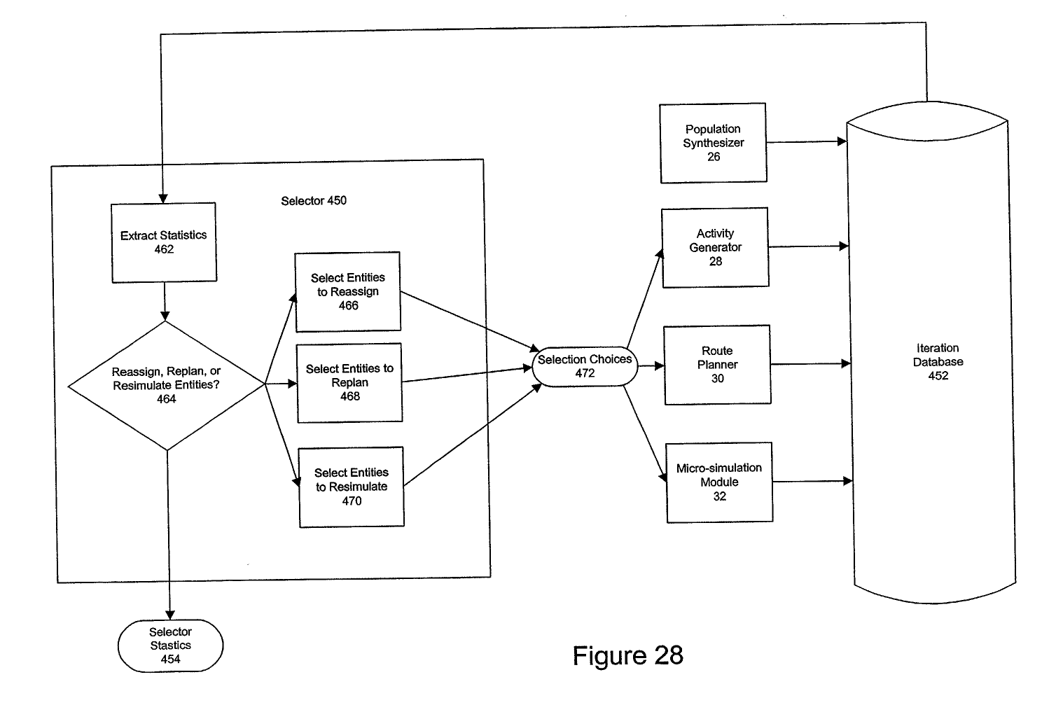

Referring to FIG. 28, a block diagram illustrating the selection process and interaction of the selector 450 and the iteration database 452 is shown. The modules 26, 28, 30, 32 each send their respective outputs to the iteration database 452. The iteration database 452 receives and stores the outputs as updates. The selector 450 extracts 462 statistics reflecting outputs from the iteration database 452. From the statistics, the selector 450 decides how to proceed with the next iteration.

The selector 450 decides 464 whether to reassign activities to entities, replan travel routes, and/or resimulate entities. Based on these decisions, the selector 450 may then select 466 entities to reassign activities to, select 468 entities to replan routes, and/or select 470 entities to resimulate. The selector 450 then generates and sends the selection choices 472 to the appropriate modules 28, 30, 32.

After the selector 450 completes the selection process for all entities, the activity generator 28, the route planner 30, and/or the micro-simulation module 32 run to calculate the updated activity output data 100, travel plans 124, or simulation output data 242 respectively. The iteration script 456, shown in FIG. 27, invokes the selector 450 again at the start of the next iteration in the study.

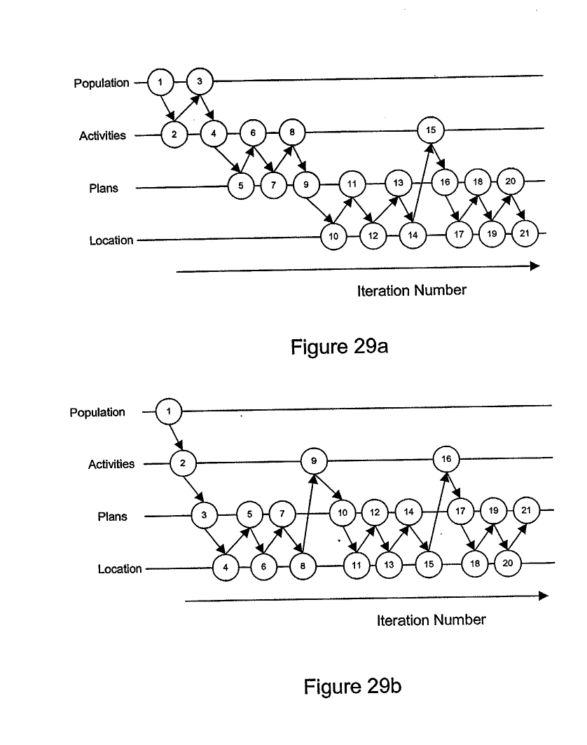

Referring to FIGS. 29a and 29b, the depicted graphs illustrate examples of possible progressions determined by the selector 450. The progressions illustrated are for exemplary purposes only and one of skill in the art will appreciate that the exact order and number of progressions will vary depending on each study performed.

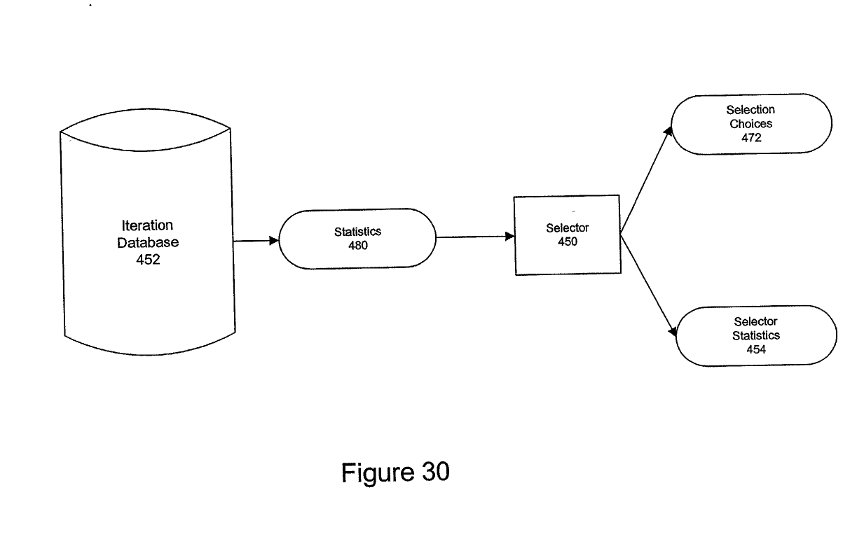

Referring to FIG. 30, a block diagram illustrating the data flows into and out of the selector 450 is shown. The selector 450 extracts statistics 480 collected over iterations from the iteration database 452. The statistics 480 included records of entity iterations within a study, entity attributes representing quasi-static information, expectations encompassing planned activities, routes, and times, and experiences including information extracted from detailed simulation output data 242. Furthermore, the statistics 480 may be customized by a user for a particular study.

The selector 450 uses the statistics 480 to make selection decisions. In performing a simulation, a user may choose the statistics 480 from the individual entities 54, activity output data 100, and travel plans 124. By way of example, a user may choose income, travel mode preference, or the expected duration of a trip. A user may choose statistics 480 extracted from the simulation output data 242 such as the actual duration of a trip.

The selector 450 outputs selector statistics 454 and selection choices 472. The selection choices 472 list the individual entities 54 that will be reassigned activities 466, and re-planned routes 468. The selection choices 472 embody the selector's 450 detailed decisions. The selector statistics 454 provide a basic summary of the choices a selector 450 makes. The selector statistics 454 include how many entities are re-planned 468, distributions of the difference between expected travel times, and experienced travel times for various traveler populations.

The flexibility of the framework and selector module 50 allows for countless variations in the iteration process. For example, in some studies, the selector 450 may run after the activity generator 28 or route planner 30 completes its execution. Thus, the selector 450 decides which of the generated activities or plans will be accepted for entities. Activites or plans not accepted are discarded and new activities or plans are produced.

The iteration script 456 may be configured to determine which version of the activity generator 28, route planner 30, or micro-simulation module 32 runs during the present iteration. The iteration script 456 may further allow for the adjustment of transit schedules or the number of vehicles in a transit fleet. The adjustment of network characteristics, such as traffic signal timing, congestion pricing, or roadway information signs may further be enabled by the iteration script 456. The iteration script 456 may enable certain entities to receive data from information systems regarding the status of network congestion. The iteration script 456 may further determine whether to complete the study because the iterations have converged or diverged sufficiently.

The system 10 of the present invention is an extremely scalable micro-simulation based representation of population movements. Metropolitan areas with millions of person trips each day with millions of nodes and links can be analyzed by the system 10. In addition, the system 10 provides detail of representation of individual entities. The system 10 successfully incorporates models, algorithms and complexity theory bounds for routing in time-dependent, multi-modal, multi-labeled transportation networks. The system 10 uses discrete space-time models such as cellular automata for modeling and efficient microscopic simulation of travel dynamics. The system 10 further relies upon iterated feedback mechanisms for route/mode/activity—selection and efficient information feedback.

In addition to population movement, the system 10 has application to various simulation-based analysis. For example, the system 10 may be used for next generation hybrid and ad-hoc communication and computation systems. As such, wireless communication activity surveys may be inputted to derive wireless traffic patterns by location and time. The system 10 may further be used for simulation-based analysis for study of the spread of contagious diseases. Disease incubation and spread data and models may be inputted to simulate a predicted spread. The system 10 may also be used for environmental impact of transportation system changes. Pollution survey and predicted pollution generation of changes may be added to the input to simulate environmental impact.

In an alternative embodiment, the system 10 may be configured to generate multiple synthetic populations. Each entity of a population set may be interconnected with one or more entities of another population set to form interrelated entities. The interrelated entities move through time and space in the network relative to one another. Entities in a first population set may be defined by a vector which includes several entity attributes. One attribute is the entity identification which remains unchanged during the simulation. However, other attributes such as home location, income, family unit, location, gender, and so forth may be altered.

An entity so defined in the first population set, such as a human person, may be interrelated or otherwise coupled to an entity in a second population set. For example, the second population set may be cellular telephones. Each cellular telephone entity may be defined by a vector defining entity attributes such as identification, initial purchase price, power transmission capability, and so forth.

By coupling entities of different population sets, the system 10 simulates layers of interdependent populations. Entities of one population set may be dependent on another population set for movement in space. Cellular telephone entities rely upon human entities for transportation.

A population set may not include tangible entities. For example, although a health record may be listed as an attribute in a human entity vector, a health record may be an entity in a health record population. Each health record entity may couple directly to a corresponding human entity. As such, health record entity movements in a network may depend directly on movement of the corresponding human entity.

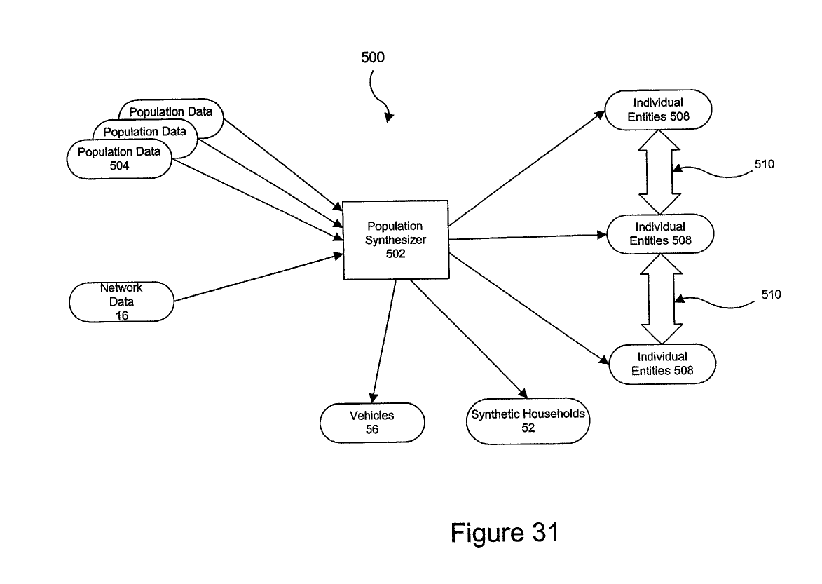

Referring to FIG. 31, a block diagram of an alternative embodiment of a system 500 that links interdependent populations is shown. As in the previous system 10, a population synthesizer 502 receives aggregated data. The aggregated data is disaggregated into a synthetic population which is statistically equal to the aggregated data. A disaggregated synthetic population enables interactions between the synthetic entities to generate a realistic simulation.

The population synthesizer 502 receives aggregated population data 504 representing a population set. The population synthesizer 502 may further receive aggregated population data 504 representing additional population sets. Each population set may represent different types of entities. The population synthesizer 502 further receives network data 16 representative of a transportation network.

The population synthesizer 502 generates disaggregated data in the form of sets of individual entities 508. The population synthesizer 502 further forms relationships 510 between the individual entities 508. The relationships 510 are formed between two or more entities 508 of population sets. Thus, entities 508 of a first population set are coupled to entities 508 of a second population set. The coupling may represent entire dependency of entities 508 of a second population set upon entities 508 of a first population set. For example, objects that are owned or moved by sentient owners are dependent. Furthermore, parasitic entities such as a virus are dependent on a host for movement and survival. Alternatively, coupling may represent interdependency between entities 508 of different population sets. For example, human entities and animal entities may form an interdependent relationship wherein they rely upon one another.

Each entity 508, however, is not necessarily coupled to an entity 508 of another population set. For example, not every human entity owns a cellular telephone. Furthermore, an entity 508 of a first population set may be coupled to a plurality of entities 508 of a second population set. Once again, by way of example, a human entity may own more than one cellular phone. An entity 508 may also be coupled to exactly one corresponding entity 508 in another population set. For example, a human entity may be coupled to a corresponding health record.

Individual entities 508, such as human entities, animals, objects, etc may be assigned to synthetic households 52. The assignment to a household 52 does not in itself generate couplings between entities, but does form an association. The association may generate interactions betweens entities in the association.

The population synthesizer 502 may further generate vehicle data 56 such as that previously described. Vehicle data 56 provides information regarding mode of transportation, starting location, and association with a human entity or household. Vehicles may alternatively be provided to the population synthesizer 502 as aggregated population data 504. Vehicles may then be outputted as individual entities 508 and coupled to human entities rather than being produced as vehicle data 56. Such coupling is advantageous if vehicle movement is to be simulated.

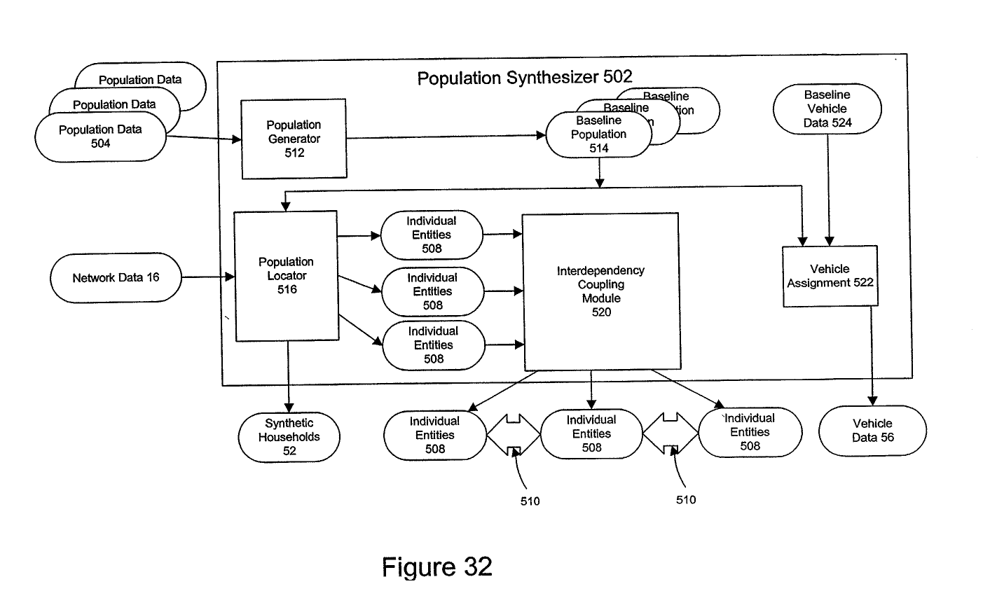

Referring to FIG. 32, a data flow diagram is shown that illustrates data output generated by the population synthesizer 502. The population synthesizer 502 includes a population generator 512 that receives sets of population data 504 and generates disaggregated baseline populations 514. The population generator 512 may generate the different sets of baseline populations 514 in a manner similar to that described in reference to FIG. 6. Thus, the population generator 512 may use IPF to fit block group summaries to cross-classified values in the aggregated data. The population generator 512 may use a two-step procedure to modify the IPF routine so that the generator 512 can simultaneously consider all block groups.

The population synthesizer 502 further includes a population locator 516 that receives the sets of baseline population 514 and network data 16. From the network data 16, the population locator 516 locates the synthetic households 52 at activity locations on the network using land use data. The population generator 512 generates sets of individual entities 508 corresponding to each baseline population set 514 on the network.

The sets of individual entities 508 are sent to an interdependency coupling module 520 that creates relationships 510 between individual entities 508 in different population sets. The forming of relationships 510 are designed to be statistically accurate. In so doing, ownership or other form of dominance may be indicated in the relationship 510. Thus, an entity 508 may be subservient or dependent upon another entity 508 for mobility.

The population synthesizer 502 further includes a vehicle assignment module 522 that receives a set of baseline population 514 and baseline vehicle data 524. A specific set of baseline population 514 may be indicated as a dominant population 514 that would be assigned vehicles. The vehicle assignment module 522 assigns vehicle types to each vehicle in the dominant population. The vehicle assignment module 522 generates the vehicle data 56 that is associated with the household data 52 and individual entities 508.

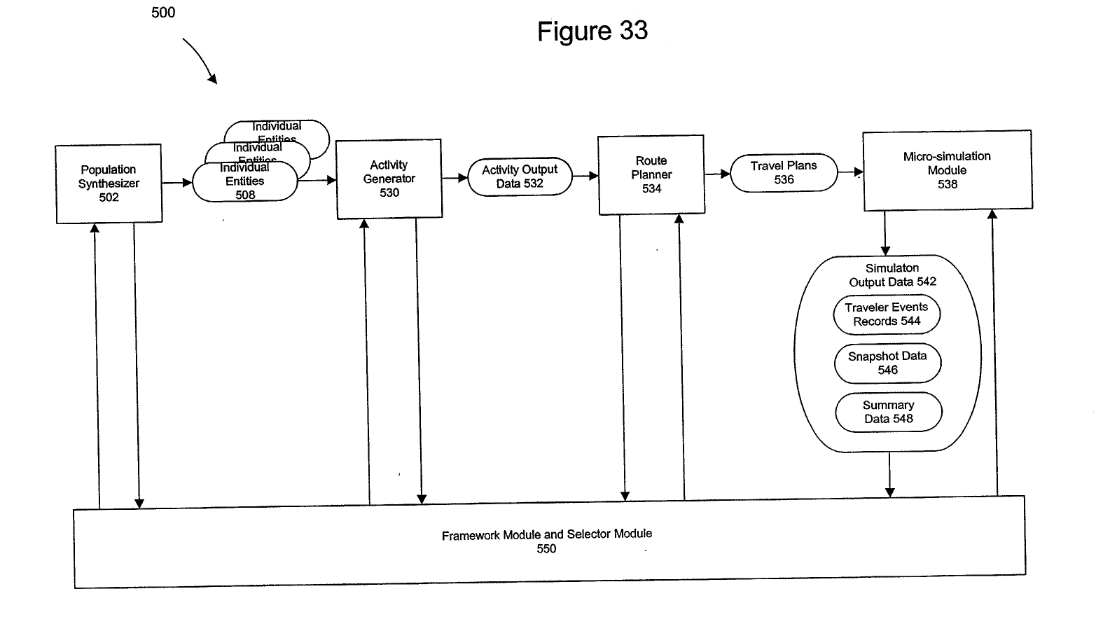

Referring to FIG. 33, a block diagram illustrating the various modules of the system 500 is shown. The population synthesizer 502 sends individual entities 508 for two or more population sets to an activity generator 530. The individual entities 508 have interdependent relationships with other entities 508 from different population sets.

An activity generator 530 generates activity output data 532 for each individual entity 508 in each population set in a manner similar to that previously described. The activity generator 530 considers the relationships between entities 508 in generating the activity output data 532. Thus, activities of a dependent entity 508 may be determined by a related entity 508.

The activity output data 532 is sent to a route planner 534. Similar to that described above, the route planner 534 generates travel plans 536 for each entity 508. The travel plans 536 satisfy the activities and intent of an entity 508 within the constraints of a network represented by the network data 16. The travel plans 536 for an inanimate object entity 508 may entirely depend upon a human entity owner.

A micro-simulation module 538 simulates entity interactions in time and space and casualty interactions. The entity interactions may be between entities 508 within the same population set or a different population set. The micro-simulation module 538 operates as discussed in the previous embodiment with the increased dimensionality of relationships between entities 508. The micro-simulation module 538 creates simulation output data 542 including traveler events records 544, snapshot data 546, and summary data 548. The simulation output data 542 is similar to that of the previously discussed embodiment.

A framework and a selector module 550, similar to that previously discussed, in that it receive outputs from the modules and uses the output to re-plan activities and travel times for entities 508. The system 500 then runs the simulation again. As before, iterations may be performed repeatedly until the travel plans 536 and simulated travel do not change significantly between runs.

The present invention analyzes a network by simulating movement and interdependent relationships between entities in the network. A population synthesizer processes aggregated information to generate a synthetic population representative of individual entities in a statistically valid way. The population synthesizer further forms interdependent relationships between entities of different population sets. An activity generator generates typical activities for the synthetic population and creates activity output data having household and individual activities. A route planner receives the activity output data and generates travel plans by searching the network to find optimal travel modes and routes. A micro-simulation module simulates the movement of the individual entities and follows each entity's travel plans throughout the transportation network. The system may simulate vehicles and the traveling and driving behavior of entities in the transportation network.

The framework and selector modules 550 receive outputs from the modules of the system and generate feedback to improve the simulation process by re-generating the activities and routes. The system may run the simulation repeatedly and improve the results through the use of feedback. The system may operate in parallel using multiple processors to manage the modules and database.

The present invention provides new ways of measuring the effectiveness of transportation system changes. The present invention may be used for simulation and analysis of metropolitan areas as well as networks of various sizes. The present invention simulates the interaction between entities having interdependent relationships and produces realistic movement dynamics. A user may then perform a variety of analyses such as reviewing the overall performance of a transportation network, the effective movement of specific entities or sub-populations, the movement of entities dependent on entities of a different population set, and other analyses as determined by a user.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A system for simulating movement of entities within a network, the system comprising:
a processor for executing instructions; and
a memory device in communication with the processor and storing modules executable by the processor, the modules comprising:
a population synthesizer to receive aggregated population data representative of first and second population sets, to generate disaggregated entities for each population set, and to form relationships between first entities associated with the first population set and second entities associated with the second population set;
an activity generator for receiving the entities and generating activities located in the network for each entity;
a route planner for receiving the activities and generating travel plans for each entity for travel within the network; and
a micro-simulation module for simulating movement of each entity within the network and generating simulation output data.

2. The system of claim 1, wherein the first entities are representative of humans and the second entities are representative of non-humans.

3. The system of claim 1, wherein the second entities are dependent upon the first entities for movement.

4. The system of claim 1, wherein the population synthesizer comprises a population generator to receive the aggregated population data and generate first and second baseline populations corresponding to the first and second population sets respectively.

5. The system of claim 4, wherein the population synthesizer further comprises a population locator to receive network data representative of the network and the first and second baseline populations and place first and second entities within the network.

6. The system of claim 4, wherein the population synthesizer further comprises a vehicle assignment module to receive the baseline populations and baseline vehicle data and generate vehicle data.

7. The system of claim 4, wherein the population synthesizer further comprises an interdependency coupling module to receive the entities and form relationships between first and second entities.

8. The system of claim 1, wherein the activity generator comprises an activity patterns module to receive aggregated activity data and to generate activity patterns.

9. The system of claim 8, wherein the activity generator further comprises a matching module to receive the entities, the activity patterns, and households, and match the activity patterns and entities to households.

10. The system of claim 9, wherein the activity generator further comprises an activity location generator to generate locations in the network for activities.

11. The system of claim 1 0, wherein the location generator comprises:
a discrete choice module to select locations for primary activities in the network;
and
a trip-chaining module to select locations for remaining activities in the network.

12. The system of claim 9, wherein the activity generator further comprises a make household file module to create a set of household files containing the households.

13. The system of claim 9, wherein the activity generator further comprises an activity regenerator module to partially modify existing activities and generate new activities for households.

14. The system of claim 1, wherein the route planner comprises an internal planner network module to receive network data and to construct an internal network.

15. The system of claim 14, wherein the route planner further comprises a requests module to receive activities and travel times and to generate trip requests.

16. The system of claim 15 wherein the trip requests include a source activity location, a destination activity location, and allowed travel modes.

17. The system of claim 15, wherein the route planner further comprises a paths module in communication with the internal planner network module and the requests module, the paths module configured to review trip requests from the requests module and generate travel plans for each entity.

18. The system of claim 17, wherein the route planner further comprises a retimes module to review and update the duration of travel plans.

19. The system of claim 15, wherein the route planner is configured to recognize activities that generate an anomaly in the travel plans.

20. The system of claim 1, wherein the micro-simulation module includes an output module that collects and stores simulation output data.

21. The system of claim 1, wherein the simulation output data includes traveler event records, snapshot data, and summary data.

22. The system of claim 1, wherein the micro-simulation module is configured to perform a cellular automata process, comprising:
dividing the network into a plurality of cells;
examining cells for vehicle occupancy;
determining whether to accelerate or de-accelerate a vehicle; and
advancing vehicles to adjacent cells.

23. The system of claim 1, wherein the micro-simulation module is configured to perform a method during a discrete time step, comprising:
updating traffic signals;
preparing nodes in the network;
moving vehicles to adjacent lanes;
moving transit vehicles to stops;
moving transit vehicles from stops; and
cleaning up nodes in the network.

24. The system of claim 1, wherein the modules further comprise a framework module and a selector module to receive the activities, travel plans, and simulation output data and generate selections for the activity generator, route planner, and micro-simulation module.

25. The system of claim 24, wherein the selector module comprises:
an iteration database containing iteration data including activities, travel plans, and simulation output data from a plurality of iterations; and
a selector, in communication with the iteration database, and configured to make selections responsive to the iteration data.

26. The system of claim 25, further comprising an iteration script for invoking the selector and iteration database.

27. A computer readable medium having stored thereon computer executable instructions for performing a method for simulating movement of entities within a network, the method comprising:
receiving aggregated population data representative of first and second population sets;
generating disaggregated first entities associated with the first population set and disaggregated second entities associated with the second population set;
forming relationships between the first and second entities;
generating activities located in the network for each entity;
generating travel plans for each entity for travel within the network;
simulating movement of each entity within the network; and
generating simulation output data.

28. The computer readable medium of claim 27 wherein the first entities are representative of humans and the second entities are representative of non-humans.

29. The computer readable medium of claim 27 wherein the second entities are dependent upon the first entities for movement.

30. The computer readable medium of claim 27, wherein the method further comprises generating first and second baseline populations corresponding to the first and second population sets respectively.

31. The computer readable medium of claim 30, wherein the method further comprises:
receiving network data representative of the network; and
placing entities within the network based on the network data and the first and second baseline populations.

32. The computer readable medium of claim 30, wherein the method further comprises generating vehicle data based on baseline populations and baseline vehicle data.

33. The computer readable medium of claim 27, wherein the method further comprises:
receiving aggregated activity data; and
generating activity patterns based on the aggregated activity data.

34. The computer readable medium of claim 33, wherein the method further comprises:
receiving synthetic households; and
matching the activity patterns and entities to the synthetic households.

35. The computer readable medium of claim 33, wherein the method further comprises generating locations in the network for the activities.

36. The computer readable medium of claim 34, wherein the method further comprises:
partially modifying existing activities; and
generating new activities for the synthetic households.

37. The computer readable medium of claim 27, wherein the method further comprises:
receiving network data; and
constructing an internal network based on the network data.

38. The computer readable medium of claim 27, wherein the method further comprises:
receiving travel times; and
generating trip requests based on the travel times.

39. The computer readable medium of claim 38, wherein the method further comprises:
reviewing trip requests; and
generating travel plans for each entity based on the trip requests.

40. The computer readable medium of claim 39, wherein the method further comprises:
reviewing the travel plans;
comparing the travel plans to actual travel durations; and
updating the duration of travel plans to reflect the actual travel plans.

41. The computer readable medium of claim 39, wherein the method further comprises recognizing activities that generate an anomaly in the travel plans.

42. The computer readable medium of claim 27, wherein the simulation output data includes traveler event records, snapshot data, and summary data.

43. The computer readable medium of claim 27, wherein the method further comprises:
dividing the network into a plurality of cells;
examining cells for vehicle occupancy;
determining whether to accelerate or de-accelerate a vehicle; and
advancing vehicles to adjacent cells.

44. The computer readable medium of claim 27, wherein the method further comprises:
updating traffic signals;
preparing nodes in the network;
moving vehicles to adjacent lanes;
moving transit vehicles to stops;
moving transit vehicles from stops; and
cleaning up nodes in the network.

45. The computer readable medium of claim 27, wherein the method further comprises generating selections for the activity generator, route planner, and micro-simulation module.

46. The computer readable medium of claim 45, wherein the method further comprises:
storing iteration data including activities, travel plans, and simulation output data from a plurality of iterations; and
generating selections responsive to the iteration data.

47. The computer readable medium of claim 27, wherein simulating movement of each entity comprises:
partitioning the network into subnetworks; and
assigning subnetworks to a plurality of processors.

48. A method for simulating movement of entities within a network, the method comprising:
receiving aggregated population data representative of first and second population sets;
generating disaggregated first entities associated with the first population set and disaggregated second entities associated with the second population set;
forming relationships between the first and second entities;
generating activities located in the network for each entity;
generating travel plans for each entity for travel within the network;
simulating movement of each entity within the network; and
generating simulation output data.

49. The method of claim 48 wherein the first entities are representative of humans and the second entities are representative of non-humans.

50. The method of claim 48 wherein the second entities are dependent upon the first entities for movement.

51. The method of claim 48, further comprising generating first and second baseline populations corresponding to the first and second population sets respectively.

52. The method of claim 51, further comprising:
receiving network data representative of the network; and
placing entities within the network based on the network data and the first and second baseline populations.

53. The method of claim 51, further comprising generating vehicle data based on baseline populations and baseline vehicle data.

54. The method of claim 51, further comprising:
receiving aggregated activity data; and
generating activity patterns based on the aggregated activity data.

55. The method of claim 54, further comprising:
receiving synthetic households; and
matching the activity patterns and entities to the synthetic households.

56. The method of claim 54, further comprising generating locations in the network for the activities.

57. The method of claim 55, further comprising:
partially modifying existing activities; and
generating new activities for synthetic households.

58. The method of claim 48, further comprising:
receiving network data; and
constructing an internal network based on the network data.

59. The method of claim 48, further comprising:
receiving travel times; and
generating trip requests based on the travel times.

60. The method of claim 59, further comprising:
reviewing trip requests; and
generating travel plans for each entity based on the trip requests.

61. The method of claim 60, further comprising:
reviewing the travel plans;
comparing the travel plans to actual travel durations; and
updating the duration of travel plans to reflect the actual travel plans.

62. The method of claim 60, further comprising recognizing activities that generate an anomaly in the travel plans.

63. The method of claim 48, wherein the simulation output data includes traveler event records, snapshot data, and summary data.

64. The method of claim 48, further comprising:
dividing the network into a plurality of cells;
examining cells for vehicle occupancy;
determining whether to accelerate or de-accelerate a vehicle; and
advancing vehicles to adjacent cells.

65. The method of claim 48, further comprising:
updating traffic signals;
preparing nodes in the network;
moving vehicles to adjacent lanes;
moving transit vehicles to stops;
moving transit vehicles from stops; and
cleaning up nodes in the network.

66. The method of claim 48, further comprising generating selections for the activity generator, route planner, and micro-simulation module.

67. The method of claim 66, further comprising:
storing iteration data including activities, travel plans, and simulation output data from a plurality of iterations; and
generating selections responsive to the iteration data.

68. The method of claim 48, wherein simulating movement of each entity comprises:
partitioning the network into subnetworks; and
assigning subnetworks to a plurality of processors.

69. A system for simulating movement of entities within a network, the system comprising:
a plurality of processors in electrical communication with one another and configured for parallel processing; and
a memory device in communication with the processors and storing modules executable by the processors, the modules comprising:
a population synthesizer to receive aggregated population data representative of first and second population sets, to generate disaggregated entities for each population set, and to form relationships between first entities associated with the first population set with second entities associated with the second population set;
an activity generator for receiving the entities and generating activities located in the network for each entity;
a route planner for receiving the activities and generating travel plans for each entity for travel within the network; and
a micro-simulation module for simulating movement of each entity within the network and generating simulation output data.

70. A system for simulating movement of entities within a network, the system comprising:
processing means; and
memory means in communication with the processing means for storing modules executable by the processing means, the modules comprising:
population synthesizer means for receiving aggregated population data representative of first and second population sets, for generating disaggregated entities for each population set, and for forming relationships between first entities associated with the first population set and second entities associated with the second population set;
activity generator means for receiving the entities and for generating activities located in the network for each entity;
route planner means for receiving the activities and for generating travel plans for each entity for travel within the network; and
micro-simulation means for simulating movement of each entity within the network and for generating simulation output data.

71. The system of claim 70, wherein the population synthesizer means comprises population generator means for receiving the aggregated population data and for generating first and second baseline populations corresponding to the first and second population sets respectively.

72. The system of claim 71, wherein the population synthesizer means further comprises population locator means for receiving network data representative of the network and the first and second baseline populations and for placing first and second entities within the network.

73. The system of claim 71, wherein the population synthesizer means further comprises vehicle assignment means for receiving the baseline populations and baseline vehicle data and for generating vehicle data.

74. The system of claim 70, wherein the population synthesizer means comprises interdependency coupling means for receiving the entities and for forming relationships between first and second entities.

75. The system of claim 70, wherein the activity generator means comprises an activity location generator means for generating locations in the network for activities.

76. The system of claim 70, wherein the activity generator means comprises activity patterns means for receiving aggregated activity data and for generating activity patterns.

77. The system of claim 76, wherein the activity generator means further comprises matching means for receiving the entities, the activity patterns, and households, and for matching the activity patterns and entities to households.

78. The system of claim 77, wherein the activity generator means further comprises activity regenerator means for modifying existing activities and for generating new activities for households.

79. The system of claim 70, wherein the route planner means comprises internal planner network means for receiving network data and for constructing an internal network.

80. The system of claim 79, wherein the route planner means further comprises requests means for receiving activities and travel times and for generating trip requests.

81. The system of claim 80, wherein the route planner means further comprises path means, in communication with the internal planner network means and the requests means, for reviewing trip requests and generating travel plans for each entity.

82. The system of claim 70, wherein the route planner means further comprises retimes means for reviewing and updating the duration of travel plans .

83. The system of claim 70, wherein the micro-simulation means includes output means for collecting and storing simulation output data.

84. The system of claim 83, wherein the simulation output data includes traveler event records, snapshot data, and summary data.

85. The system of claim 70, wherein the modules further comprise framework and selector means for receiving the activities, travel plans, and simulation output data and for generating selections for the activity generator means, route planner means, and micro-simulation means.

86. The system of claim 85, wherein the framework and selector means comprises:
iteration database means for storing iteration data including activities, travel plans, and simulation output data from a plurality of iterations; and
selector means, in communication with the iteration database means, for generating selections responsive to the iteration data.

87. A system for generating disaggregated population data from aggregated population data, the system comprising:
a processor for executing instructions; and
a memory device in communication with the processor and storing modules executable by the processor, the modules including,
a population synthesizer to receive aggregated population data representative of first and second population sets, to generate disaggregated entities for each population set, and to form relationships between first entities associated with the first population set and second entities associated with the second population set, the population synthesizer including,
a population generator to receive the aggregated population data and generate first and second baseline populations corresponding to the first and second population sets respectively,
a population locator to receive network data representative of the network and the first and second baseline populations and place first and second entities within the network, and
an interdependency coupling module to receive the entities and form relationships between the first and second entities.

88. The system of claim 87, wherein the first entities are representative of humans and the second entities are representative of non-humans.

89. The system of claim 87, wherein the second entities are dependent upon the first entities for movement.

90. The system of claim 87, wherein the population synthesizer further comprises a vehicle assignment module to receive the baseline populations and baseline vehicle data and generate vehicle data.

91. A method for generating disaggregated population data from aggregated population data, the method comprising:
receiving aggregated population data representative of first and second population sets;
generating first and second baseline populations corresponding to the first and second population sets respectively;
generating disaggregated first entities associated with the first population set and disaggregated second entities associated with the second population set;
forming relationships between the first and second entities;
receiving network data representative of the network; and
locating first and second entities within the network based on the network data.

92. The method of claim 91 wherein the first entities are representative of humans and the second entities are representative of non-humans.

93. The method of claim 91 wherein the second entities are dependent upon the first entities for movement.

94. The method of claim 91, further comprising generating vehicle data based on baseline populations and baseline vehicle data.
